(19) United States
(12) Patent Application Publication
(10) Pub. No.: US 2006/0193009 A1
(43) Pub. Date: Aug. 31, 2006

(54) Image-processing apparatus, image-processing method, image-processing system, printing apparatus, and printing system

(76) Inventor: Toshiaki Kakutani, Nagano-ken (JP)

Correspondence Address: MARTINE PENILLA & GENCARELLA, LLP, 710 LAKEWAY DRIVE, SUITE 200, SUNNYVALE, CA, 94085, US

(21) Appl. No.: 11/344,871

(22) Filed: Jan. 31, 2006

(30) Foreign Application Priority Data
Jan. 2, 2005 (JP) 2005-025632

(51) Int. Cl. H04N 1/40

(52) U.S. Cl. 358/3.03; 358/521

(57) ABSTRACT

An image-processing apparatus includes (A) a value-multiplexing processing section and (B) a dot-formation-data generating section. The value-multiplexing processing section generates, based on image data, multivalue gradation-value data by performing value-multiplexing processing on a gradation value of each of a plurality of pixels that constitute an image expressed by the image data, in accordance with a resolution of an output image. The dot-formation-data generating section converts the multivalue gradation-value data generated by the value-multiplexing processing section into dot-number data indicating a number of dots, determines whether or not to form a dot individually for each of one or more pixels based on the dot-number data, and generates dot-formation data of the output image having the above-described resolution by employing at least a portion of the pixels, among the one or more pixels for which whether or not to form a dot has been determined, as a pixel that constitutes the output image.

### CROSS-REFERENCE TO RELATED APPLICATIONS

The present application claims priority upon Japanese Patent Application No. 2005-025632 filed on Feb. 1, 2005, which is herein incorporated by reference.

### BACKGROUND

1. Technical Field

The present invention relates to image-processing apparatuses, image-processing methods, image-processing systems, printing apparatuses, and printing systems.

2. Related Art

Image-outputting apparatuses that output images by forming dots on output media, such as print media and liquid crystal displays, are widely used as output devices for various image equipments. In such image-outputting apparatuses, an image is handled in a state where it is divided up into small regions called “pixels”, and the dots are formed in these pixels. In forming the dots in these pixels, each pixel can, of course, only take on either a state in which a dot is formed therein or a state in which a dot is not formed therein. However, when macroscopically viewing a region having somewhat of an area, it is possible to make the density of the dots to be formed either high or low, and in this way, it becomes possible to output an image having multiple gradations by changing the dot-formation density. For example, in cases where dots are formed with black ink on print paper, regions in which the dots are densely formed will appear dark, whereas regions in which dots are sparsely formed will appear light. On the other hand, in cases where dots are formed as luminescent spots on a liquid-crystal display, regions in which dots are densely formed will appear light, and regions in which dots are sparsely formed will appear dark. By appropriately controlling the dot-formation density in this way, it is possible to output images having multiple gradations. Data for controlling dot formation such that an appropriate formation density can be obtained in the above-mentioned manner is generated by subjecting the image to be output to predetermined image processing.

In recent years, there are demands on these image-outputting apparatuses for larger images and higher quality of images that are output. To meet the demand for higher image quality, it is effective to divide the image into finer pixels. By making the pixels small, it is possible to improve image quality because the dots formed in the pixels will not stand out. On the other hand, the demand for larger images is met by increasing the number of pixels. It is, of course, possible to make the output image larger by enlarging the size of each pixel, but this will give rise to deterioration in image quality. Therefore, it is effective to increase the number of pixels to meet the demand for large-size images.

Increasing the number of pixels that make up an image, however, lengthens the time necessary for image processing, and thus, it becomes difficult to output the image quickly. In view of this, techniques for enabling fast image processing have been proposed. (See, for example, JP-A-2002-185789.)

However, even if this fast image processing is employed, the effect of increasing the speed for outputting images will inevitably be limited if it takes time for transferring the image data, or for transferring the image data that has been processed.

Further, in recent years, users wish to immediately output images by directly supplying image data captured using digital cameras etc. to image-outputting apparatuses such as printing apparatuses. In such cases, it is not possible to perform image processing using image-processing apparatuses, such as so-called personal computers, that have high processing abilities. Accordingly, it is necessary to simplify the image processing tasks such that either the image-capturing device, such as the digital camera, or the image-outputting apparatus alone can execute those tasks, or both the devices can share and execute those tasks.

### SUMMARY

The present invention has been made in light of the foregoing issues, and an advantage of some aspects of the present invention is that it is possible to achieve high-speed image processing and data transferring while suppressing deterioration in image quality.

An aspect of the invention is an image-processing apparatus including: (A) a value-multiplexing processing section that generates, based on image data, multivalue gradation-value data by performing value-multiplexing processing on a gradation value of each of a plurality of pixels that constitute an image expressed by the image data, in accordance with a resolution of an output image; and (B) a dot-formation-data generating section that converts the multivalue gradation-value data generated by the value-multiplexing processing section into dot-number data indicating a number of dots, that determines whether or not to form a dot individually for each of one or more pixels based on the dot-number data, and that generates dot-formation data of the output image having the above-described resolution by employing at least a portion of the pixels, among the one or more pixels for which whether or not to form a dot has been determined, as a pixel that constitutes the output image.

Other features of the invention will be made clear through the following description with reference to the accompanying drawings.

### BRIEF DESCRIPTION OF THE DRAWINGS

FIG. 1 is a perspective view of a printing system to which an image-processing apparatus of an embodiment is applied;

FIG. 2 is an explanatory diagram describing an example of an inner configuration of a computer;

FIG. 3 is a perspective view describing an inner configuration of a printing apparatus;

FIG. 4 is a sectional view showing a carrying section of the printing apparatus;

FIG. 5 is a block diagram showing a system configuration of the printing apparatus;

FIG. 6 is an explanatory diagram showing an arrangement of nozzles in a head;

FIG. 7 a diagram describing an example of a drive circuit of the head;

FIG. 8 is a timing chart of various signals;

FIG. 9 is an explanatory diagram describing an outline of a conventional process performed by a printer driver;

FIG. 10 is an explanatory diagram describing an outline of a process of the present embodiment performed by a printer driver;

FIG. 11 is a flowchart describing an example of a processing procedure of value-multiplexing processing of a value-multiplexing processing section;

FIG. 12 is an explanatory diagram schematically showing an example of a value-multiplexing table;

FIG. 13 is an explanatory diagram illustrating a relationship between a gradation value of a pixel and multivalue gradation-value data;

FIG. 14A is an explanatory diagram describing a method of setting classification numbers in the “1×1 mode”, FIG. 14B is an explanatory diagram describing a method of setting classification numbers in the “2×1 mode”, FIG. 14C is an explanatory diagram describing a method of setting classification numbers in the “1×2 mode”, FIG. 14D is an explanatory diagram describing a method of setting classification numbers in the “2×2 mode”, and FIG. 14E is an explanatory diagram describing a method of setting classification numbers in the “4×2 mode”;

FIG. 15 is a flowchart showing an example of a processing procedure of the dot-formation-data generating section;

FIG. 16 is an explanatory diagram of an example of a dot-number-data conversion table;

FIG. 17 is an explanatory diagram of an example of a correspondence between the dot-number data and information on the number and the size of dots;

FIG. 18A shows an example of a sequence value matrix set in correspondence to the classification number “1”, FIG. 18B shows an example of a sequence value matrix set in correspondence to the classification number “2”, and FIG. 18C shows an example of a sequence value matrix set in correspondence to the classification number “3”;

FIG. 19 is an explanatory diagram of an example of a procedure for determining whether or not to form dots;

FIG. 20A is an explanatory diagram for cutting out a pixel in the upper left corner, FIG. 20B is an explanatory diagram for cutting out the second pixel from the left in the upper stage, FIG. 20C is an explanatory diagram for cutting out the second pixel from the right in the upper stage, FIG. 20D is an explanatory diagram for cutting out a pixel in the upper right corner, FIG. 20E is an explanatory diagram for cutting out a pixel in the lower left corner, FIG. 20F is an explanatory diagram for cutting out the second pixel from the left in the lower stage, FIG. 20G is an explanatory diagram for cutting out the second pixel from the right in the lower stage, and FIG. 20H is an explanatory diagram for cutting out a pixel in the lower right corner;

FIG. 21 is an explanatory diagram of positions of the pixels within the CMYK image data;

FIG. 22A is an explanatory diagram for cutting out the first and second pixels from the left in the upper stage, FIG. 22B is an explanatory diagram for cutting out the first and second pixels from the right in the upper stage, FIG. 22C is an explanatory diagram for cutting out the first and second pixels from the left in the lower stage, and FIG. 22D is an explanatory diagram for cutting out the first and second pixels from the right in the lower stage;

FIG. 23 is an explanatory diagram of positions of the pixels within the CMYK image data;

FIG. 24A is an explanatory diagram for cutting out two vertically-adjacent pixels in the first column from the left, FIG. 24B is an explanatory diagram for cutting out two vertically-adjacent pixels in the second column from the left, FIG. 24C is an explanatory diagram for cutting out two vertically-adjacent pixels in the second column from the right, and FIG. 24D is an explanatory diagram for cutting out two vertically-adjacent pixels in the first column from the right;

FIG. 25 is an explanatory diagram of positions of the pixels within the CMYK image data;

FIG. 26A is an explanatory diagram for cutting out four pixels in the left half, and FIG. 26B is an explanatory diagram for cutting out four pixels in the right half;

FIG. 27 is an explanatory diagram of positions of the pixels within the CMYK image data;

FIG. 28 is an explanatory diagram of a method for cutting out pixels in the “4×2 mode”;

FIG. 29 is an explanatory diagram of an example of a dot-number-data conversion table for the “2×4 mode”;

FIG. 30 is an explanatory diagram of an example of a sequence value matrix for the “2×4 mode”;

FIG. 31 is an explanatory diagram of a method for determining whether or not to form dots in the “2×4 mode”;

FIG. 32 is an explanatory diagram of an example of a dot-number-data conversion table for the “4×4 mode”;

FIG. 33 is an explanatory diagram of an example of a correspondence between the dot-number data for the “4×4 mode” and information on the number and the size of the dots to be formed that is expressed by the dot-number data;

FIG. 34 is an explanatory diagram of an example of a sequence value matrix for the “4×4 mode”;

FIG. 35 is an explanatory diagram of a method for determining whether or not to form dots in the “4×4 mode”;

FIG. 36 is an explanatory diagram illustrating an enlarged portion of a dither matrix;

FIG. 37 is an explanatory diagram describing a method for determining whether or not to form a dot for each pixel with reference to the dither matrix;

FIG. 38A is an explanatory diagram of unit blocks set in the dither matrix, FIG. 38B is an explanatory diagram of classification numbers set in the dither matrix, and FIG. 38C is an explanatory diagram when applying the dither matrix to image data;

FIG. 39A is an explanatory diagram of a position of a focused pixel in the CMYK image data, FIG. 39B is an explanatory diagram of an example of a method for applying the dither matrix to the CMYK image data, and FIG. 39C is an explanatory diagram of a method for specifying the unit block to which the focused pixel belongs;

FIG. 40 is a flowchart showing an outline of halftone processing;

FIG. 41 is an explanatory diagram showing a dot density conversion table;

FIG. 42 is an explanatory diagram describing an outline of halftone processing;

FIG. 43 is a flowchart showing an example of a procedure for setting a value-multiplexing table;

FIG. 44 is a flowchart showing an example of a procedure for setting a dot-number-data conversion table;

FIG. 45A is an explanatory diagram of classification numbers set in the dither matrix, FIG. 45B is an explanatory diagram of a procedure for generating a sequence value matrix for the classification number “1”, and FIG. 45C is an explanatory diagram of a procedure for generating a sequence value matrix for the classification number “2”;

FIG. 46 is an explanatory diagram of an outline of dot-formation-data generation processing;

FIG. 47 is an explanatory diagram describing an example of another type of value-multiplexing table;

FIG. 48 is an explanatory diagram describing an example of dot-formation-data generation processing according another method;

FIG. 49 is an explanatory diagram describing an example of a table of a correspondence between the dot-number data and the intermediate data;

FIG. 50A is an explanatory diagram describing an overview of the intermediate data, FIG. 50B is an explanatory diagram of a method for reading out 2-bit data from the intermediate data, and FIG. 50C is an explanatory diagram of a method for reading out 2-bit data by shifting the intermediate data;

FIG. 51 is an explanatory diagram describing an example of another type of dot-number-data conversion table; and

FIG. 52A is an explanatory diagram of an example of dot data, and FIG. 52B is an explanatory diagram of an example of an image of dots that are actually formed.

### DESCRIPTION OF EXEMPLARY EMBODIMENTS

At least the following matters are made clear through the present specification and the accompanying drawings.

An aspect of the present invention is an image-processing apparatus including: (A) a value-multiplexing processing section that generates, based on image data, multivalue gradation-value data by performing value-multiplexing processing on a gradation value of each of a plurality of pixels that constitute an image expressed by the image data, in accordance with a resolution of an output image; and (B) a dot-formation-data generating section that converts the multivalue gradation-value data generated by the value-multiplexing processing section into dot-number data indicating a number of dots, that determines whether or not to form a dot individually for each of one or more pixels based on the dot-number data, and that generates dot-formation data of the output image having the above-described resolution by employing at least a portion of the pixels, among the one or more pixels for which whether or not to form a dot has been determined, as a pixel that constitutes the output image.

With such an image-processing apparatus, it is possible to efficiently generate dot-formation data because the value-multiplexing processing section generates multivalue gradation-value data by performing value-multiplexing processing on the gradation value of each of the pixels that constitute an image expressed by the image data, in accordance with the resolution of an image to be output, and the dot-formation-data generating section converts the multivalue gradation-value data into dot-number data indicating the number of dots, determines whether or not to form a dot individually for each of one or more pixels based on the dot-number data, and generates the dot-formation data of the output image having the above-described resolution by employing at least a portion of the pixels, among the one or more pixels for which whether or not to form a dot has been determined, as a pixel that constitutes the output image.

In this image-processing apparatus, the image-processing apparatus may further include a value-multiplexing table in which the gradation value and the multivalue gradation-value data are associated; and the value-multiplexing processing section may generate the multivalue gradation-value data by referencing the value-multiplexing table. Providing such a value-multiplexing table makes it possible to easily obtain the multivalue gradation-value data from the gradation value.

In this image-processing apparatus, the value-multiplexing processing section may generate the multivalue gradation-value data by performing the value-multiplexing processing on the gradation value, provided separately for each color, of each of the pixels that constitute the image expressed by the image data, in accordance with the resolution of the output image. By generating the multivalue gradation-value data by performing the value-multiplexing processing on the gradation value, provided separately for each color, of each pixel in accordance with the resolution of the output image, it is possible to smoothly perform the dot-formation-data generation processing even when the image data is expressed using a plurality of colors.

In this image-processing apparatus, the value-multiplexing processing section may generate the multivalue gradation-value data by performing the value-multiplexing processing on the gradation value in accordance with a position of the pixel corresponding to the gradation value. By performing the value-multiplexing processing with the value-multiplexing processing section in accordance with the position of the pixel corresponding to the gradation value in this way, it is possible to generate the dot-formation data with an even higher quality and improve the quality of the output image.

In this image-processing apparatus, the multivalue gradation-value data may be generated by the value-multiplexing processing section as data having a predetermined number of bits. By generating the multivalue gradation-value data as data having a predetermined number of bits in this way, it is possible to make the data amount of the multivalue gradation-value data, which is generated by the value-multiplexing processing section, constant regardless of the resolution of the output image.

In this image-processing apparatus, the image-processing apparatus may further include a dot-number-data conversion table in which the multivalue gradation-value data and the dot-number data are associated; and the dot-formation-data generating section may convert the multivalue gradation-value data into the dot-number data by referencing the dot-number-data conversion table. Providing such a dot-number-data conversion table makes it possible to easily obtain the dot-number data from the multivalue gradation-value data.

In this image-processing apparatus, the dot-formation-data generating section may determine whether or not to form a dot individually for each of a predetermined number of pixels based on the dot-number data. By determining whether or not to form a dot for each of a predetermined number of pixels in this way, it is possible to perform the process smoothly.

In this image-processing apparatus, the dot-number data may include data on a number of dots and data on a size of the dots. By including the data on the size of the dots in this way, it is possible to determine whether or not to form dots of different sizes.

In this image-processing apparatus, the dot-formation-data generating section may determine whether or not to form a dot individually for each of the one or more pixels based on the dot-number data and dot-formation sequence data indicating an order in which dots are to be formed. By determining whether or not to form a dot individually for each of the one or more pixels based on the dot-formation sequence data in this way, it is possible to perform the process smoothly.

In this image-processing apparatus, a number of the pixel, among the one or more pixels for which whether or not to form a dot has been determined, that is used by the dot-formation-data generating section as the pixel that constitutes the output image may differ depending on the resolution of the output image. By making the number of the pixel, among the one or more pixels, that is used as the pixel that constitutes the output image different depending on the resolution of the output image, it is possible to easily generate dot-formation data of output images having different resolutions.

In this image-processing apparatus, a position of the pixel, among the one or more pixels for which whether or not to form a dot has been determined, that is used by the dot-formation-data generating section as the pixel that constitutes the output image may differ depending on a position of the pixel corresponding to the gradation value subjected to the value-multiplexing processing when generating the multivalue gradation-value data. By making the position of the pixel, among the one or more pixels, that is used as the pixel that constitutes the output image different depending on the position of the pixel corresponding to the gradation value subjected to the value-multiplexing processing when generating the multivalue gradation-value data, it is possible to smoothly generate the dot-formation data of the output image.

Another aspect is an image-processing apparatus including:

(A) a value-multiplexing processing section that generates, based on image data, multivalue gradation-value data by performing value-multiplexing processing on a gradation value of each of a plurality of pixels that constitute an image expressed by the image data, in accordance with a resolution of an output image; and

(B) a dot-formation-data generating section that converts the multivalue gradation-value data generated by the value-multiplexing processing section into dot-number data indicating a number of dots, that determines whether or not to form a dot individually for each of one or more pixels based on the dot-number data, and that generates dot-formation data of the output image having the above-described resolution by employing at least a portion of the pixels, among the one or more pixels for which whether or not to form a dot has been determined, as a pixel that constitutes the output image;

(C) wherein the image-processing apparatus further includes a value-multiplexing table in which the gradation value and the multivalue gradation-value data are associated, and the value-multiplexing processing section generates the multivalue gradation-value data by referencing the value-multiplexing table;

(D) wherein the value-multiplexing processing section generates the multivalue gradation-value data by performing the value-multiplexing processing on the gradation value, provided separately for each color, of each of the pixels that constitute the image expressed by the image data, in accordance with the resolution of the output image;

(E) wherein the value-multiplexing processing section generates the multivalue gradation-value data by performing the value-multiplexing processing on the gradation value in accordance with a position of the pixel corresponding to the gradation value;

(F) wherein the multivalue gradation-value data is generated by the value-multiplexing processing section as data having a predetermined number of bits;

(G) wherein the image-processing apparatus further includes a dot-number-data conversion table in which the multivalue gradation-value data and the dot-number data are associated, and the dot-formation-data generating section converts the multivalue gradation-value data into the dot-number data by referencing the dot-number-data conversion table;

(H) wherein the dot-formation-data generating section determines whether or not to form a dot individually for each of a predetermined number of pixels based on the dot-number data;

(I) wherein the dot-number data includes data on a number of dots and data on a size of the dots;

(J) wherein the dot-formation-data generating section determines whether or not to form a dot individually for each of the one or more pixels based on the dot-number data and dot-formation sequence data indicating an order in which dots are to be formed;

(K) wherein a number of the pixel, among the one or more pixels for which whether or not to form a dot has been determined, that is used by the dot-formation-data generating section as the pixel that constitutes the output image differs depending on the resolution of the output image; and

(L) wherein a position of the pixel, among the one or more pixels for which whether or not to form a dot has been determined, that is used by the dot-formation-data generating section as the pixel that constitutes the output image differs depending on a position of the pixel corresponding to the gradation value subjected to the value-multiplexing processing when generating the multivalue gradation-value data.

Another aspect is an image-processing method including:

a value-multiplexing processing step of generating, based on image data, multivalue gradation-value data by performing value-multiplexing processing on a gradation value of each of a plurality of pixels that constitute an image expressed by the image data, in accordance with a resolution of an output image; and

a dot-formation-data generating step of
converting the multivalue gradation-value data generated in the value-multiplexing processing step into dot-number data indicating a number of dots,
determining whether or not to form a dot individually for each of one or more pixels based on the dot-number data, and
generating dot-formation data of the output image having the above-described resolution by employing at least a portion of the pixels, among the one or more pixels for which whether or not to form a dot has been determined, as a pixel that constitutes the output image.

Another aspect is an image-processing system including:

an image-processing apparatus that includes a value-multiplexing processing section that generates, based on image data, multivalue gradation-value data by performing value-multiplexing processing on a gradation value of each of a plurality of pixels that constitute an image expressed by the image data, in accordance with a resolution of an output image; and

an image-outputting apparatus that can communicate with the image-processing apparatus and that includes a dot-formation-data generating section that converts the multivalue gradation-value data generated by the value-multiplexing processing section into dot-number data indicating a number of dots, that determines whether or not to form a dot individually for each of one or more pixels based on the dot-number data, and that generates dot-formation data of the output image having the above-described resolution by employing at least a portion of the pixels, among the one or more pixels for which whether or not to form a dot has been determined, as a pixel that constitutes the output image.

Another aspect is a printing apparatus including:

(A) a value-multiplexing processing section that generates, based on image data, multivalue gradation-value data by performing value-multiplexing processing on a gradation value of each of a plurality of pixels that constitute an image expressed by the image data, in accordance with a resolution of an output image;

(B) a dot-formation-data generating section that converts the multivalue gradation-value data generated by the value-multiplexing processing section into dot-number data indicating a number of dots, that determines whether or not to form a dot individually for each of one or more pixels based on the dot-number data, and that generates dot-formation data of the output image having the above-described resolution by employing at least a portion of the pixels, among the one or more pixels for which whether or not to form a dot has been determined, as a pixel that constitutes the output image; and

(C) a printing section that performs printing on a medium based on the dot-number data generated by the dot-formation-data generating section.

Another aspect is a printing system including:

a computer that includes a value-multiplexing processing section that generates, based on image data, multivalue gradation-value data by performing value-multiplexing processing on a gradation value of each of a plurality of pixels that constitute an image expressed by the image data, in accordance with a resolution of an output image; and

a printing apparatus connectable to the computer and that includes
a dot-formation-data generating section that converts the multivalue gradation-value data generated by the value-multiplexing processing section into dot-number data indicating a number of dots, that determines whether or not to form a dot individually for each of one or more pixels based on the dot-number data, and that generates dot-formation data of the output image having the above-described resolution by employing at least a portion of the pixels, among the one or more pixels for which whether or not to form a dot has been determined, as a pixel that constitutes the output image, and
a printing section that performs printing on a medium based on the dot-number data generated by the dot-formation-data generating section.
   ===Outline of Image-Processing Apparatus Etc.===

An example in which a printing system including a printing apparatus and a computer for controlling the printing apparatus is employed is described as an embodiment of an image-processing apparatus etc. according to the present invention. Herein, an inkjet printer is described as an example of the printing apparatus.

The computer functions as a “value-multiplexing processing section” that generates, based on image data, “multivalue gradation-value data” by performing value-multiplexing processing on the gradation value of each of the pixels, which constitute an image expressed by the above-mentioned image data, in accordance with the resolution of the image to be output.

The inkjet printer functions as a “dot-formation-data generating section” that converts the multivalue gradation-value data generated by the computer into “dot-number data” indicating the number of dots, that determines whether or not to form a dot individually for each of one or more pixels based on the dot-number data, and that generates “dot-formation data” of the output image having the above-described resolution by employing at least a portion of the pixels, among the one or more pixels for which whether or not to form a dot has been determined, as a pixel that constitutes the output image. The configuration of the computer and the inkjet printer is described in detail below.

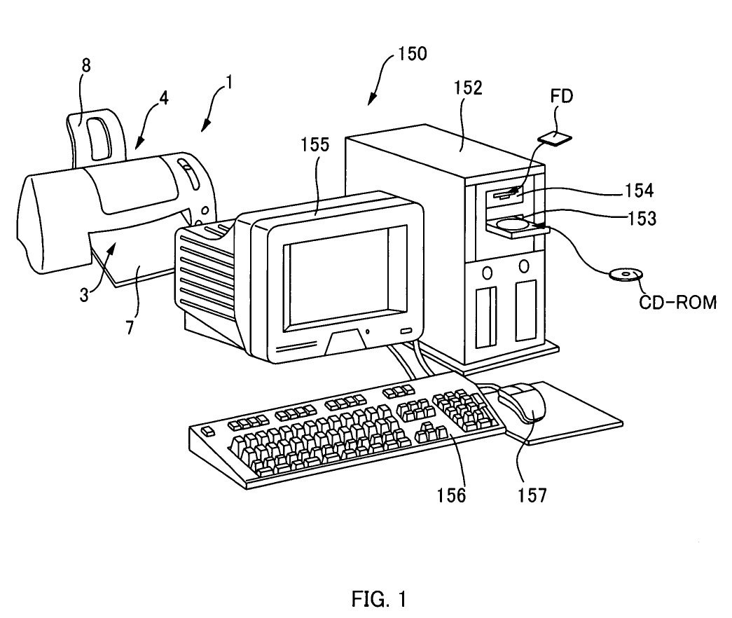

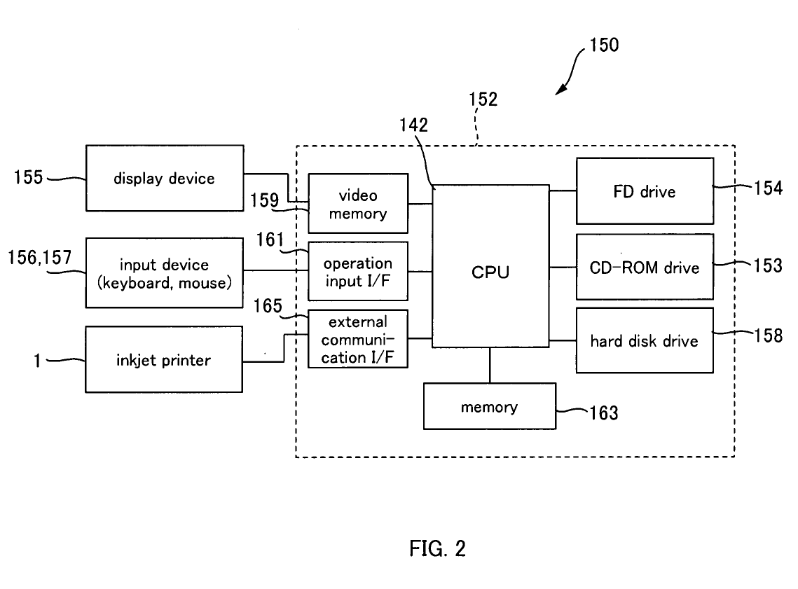

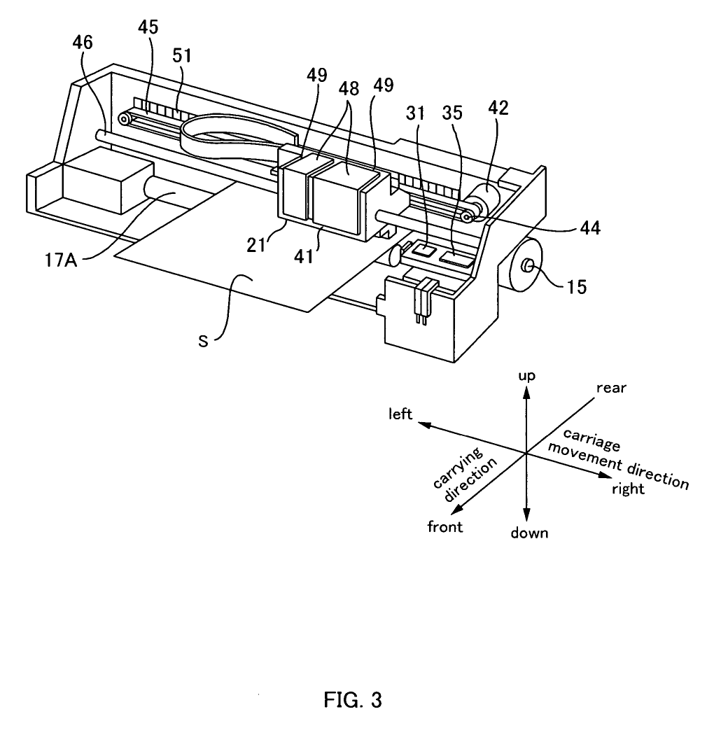

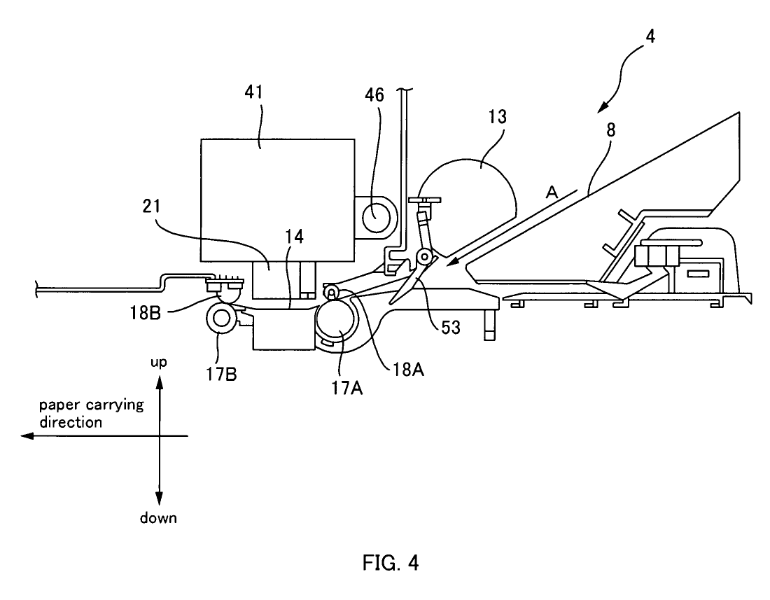

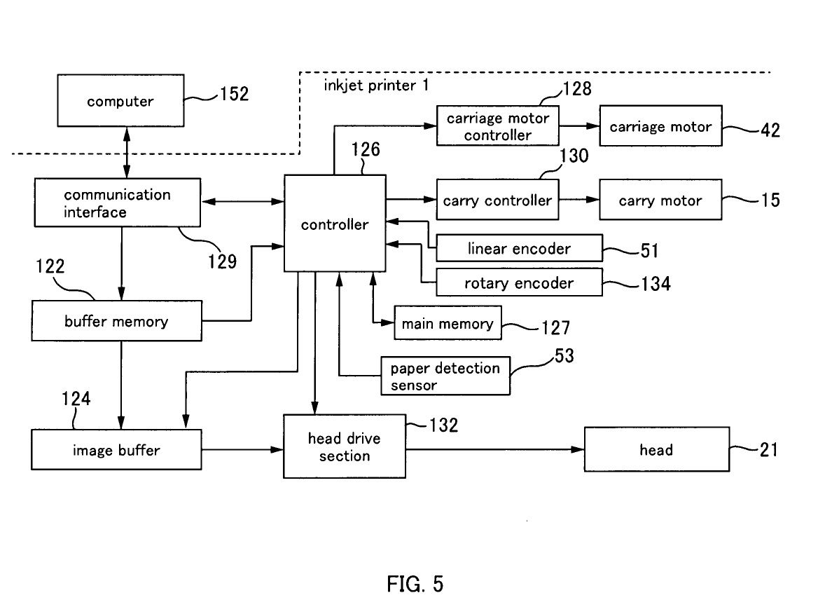

FIG. 1 through FIG. 5 describe the image-processing system (printing system) according to the present embodiment. FIG. 1 shows an outer appearance of the inkjet printer and the computer. FIG. 2 is a block diagram showing an example of an inner configuration of the computer 152. FIG. 3 shows an inner configuration of the inkjet printer 1. FIG. 4 shows a configuration of a carrying section of the inkjet printer 1. FIG. 5 shows a system configuration of the inkjet printer 1.

As shown in FIG. 1, the computer 152 is communicably connected, either in a wireless or wired fashion, to the inkjet printer 1. Various types of computers such as personal computers may be employed as the computer 152, and in general, the computer 152 is internally provided with various processing units such as CPUs, various memories such as RAMs and ROMs, and various drive devices such as a hard disk device (not shown), a CD-ROM drive device 153, and a flexible disk drive device (FDD) 154. In addition, the computer 152 is connected to a display device 155 such as a CRT display and input devices such as a keyboard 156 and a mouse 157.

The computer 152 reads out various programs from the various memories and/or the various drive devices, and executes these programs under a certain operating systems (OS). Programs that may be executed include various application programs and a printer driver which is a program for controlling the inkjet printer 1 connected to the computer 152.

The printer driver is a program that is installed to the computer 152 via a communications line such as the Internet or via a storage medium such as a CD-ROM or a flexible disk (FD). By installing the printer driver to the computer 152, the computer 152 functions as a so-called “print-control apparatus” that controls the inkjet printer 1 (printing apparatus).

<Configuration of Computer>

As shown in FIG. 2, the computer 152 is provided with the flexible disk drive device (FDD) 154, the CD-ROM drive device 153, a CPU 142, a memory 163, a hard disk drive device 158, a video memory 159, an operation input interface 161, and an external communication interface 165 (external communication I/F).

The CPU 142 controls the entire computer 152. The memory 163 is for reserving a work area and an area for storing computer programs that are used by the CPU 142. The memory 163 is made up of a RAM, an EEPROM, a ROM, and so forth. To the hard disk drive device 158 is installed the printer driver which is the program for controlling the inkjet printer 1 of the present embodiment. The CPU 142 reads in programs such as the printer driver stored in the hard disk drive device 158 and operates in accordance with the programs. The CPU 142 also outputs, via the video memory 159, video signals for displaying screens through the display device 155. Further, the CPU 142 receives, via the operation input interface 161, operation inputs from the input devices such as the keyboard 156 and the mouse 157. Further, the CPU 142 is connected to and exchange data with the inkjet printer 1 via the external communication interface 165.

<Configuration of Inkjet Printer>

On the other hand, as shown in FIG. 1, the inkjet printer 1 is structured such that a medium S, such as print paper, that is supplied from the rear side of the printer is discharged from its front side. The rear side is provided with a paper supply section 4 into which media S to be printed are set. The paper supply section 4 includes a paper supply tray 8 for supporting the media S. The front side of the inkjet printer 1 is provided with a paper discharge section 3 where the printed medium S is discharged. The paper discharge section 3 includes a paper discharge tray 7 for holding discharged media S for which printing has finished.

(1) Internal Configuration

As shown in FIG. 3, a carriage 41 is provided inside the inkjet printer 1. The carriage 41 is provided such that it can be relatively moved in the left-and-right directions. In the periphery of the carriage 41 are provided a carriage motor 42, a pulley 44, a timing belt 45, and a guide rail 46. The carriage motor 42 is made, for example, of a DC motor, and serves as a drive source for relatively moving the carriage 41 in the left-and-right directions (also referred to as the “carriage movement direction”). The timing belt 45 is connected to the carriage motor 42 via the pulley 44, and a portion thereof is connected to the carriage 41. When the carriage motor 42 is driven to rotate, the timing belt 45 relatively moves the carriage 41 in the carriage movement direction (the left-and-right directions). The guide rail 46 guides the carriage 41 in the carriage movement direction (the left-and-right directions).

Further, in the periphery of the carriage 41 are provided a linear encoder 51 that detects the position of the carriage 41, a carry roller 17A for carrying the medium S in a direction (the rear-to-front direction in the figure; also referred to below as the “carrying direction”) that intersects with the movement direction of the carriage 41, and a carry motor 15 that drives and rotates the carry roller 17A.

The carriage 41 is provided with ink cartridges 48 containing various types of ink and a head 21 that prints on the medium S. The ink cartridges 48 contain ink of various colors such as yellow (Y), magenta (M), cyan (C), and black (K), and are detachably attachable to a cartridge attachment section 49 provided on the carriage 41. In the present embodiment, the head 21 performs printing by ejecting ink onto the medium S. To achieve this, the head 21 is provided with a multitude of nozzles for ejecting the ink.

In addition, inside the inkjet printer 1 are provided a pump device 31 that sucks out the ink from the nozzles in order to eliminate clogging of the nozzles of the head 21, and a capping device 35 that seals the nozzles of the head 21 when printing is not being performed (such as during standby) in order to prevent clogging of the nozzles of the head 21.

(2) Carrying Section

The carrying section of the inkjet printer 1 is described next. As shown in FIG. 4, the carrying section includes a paper supply roller 13, a paper detection sensor 53, a carry roller 17A, a paper discharge roller 17B, a platen 14, and free rollers 18A and 18B.

The medium S to be printed is set to the paper supply tray 8. The medium S set to the paper supply tray 8 is carried in the direction shown by the arrow A in the figure by the paper supply roller 13 whose sectional shape is substantially the shape of the letter “D”, and is fed into the inkjet printer 1. The medium S having been fed into the inkjet printer 1 comes into contact with the paper detection sensor 53. The paper detection sensor 53 is arranged between the paper supply roller 13 and the carry roller 17A, and detects the medium S that has been supplied by the paper supply roller 13.

The medium S detected by the paper detection sensor 53 is successively carried by the carry roller 17A to the platen 14 where printing is performed. The free roller 18A is provided at a position in opposition to the carry roller 17A. By pinching the medium S between the free roller 18A and the carry roller 17A, the medium S is carried smoothly.

The medium S fed to the platen 14 is successively printed with ink ejected from the head 21. The platen 14 is provided in opposition to the head 21, and supports the medium S, which is being printed, from below.

The printed medium S is successively discharged out of the inkjet printer 1 by the paper discharge roller 17B. The paper discharge roller 17B is driven in synchronization with the carry motor 15, and discharges the medium S out of the inkjet printer 1 by pinching the medium S between it and the free roller 18B that is provided in opposition to the paper discharge roller 17B.

(3) System Configuration

The following is a description concerning the system configuration of the inkjet printer 1. As shown in FIG. 5, the inkjet printer 1 is provided with a buffer memory 122, an image buffer 124, a controller 126, a main memory 127, a communication interface 129, a carriage motor controller 128, a carry controller 130, and a head drive section 132.

The communication interface 129 is used by the inkjet printer 1 to exchange data with the external computer 152. The communication interface 129 is communicably connected to the external computer 152, in either a wired or wireless fashion, and receives various types of data such as print data transmitted from the computer 152.

The various types of data such as print data received by the communication interface 129 is stored in the buffer memory 122. Furthermore, head drive data for driving the head 21 such that ink is ejected from the head 21 is sequentially stored in the image buffer 124. The head drive data stored in the image buffer 124 is sequentially sent to the head drive section 132. Furthermore, the main memory 127 is constituted by a ROM, a RAM, or an EEPROM for example. Various programs for controlling the inkjet printer 1 and various types of setting data, for example, are stored in the main memory 127.

The controller 126 reads out control programs and various types of setting data from the main memory 127 and performs overall control of the inkjet printer 1 in accordance with the control programs and the various types of setting data. Furthermore, detection signals from various sensors such as a rotary encoder 134, the linear encoder 51, and the paper detection sensor 53 are input to the controller 126.

When various types of data such as print data that has been sent from the external computer 152 is received by the communication interface 129 and is stored in the buffer memory 122, the controller 126 reads out necessary information from among the stored data from the buffer memory 122. Based on the information that is read out, the controller 126 controls each of the carriage motor controller 128, the carry controller 130, and the head drive section 132, for example, in accordance with control programs while referencing output from the linear encoder 51 and the rotary encoder 134.

The carriage motor controller 128 controls the drive such as the rotation direction, the rotation number, and the torque of the carriage motor 42 in accordance with instructions from the controller 126. The carry controller 130 controls the drive of, for example, the carry motor 15 for driving and rotating the carry roller 17A in accordance with instructions from the controller 126.

The head drive section 132 controls the drive of the color nozzles provided in the head 21 in accordance with instructions from the controller 126 and based on print data stored in the image buffer 124.

(4) Head

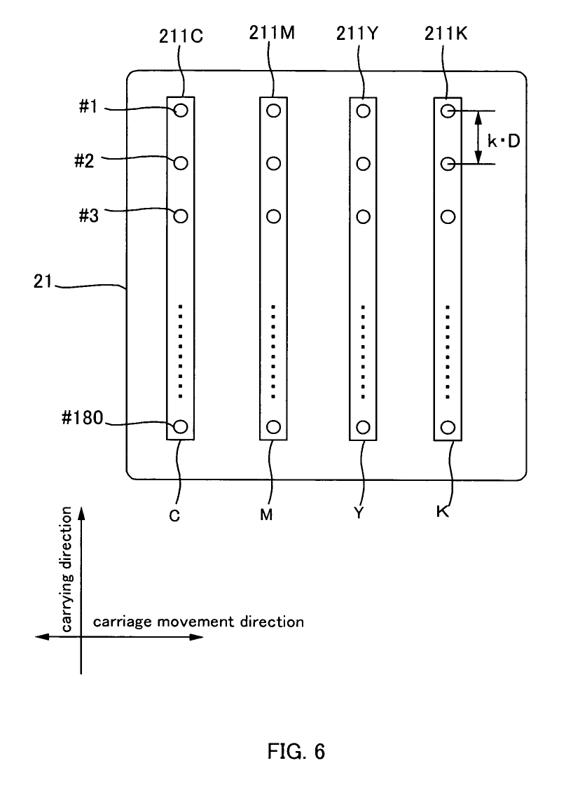

FIG. 6 is a diagram showing the arrangement of the ink nozzles provided on the bottom face of the head 21. As shown in FIG. 6, the bottom face of the head 21 is provided with nozzle rows—that is, a cyan nozzle row 211C, a magenta nozzle row 211M, a yellow nozzle row 211Y, and a black nozzle row 211K—, each constituted by a plurality of nozzles #1 to #180, for each of the colors yellow (Y), magenta (M), cyan (C), and black (K).

The nozzles #1 to #180 in each of the nozzle rows 211C, 211M, 211Y, and 211K are arranged in one straight line with a spacing between one another in a predetermined direction (carrying direction of the medium S in this embodiment). Each spacing between the nozzles #1 to #180 (nozzle spacing) is set to “k·D”. Here, “D” is the minimum dot pitch in the carrying direction (that is, the spacing between dots formed on the medium S at the highest resolution). Also, “k” is an integer of 1 or larger. For example, if the nozzle pitch is 120 dpi ( 1/120 inch), and the dot pitch in the carrying direction is 360 dpi ( 1/360), then k=3. The nozzle rows 211C, 211M, 211Y, and 211K are arranged in parallel to each other with a predetermined spacing D1 between one another in the movement direction (scanning direction) of the head 21. Each nozzle #1 to #180 is provided with a piezo element (not shown) as a drive element for causing ejection of ink droplets.

The nozzles #1 to #180 of each of the nozzle rows 211C, 211M, 211Y, and 211K are arranged in a straight line in a predetermined direction. In this embodiment, when the head is properly disposed, the nozzles #1 to #180 of each of the nozzle rows 211C, 211M, 211Y, and 211K are arranged in the carrying direction of the medium S.

When a voltage of a predetermined duration is applied between electrodes provided at both ends of a piezo element, the piezo element is expanded for the duration of voltage application and deforms a lateral wall of an ink channel. Accordingly, the volume of the ink channel is constricted according to the expansion of the piezo element, and ink corresponding to this amount of constriction becomes an ink droplet, which is ejected from the corresponding nozzles #1 to #180 of the color nozzle rows 211C, 211M, 211Y, and 211K.

(5) Drive Circuit

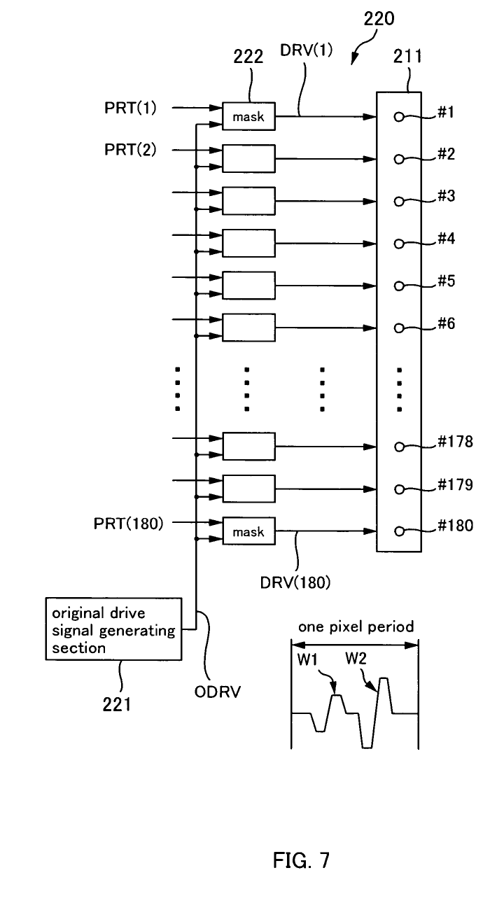

FIG. 7 shows a drive circuit 220 of the nozzles #1 to #180. As shown in FIG. 7, the drive circuit 220 is provided with an original drive signal generating section 221 and a plurality of mask circuits 222. The original drive signal generating section 221 generates an original drive signal ODRV that is commonly used by the nozzles #1 to #180. As shown in a lower portion of FIG. 7, the original drive signal ODRV is a signal that includes two pulses—a first pulse W1 and a second pulse W2—in a main-scanning period for one pixel (i.e., within a time during which the carriage 41 moves across the spacing of one pixel). The original drive signal ODRV generated at the original drive signal generating section 221 is output to the mask circuits 222.

The mask circuits 222 are provided in correspondence with the plurality of piezo elements for driving the nozzles #1 to #180 of the head 21. The mask circuits 222 receive the original drive signal ODRV from the original drive signal generating section 221 and also receive print signals PRT(i). The print signal PRT(i) is pixel data corresponding to a pixel, and is a binary signal having 2-bit information corresponding to one pixel. The bits respectively correspond to the first pulse W1 and the second pulse W2. The mask circuits 222 are gates for blocking the original drive signal ODRV or letting it pass through depending on the level of the print signal PRT(i). More specifically, when the print signal PRT(i) is at a level “0”, the pulse of the original drive signal ODRV is blocked, but when the print signal PRT(i) is at a level “1”, the pulse corresponding to the original drive signal ODRV is allowed to pass through as it is and is output as an actual drive signal DRV toward the piezo elements of the nozzles #1 to #180. The piezo elements of the nozzles #1 to #180 are driven based on the actual drive signal DRV from the mask circuits 222 and eject ink.

(6) Signal Waveforms

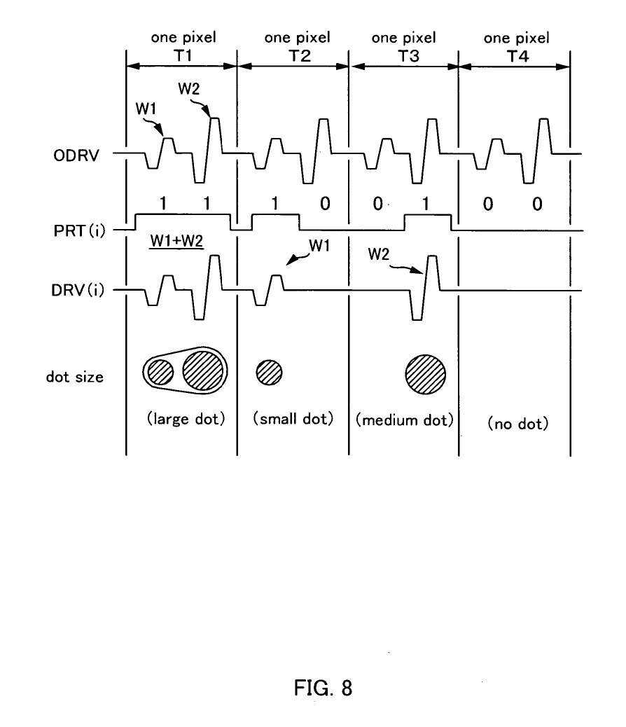

FIG. 8 is a timing chart of the original drive signal ODRV, the print signal PRT(i), and the actual drive signal DRV(i) indicating the operation of the original drive signal generating section 221. As shown in FIG. 8, the original drive signal ODRV generates the first pulse W1 and the second pulse W2 in this order during each pixel period T1, T2, T3, and T4. It should be noted that “pixel period” has the same meaning as the movement interval of the carriage 41 for a one-pixel amount.

Herein, when the print signal PRT(i) corresponds to 2-bit pixel data “10”, then only the first pulse W1 is output in the first half of one pixel period. Accordingly, a small ink droplet is ejected from the nozzles #1 to #180, and a dot of a small size (small dot) is formed on the medium S. Furthermore, when the print signal PRT(i) corresponds to 2-bit pixel data “01”, then only the second pulse W2 is output in the second half of one pixel period. Accordingly, an ink droplet of a medium size is ejected from the nozzles #1 to #180, and a dot of a medium size (medium dot) is formed on the medium S. Furthermore, when the print signal PRT(i) corresponds to 2-bit pixel data “11”, then the first pulse W1 and the second pulse W2 are output during one pixel period. Accordingly, an ink droplet of a large size is ejected from the nozzles #1 to #180, and a dot of a large size (large dot) is formed on the medium S. As described above, the actual drive signal DRV(i) in one pixel period is shaped such that it has three different waveforms corresponding to three different values of the print signal PRT(i), and based on these signals, the head 21 can form dots of three sizes and can adjust the amount of ink ejected during a pixel period. Furthermore, if the print signal PRT(i) corresponds to 2-bit pixel data “00” as in the pixel period T4, then no ink droplet is ejected from the nozzles #1 to #180, and no dot is formed on the medium S.

In the inkjet printer 1 according to this embodiment, the drive circuits 220 of the nozzles #1 to #180 are provided separately for each of the nozzle rows 211C, 211M, 211Y, and 211K, that is, for each of the colors yellow (Y), magenta (M), cyan (C), and black (K), such that piezo elements are driven separately for each of the nozzles #1 to #180 of the nozzle rows 211C, 211M, 211Y, and 211K.

===Processes of Computer===

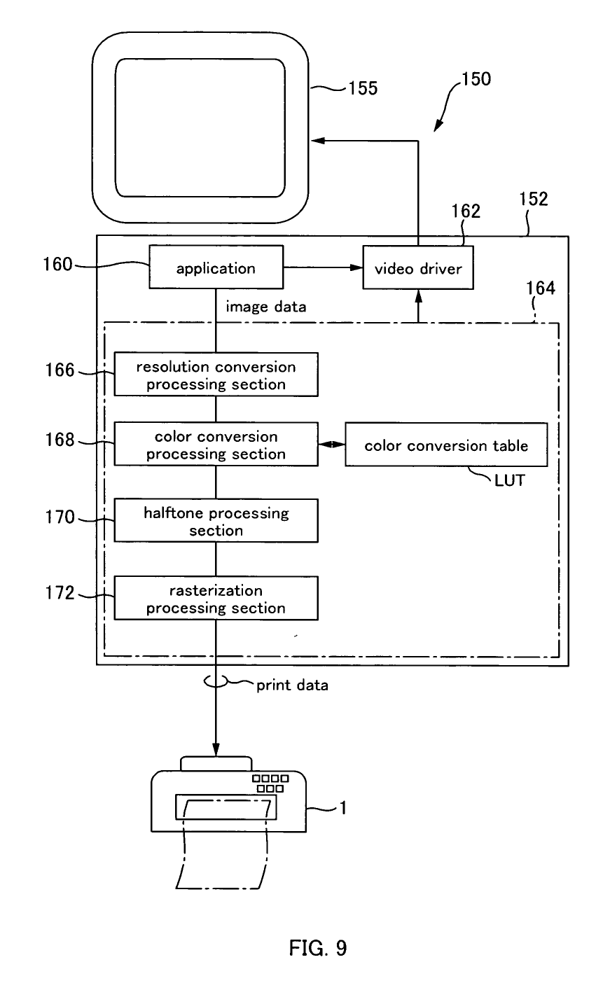

FIG. 9 describes the internal processes of the computer 152. In the computer 152, various computer programs, such as the video driver 162, the application program 160, and the printer driver 164, are executed under the operating system installed to the computer 152. The video driver 162 has the function of displaying screens on the display device 155 according to display commands from the application program 160 and the printer driver 164.

The application program 160 has, for example, the function of editing images, and generates data (image data) relating to the image. A user can give an instruction to print the image edited by the application program 160 via the user interface of the application program 160. When the application program 160 receives this print instruction, it outputs the image data to the printer driver 164.

Based on the image data acquired from the application program 160, the printer driver 164 generates print data for printing, with the inkjet printer 1, the image requested by the application program 160. Herein, “print data” is data of a format that can be interpreted by the inkjet printer 1. The print data includes various command data for instructing the inkjet printer 1 to execute certain operations, and data for printing the image on the medium. The printer driver 164 generates the print data and outputs it to the inkjet printer 1.

<Conventional Processing>

Below, processing that has conventionally been executed for generating the print data with the printer driver 164 is described. As described in FIG. 9, in order to generate print data based on the image data acquired from the application program 160, the printer driver 164 includes a resolution conversion processing section 166, a color conversion processing section 168, a halftone processing section 170, and a rasterization processing section 172. These processing sections 166, 168, 170, and 172 are described below.

The resolution conversion processing section 166 performs resolution conversion processing in which the image data (text data, image data, etc.) output from the application program 160 to the resolution used for printing on the medium S. In this resolution conversion processing, in cases where, for example, the resolution for printing an image on the medium S is designated to be 720 dpi (width)×720 dpi (length), the image data received from the application program 160 is converted into image data having a resolution of 720 dpi (width)×720 dpi (length). It should be noted that the image data after resolution conversion is RGB data in multiple gradations (for example, 256 gradations) expressed using the RGB color space. The RGB data obtained by subjecting the image data to resolution conversion is referred to below as “RGB image data”.

The color conversion processing section 168 performs color conversion processing in which the RGB data is converted into CMYK image data expressed using the CMYK color space. It should be noted that the CMYK data is data corresponding to the colors of ink of the inkjet printer 1. The color conversion processing is performed by the printer driver 164 referencing a table, that is, a color conversion table LUT, in which the gradation values of the RGB image data are correlated to the gradation values of the CMYK image data. By this color conversion processing, the RGB data for each pixel is converted into CMYK data corresponding to the ink colors. It should be noted that the data after color conversion is CMYK data in 256 gradations expressed using the CMYK color space. The CMYK data obtained by subjecting the RGB image data to color conversion is referred to below as “CMYK image data”.

The halftone processing section 170 performs halftone processing in which data having a large number of gradations is converted into data having a number of gradations that can be formed by the inkjet printer 1. Halftone processing is, for example, a process of converting data expressing 256 gradations into 1-bit data expressing two gradations or 2-bit data expressing four gradations. In this halftone processing, pixel data is generated using dithering, Y correction, error diffusion, and so forth, such that the inkjet printer 1 can dispersedly form dots. When employing dithering in the halftone processing, the halftone processing section 170 references a dither table. When employing y correction, the halftone processing section 170 references a gamma table, and when employing error diffusion, the halftone processing section 170 references an error memory for storing diffused errors. The halftoned data has the same resolution as that of the above-mentioned RGB data (i.e., 720 dpi (width)×720 dpi (length) for example), but each pixel of the halftoned data is made up of 1-bit or 2-bit data, for example. Below, halftoned data made up of 1-bit data is referred to as “binary data” and halftoned data made up of 2-bit data is referred to as “multivalue data”.

The rasterization processing section 172 performs rasterization processing in which data, such as the binary data and the multivalue data, obtained as a result of the halftone processing performed by the halftone processing section is rearranged in the order in which it is transferred to the inkjet printer 1. Data generated by this rasterization processing is output to the inkjet printer 1 as print data.

In accordance with the print data sent from the computer 152, the inkjet printer 1 causes ink to be ejected from each of the nozzles #1 to #180 of the nozzle rows 211C, 211M, 211Y, and 211K of the head 21 while relatively moving the carriage 41 with respect to the medium S, to form dots on the medium S with the ejected ink, thereby printing the image designated by the application program 160 on the medium S.

===Processing of Present Embodiment===

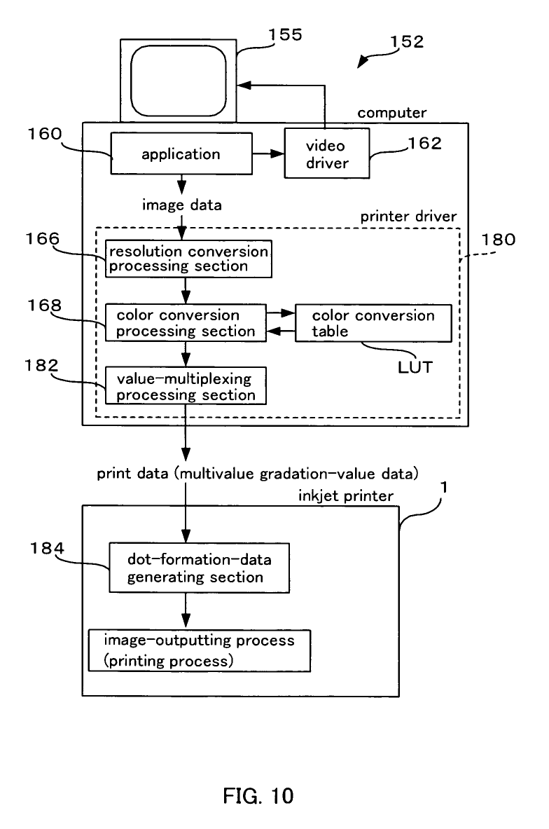

The printer driver of the present embodiment executes completely new processing that is different from the conventional processing. FIG. 10 describes an outline of the new processing. In this new processing, the printer driver 180 executes the resolution conversion processing and the color conversion processing, as in the conventional processing. However, the resolution conversion processing executed by the printer driver 180 is different from the conventional resolution conversion processing. On the other hand, the halftone processing and the rasterization processing executed in the conventional processing are not executed by the printer driver 180 of the present embodiment, but different processing is executed. Below, an outline of the processing carried out by the printer driver 180 of the present embodiment is described.

<Outline of Processing>

The printer driver 180 includes a resolution conversion processing section 166 that executes resolution conversion processing and a color conversion processing section 168 that executes color conversion processing. The resolution conversion processing section 166 converts the resolution of the image data (text data, image data, etc.) output from the application program 160, as in the conventional processing. However, the resolution of the image data is not converted into the resolution (i.e., the output resolution) used when printing on the medium S as in the conventional processing, but is converted into a predetermined resolution. More specifically, for example, in cases where the resolution after conversion is designated to be 360 dpi (width)×360 dpi (length), the image data received from the application program 160 is converted into image data having a resolution of 360 dpi (width)×360 dpi (length). Conversion to the resolution (i.e., the output resolution) used when printing the image on the medium S is executed during a later process. In other words, with this resolution conversion processing, even when the resolution (i.e., the output resolution) used when printing on the medium S is 720 dpi (width)×720 dpi (length), the image data received from the application program 160 is converted into image data having a resolution of 360 dpi (width)×360 dpi (length). Further, even when the resolution (i.e., the output resolution) used when printing on the medium S is 1440 dpi (width)×1440 dpi (length), the image data received from the application program 160 is converted into image data having a resolution of 360 dpi (width)×360 dpi (length) with this resolution conversion processing. With this resolution conversion processing, the resolution conversion processing section 166 generates RGB image data in multiple gradations (for example, 256 gradations) expressed using the RGB color space.

The color conversion processing section 168 converts the RGB image data generated by the resolution conversion processing section 166 into CMYK image data which is expressed using the CMYK color space and corresponds to the colors of ink of the inkjet printer 1, as in the conventional processing. The color conversion processing section 168 performs the conversion using the color conversion table LUT in which the gradation values of each color (three colors—R (red), G (green), and B (blue)—in this example) of the pixels of the RGB image data and the gradation values of each color (four colors—C (cyan), M (magenta), Y (yellow), and K (black)—in this example) of the pixels of the CMYK image data. By this color conversion processing, the RGB data of each pixel is converted into CMYK data corresponding to the ink colors. It should be noted that the CMYK data is data expressed using the CMYK color space, and is CMYK data having 256 gradations for each color. The CMYK image data generated by the color conversion processing section 168 is image data having a resolution of 360 dpi (width)×360 dpi (length).

After generating the CMYK image data with the color conversion processing section 168, the printer driver 180 does not perform the halftone processing on the CMYK image data as in the conventional processing, but executes another processing that is different from the conventional processing. This is the “value-multiplexing processing”. The printer driver 180 of the present embodiment is provided with a value-multiplexing processing section 182 for executing the value-multiplexing processing.

<Value-Multiplexing Processing>

The value-multiplexing processing section 182 subjects the gradation value of each pixel, for each color, in the CMYK image data, which is generated by the color conversion processing section 168, to value-multiplexing processing to generate “multivalue gradation-value data”. In this conversion, the value-multiplexing processing section 182 converts, in accordance with the resolution (the output resolution) used when printing on the medium S, the gradation value of each pixel, for each color, in the CMYK image data into multivalue gradation-value data, pixel by pixel and color by color.

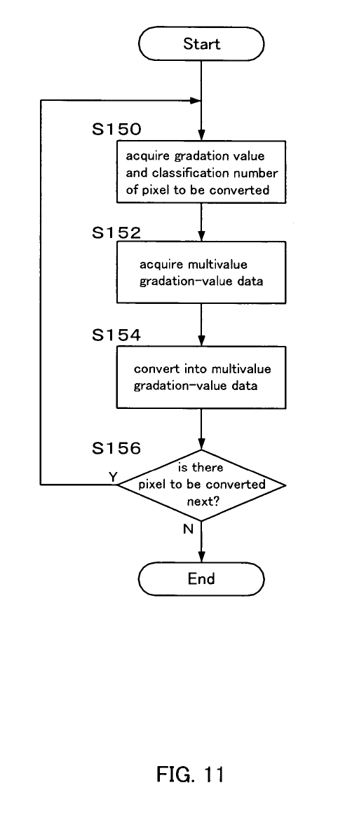

FIG. 11 describes an example of a processing procedure of the value-multiplexing processing section 182. As shown in FIG. 11, the value-multiplexing processing section 182 acquires the gradation value of each pixel in the CMYK image data, and the “classification number” of each pixel (S150). The “classification number” will be described in detail further below. The procedure then proceeds to step S152, and the value-multiplexing processing section 182 acquires multivalue gradation-value data based on the gradation value and the classification number that have been acquired. Here, the value-multiplexing processing section 182 acquires the multivalue gradation-value data using a “value-multiplexing table” in which the multivalue gradation-value data is associated, separately for each classification number, to each gradation value. The “value-multiplexing table” will be described in detail further below. The value-multiplexing processing section 182 then outputs the acquired multivalue gradation-value data as multivalue gradation-value data corresponding to the gradation value of the pixel in the CMYK image data (S154). After finishing the conversion processing in this way, the value-multiplexing processing section 182 checks whether or not there is another pixel to be converted next (S156). If there is another pixel to be converted next, then the value-multiplexing processing section 182 returns to step S150, and again executes the process of converting the gradation value of the pixel targeted for conversion into the multivalue gradation-value data. The value-multiplexing processing section 182 repeats this process until there are no more pixels to be converted. If there are no more pixels for conversion, then the value-multiplexing processing section 182 immediately ends its process.

<Value-Multiplexing Table>

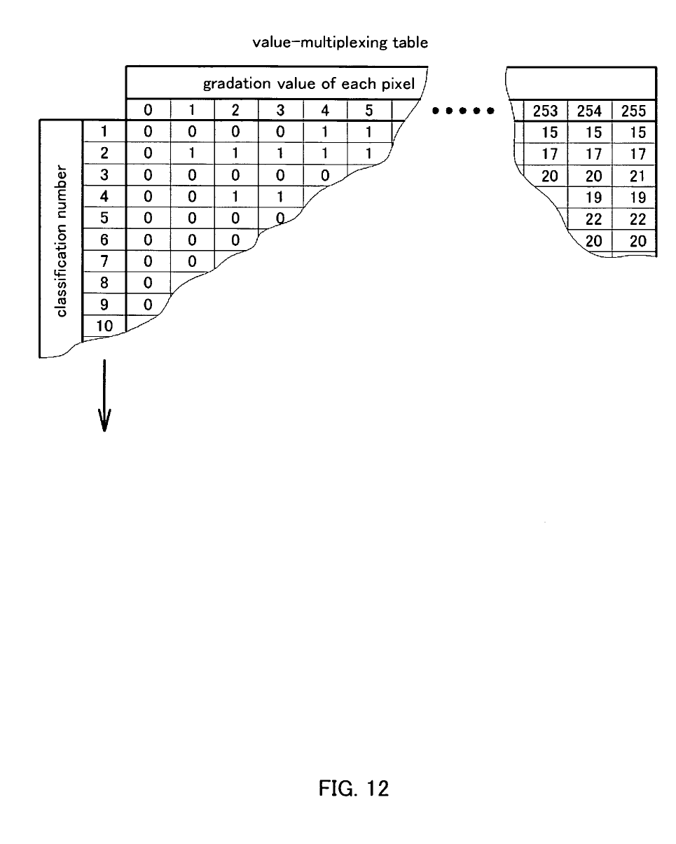

FIG. 12 is an explanatory diagram schematically showing an example of a value-multiplexing table that is used for acquiring the multivalue gradation-value data based on the gradation value and the classification number of each pixel. As shown in FIG. 12, the value-multiplexing table is a table in which a piece of multivalue gradation-value data is set corresponding to each classification number, which is provided for each pixel, and each gradation value, which is set for each pixel. For example, in the value-multiplexing table, the “classification number of each pixel” is set in the lengthwise direction and the “gradation value of each pixel” is set in the width direction as shown in FIG. 12, and a corresponding piece of multivalue gradation-value data can be found from the “classification number” and the “gradation value”. Here, the “gradation value” is expressed in 256 gradations from “0” to “255”. The “classification number” is a number that is assigned to each pixel in the CMYK image data, and a number from “1” to “1024” is assigned to each pixel. The “multivalue gradation-value data” is set to take on a value ranging from “0” to “31” in accordance with the gradation value, which ranges from “0” to “255”, and the classification number, which ranges from “1” to “1024”. The multivalue gradation-value data is set to gradually increase in accordance with the increase of the gradation value of the pixel.

The computer 152 stores, in advance, data on the above-described value-multiplexing table in a data storing section such as the hard disk drive 158 and the memory 163 (see FIG. 2). When converting the gradation value of the pixel into the multivalue gradation-value data, the value-multiplexing processing section 182 acquires the data on the value-multiplexing table from the data storing section such as the hard disk drive 158 and the memory 163.

<Value-Multiplexing Level Number>

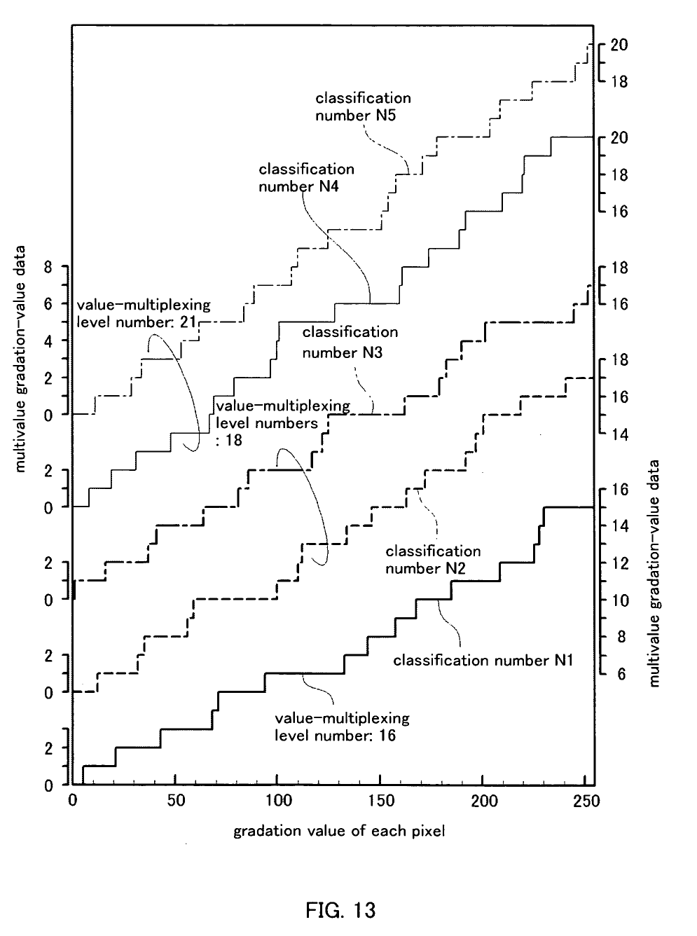

FIG. 13 is an explanatory diagram illustrating how the multivalue gradation-value data gradually increases in accordance with the increase of the gradation value of the pixel. In this example, as shown in FIG. 13, the multivalue gradation-value data corresponding to the gradation values of the pixels is shown as a line graph, in which the horizontal axis represents the gradation values of the pixels and the vertical axis represents the multivalue gradation-value data. The classification numbers N1 to N5 each represents a different classification number. The result of value-multiplexing processing is shown for five pixels corresponding to the classification numbers N1 to N5. It should be noted that, in order to prevent the line graphs for each classification number N1 to N5 from overlapping with one another and making it difficult to distinguish the line graphs from one another, the position of origin of the multivalue gradation-value data for each line graph is shown shifted in the vertical-axis direction.

The classification number N1 shown using a thick solid line in FIG. 13 will be described here. In the range where the gradation value of the pixel is “0” to “4”, the multivalue gradation-value data is “0”. In the range where the gradation value of the pixel is “5” to “20”, the multivalue gradation-value data increases to “1”. Further, in the range where the gradation value of the pixel is “21” to “42”, the multivalue gradation-value data increases to “2”. Further, in the range where the gradation value of the pixel is “43” to “69”, the multivalue gradation-value data increases to “3”. In this way, the multivalue gradation-value data increases stepwise as the gradation values of the pixels increase, and ultimately, it increases up to “15”. In other words, as for the classification number N1, the gradation value of each pixel, which can be set to a gradation value within a range of “0” to “255”, is subjected to value-multiplexing into 16 levels of gradation values “0” to “15” (in other words, changed to 16 values).

In a similar way, as for the classification number N2 shown using a thick broken line and the classification number N3 shown using a thick long-and-short dashed line in FIG. 13, the gradation value of each pixel, which can be set to a gradation value within a range of “0” to “255”, is subjected to value-multiplexing into 18 levels of gradation values “0” to “17” (in other words, changed to 18 values). Further, as for the classification number N4 shown using a thin solid line and the classification number N5 shown using a thin long-and-short dashed line in FIG. 13, the gradation value of each pixel is subjected to value-multiplexing into 21 levels of gradation values “0” to “20” (in other words, changed to 21 values). As described above, the value-multiplexing processing section 182 does not multiplex the gradation value of the pixel into a uniform “level number” (number of states that the gradation value can take as a result of value-multiplexing), but performs the value-multiplexing such that the gradation value of the pixel is multiplexed into a specific “level number” depending on the classification number of the pixel. Therefore, even when the same pixel gradation value is value-multiplexed, the level number of value-multiplexing will differ if the classification number of the pixel is different. Thus, even when the gradation value of a pixel is the same, it will be converted into different multivalue gradation-value data.

Further, even when the value-multiplexing level number is the same, the same multivalue gradation-value data is not always obtained. For example, as it is apparent when comparing the classification number N2 and the classification number N3 shown in FIG. 13, the value-multiplexing level numbers for these pixels are both 18 levels, but the gradation value of the pixel at which the multivalue gradation-value data changes is seldom the same. Similarly, as for the classification numbers N4 and N5, the value-multiplexing level numbers for these pixels are both 21 levels, but the gradation value of the pixel at which the multivalue gradation-value data changes is seldom the same. Therefore, even when the value-multiplexing level number of the pixel is the same, different multivalue gradation-value data will be obtained if the classification number is different.

As can be appreciated from the above, even though the multivalue gradation-value data becomes different depending on the classification numbers, the value-multiplexing level number is set within a range of around 15 to 21. In other words, it is considered that the value-multiplexing level number will not exceed 30, even when estimated to the highest extent. Therefore, the multivalue gradation-value data can be fully expressed with a data amount of 5 bits.

<Setting the Classification Number>

Below, a method of setting the classification number for each pixel in the CMYK image data is described. The method of setting the classification number for each pixel in the CMYK image data differs depending on the resolution (output resolution) used when printing an image on a medium S. In other words, when the resolution (output resolution) used when printing an image on a medium S is different, the way in which the classification number is assigned to the pixels in the CMYK image data differs.

The present embodiment provides seven types of resolutions as the resolution (output resolution) used when printing an image on a medium S, these being the “1×1 mode”, the “2×1 mode”, the “1×2 mode”, the “2×2 mode”, the “4×2 mode”, the “2×4 mode”, and the “4×4 mode”.

(1) Output Resolution

The “1×1 mode” is a mode for printing an image on a medium S with the same resolution as the resolution of the CMYK image data. That is, for example, when printing an image based on CMYK image data having a resolution of 360 dpi (width)×360 dpi (length), the resolution of the printed image will be 360 dpi (width)×360 dpi (length). The “2×1 mode” is a mode for printing an image on a medium S after doubling the resolution in the width direction of the CMYK image data. That is, for example, when printing an image based on CMYK image data having a resolution of 360 dpi (width)×360 dpi (length), the resolution of the printed image will be 720 dpi (width)×360 dpi (length). It should be noted that the image is printed by keeping the resolution in the length direction the same as that of the CMYK image data.

The “1×2 mode” is a mode for printing an image on a medium S after doubling the resolution in the length direction of the CMYK image data. That is, for example, when printing an image based on CMYK image data having a resolution of 360 dpi (width)×360 dpi (length), the resolution of the printed image will be 360 dpi (width)×720 dpi (length). It should be noted that the image is printed by keeping the resolution in the width direction the same as that of the CMYK image data.

The “2×2 mode” is a mode for printing an image on a medium S after doubling the resolution in both the width direction and the length direction of the CMYK image data. That is, for example, when printing an image based on CMYK image data having a resolution of 360 dpi (width)×360 dpi (length), the resolution of the printed image will be 720 dpi (width)×720 dpi (length). The “4×2 mode” is a mode for printing an image on a medium S after quadrupling the resolution in the width direction of the CMYK image data and doubling the resolution in the length direction of the CMYK image data. That is, for example, when printing an image based on CMYK image data having a resolution of 360 dpi (width)×360 dpi (length), the resolution of the printed image will be 1440 dpi (width)×720 dpi (length).

The “2×4 mode” is a mode for printing an image on a medium S after doubling the resolution in the width direction of the CMYK image data and quadrupling the resolution in the length direction of the CMYK image data. That is, for example, when printing an image based on CMYK image data having a resolution of 360 dpi (width)×360 dpi (length), the resolution of the printed image will be 720 dpi (width)×1440 dpi (length). The “4×4 mode” is a mode for printing an image on a medium S after quadrupling the resolution in both the width direction and the length direction of the CMYK image data. That is, for example, when printing an image based on CMYK image data having a resolution of 360 dpi (width)×360 dpi (length), the resolution of the printed image will be 1440 dpi (width)×1440 dpi (length).

(2) Setting the Classification Number Depending on the Resolution

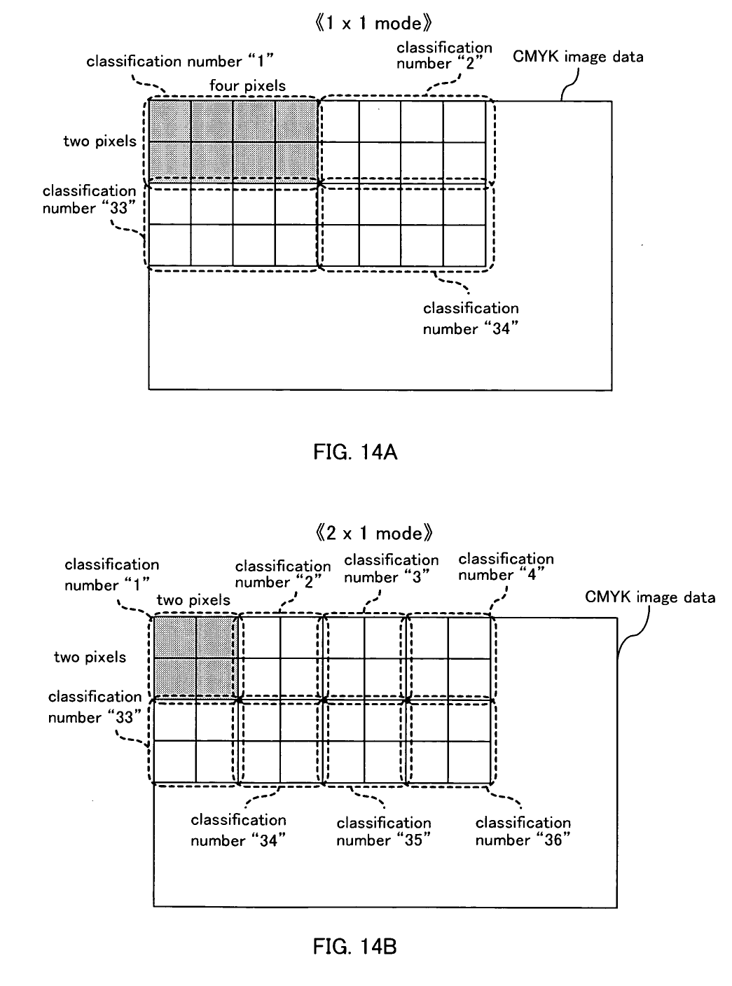

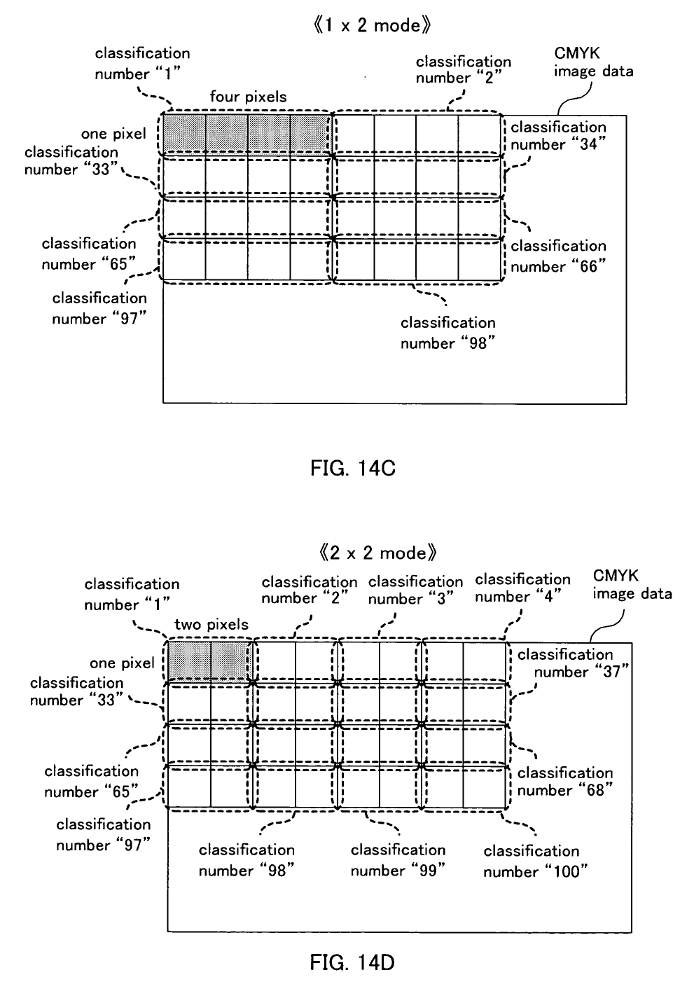

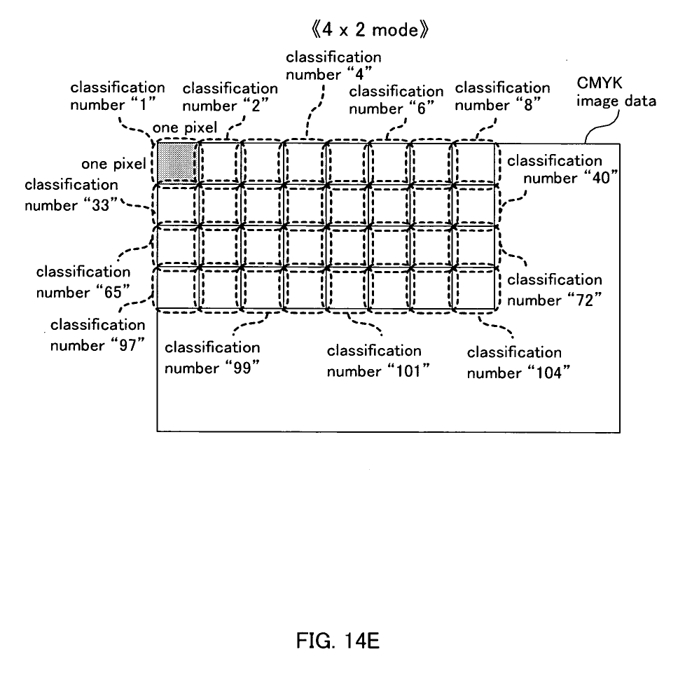

FIGS. 14A through 14E describe a method of setting the classification numbers depending on the output resolutions. FIG. 14A shows the “1×1 mode”, that is, a case in which an image is printed on a medium S at a resolution of 360 dpi (width)×360 dpi (length). FIG. 14B shows the “2×1 mode”, that is, a case in which an image is printed on a medium S at a resolution of 720 dpi (width)×360 dpi (length). FIG. 14C shows the “1×2 mode”, that is, a case in which an image is printed on a medium S at a resolution of 360 dpi (width)×720 dpi (length). FIG. 14D shows the “2×2 mode”, that is, a case in which an image is printed on a medium S at a resolution of 720 dpi (width)×720 dpi (length). FIG. 14E shows the “4×2 mode”, that is, a case in which an image is printed on a medium S at a resolution of 1440 dpi (width)×720 dpi (length). It should be noted that the “2×4 mode” and the “4×4 mode” are performed through a similar setting process as that of the “4×2 mode”.

As shown in FIG. 14A, in the “1×1 mode”, the classification number is set taking eight neighboring pixels, among the pixels that make up the CMYK image data, as a unit. More specifically, the same classification number is set to eight neighboring pixels, among the pixels that make up the CMYK image data. Herein, the same classification number is assigned to a total of eight pixels—four pixels in the width direction and two pixels in the length direction—which make up a single unit. More specifically, in this example, as shown in the figure, the classification number “1”, for example, is set to the eight pixels located in the upper left corner of the CMYK image data.

On the other hand, the classification number “2”, for example, is set to the eight pixels (four pixels in the width direction and two pixels in the length direction) adjacent, on the right side in the figure, to the eight pixels to which the classification number “1” is set. Further, the classification number “33”, for example, is set to the eight pixels (four pixels in the width direction and two pixels in the length direction) adjacent, on the lower side in the figure, to the eight pixels to which the classification number “1” is set. Further, the classification number “34”, for example, is set to the eight pixels (four pixels in the width direction and two pixels in the length direction) on the lower right of the eight pixels to which the classification number “1” is set.

Further, as shown in FIG. 14B, in the “2×1 mode”, the classification number is set taking four neighboring pixels, among the pixels that make up the CMYK image data, as a unit. More specifically, the same classification number is set to four neighboring pixels, among the pixels that make up the CMYK image data. Herein, the same classification number is assigned to a total of four pixels—two pixels in the width direction and two pixels in the length direction—which make up a single unit. More specifically, in this example, as shown in the figure, the classification number “1”, for example, is set to the four pixels located in the upper left corner of the CMYK image data.

On the other hand, the classification number “2”, for example, is set to the four pixels (two pixels in the width direction and two pixels in the length direction) adjacent, on the right side in the figure, to the four pixels to which the classification number “1” is set. Further, the classification number “3”, for example, is set to the four pixels (two pixels in the width direction and two pixels in the length direction) adjacent, on the right side in the figure, to those four pixels. Further, the classification number “33”, for example, is set to the four pixels (two pixels in the width direction and two pixels in the length direction) adjacent, on the lower side in the figure, to the four pixels to which the classification number “1” is set. In a similar way, classification numbers are set to each unit of four neighboring pixels for all the other pixels that make up the CMYK image data.

Further, as shown in FIG. 14C, in the “1×2 mode”, the classification number is set taking four neighboring pixels, among the pixels that make up the CMYK image data, as a unit. More specifically, the same classification number is set to four neighboring pixels, among the pixels that make up the CMYK image data. Herein, the same classification number is set to a total of four pixels—four pixels in the width direction and one pixel in the length direction—which make up a single unit. More specifically, in this example, as shown in the figure, the classification number “1”, for example, is set to the four pixels located in the upper left corner of the CMYK image data.

On the other hand, the classification number “2”, for example, is set to the four pixels (four pixels in the width direction and one pixel in the length direction) adjacent, on the right side in the figure, to the four pixels to which the classification number “1” is set. Further, the classification number “33”, for example, is set to the four pixels (four pixels in the width direction and one pixel in the length direction) adjacent, on the lower side in the figure, to the four pixels to which the classification number “1” is set. Further, the classification number “65”, for example, is set to the four pixels (four pixels in the width direction and one pixel in the length direction) adjacent, on the lower side in the figure, to the four pixels to which the classification number “33” is set. Further, the classification number “97”, for example, is set to the four pixels (four pixels in the width direction and one pixel in the length direction) adjacent, on the lower side in the figure, to those four pixels. In a similar way, classification numbers are set to each unit of four neighboring pixels for all the other pixels that make up the CMYK image data.

Further, as shown in FIG. 14D, in the “2×2 mode”, the classification number is set taking two neighboring pixels, among the pixels that make up the CMYK image data, as a unit. More specifically, the same classification number is set to two neighboring pixels, among the pixels that make up the CMYK image data. Herein, the same classification number is set to a total of two pixels—two pixels in the width direction and one pixel in the length direction—which make up a single unit. More specifically, in this example, as shown in the figure, the classification number “1”, for example, is set to the two pixels located in the upper left corner of the CMYK image data.

On the other hand, the classification number “2”, for example, is set to the two pixels (two pixels in the width direction and one pixel in the length direction) adjacent, on the right side in the figure, to the two pixels to which the classification number “1” is set. Further, the classification number “3”, for example, is set to the two pixels (two pixels in the width direction and one pixel in the length direction) adjacent, on the right side in the figure, to the two pixels to which the classification number “2” is set. Further, the classification number “4”, for example, is set to the two pixels (two pixels in the width direction and one pixel in the length direction) adjacent, on the right side in the figure, to those two pixels. Further, the classification number “33”, for example, is set to the two pixels (two pixels in the width direction and one pixel in the length direction) adjacent, on the lower side in the figure, to the two pixels to which the classification number “1” is set. Further, the classification number “65”, for example, is set to the two pixels (two pixels in the width direction and one pixel in the length direction) adjacent, on the lower side in the figure, to the two pixels to which the classification number “33” is set. Further, the classification number “97”, for example, is set to the two pixels (two pixels in the width direction and one pixel in the length direction) adjacent, on the lower side in the figure, to those two pixels. In a similar way, classification numbers are set to each unit of two neighboring pixels for all the other pixels that make up the CMYK image data.

Further, as shown in FIG. 14E, in the “4×2 mode”, a different classification number is set to each of the pixels that make up the CMYK image data. More specifically, in this example, as shown in the figure, the classification number “1”, for example, is set to the pixel located in the upper left corner of the CMYK image data. Further, a different classification number is set to each of the other pixels adjacent to this pixel. That is, for example, the classification number “2”, for example, is set to the pixel adjacent, on the right side in the figure, to the pixel to which the classification number “1” is set. Further, the classification number “3”, for example, is set to the pixel adjacent, on the right side in the figure, to the pixel to which the classification number “2” is set. Further, the classification number “4”, for example, is set to the pixel adjacent, on the right side in the figure, to the pixel to which the classification number “3” is set.

On the other hand, the classification number “33”, for example, is set to the pixel adjacent, on the lower side in the figure, to the pixel to which the classification number “1” is set. Further, the classification number “65”, for example, is set to the pixel adjacent, on the lower side in the figure, to the pixel to which the classification number “33” is set. Further, the classification number “97”, for example, is set to the pixel adjacent, on the lower side in the figure, to the pixel to which the classification number “65” is set.

It should be noted that, in the “2×4 mode” and the “4×4 mode”, setting of the classification numbers is carried out in a similar way as that for the “4×2 mode”.

As described above, setting of the classification number for each pixel in the CMYK image data is carried out according to a different method depending on the resolution (output resolution) used when printing an image on a medium S. Based on the classification number set in this way, the value-multiplexing processing section 182 performs the value-multiplexing processing on the gradation value of each pixel, for each color, in the CMYK image data, which is generated by the color conversion processing section 168, to generate the multivalue gradation-value data.

The multivalue gradation-value data generated through conversion by the value-multiplexing processing section 182 is sent, as print data, by the printer driver 180 from the computer 152 to the inkjet printer 1, as shown in FIG. 10.

===Processes of Inkjet Printer===

The inkjet printer 1 receives the multivalue gradation-value data sent as print data from the computer 152, generates “dot-formation data” based on the multivalue gradation-value data, and prints an image on a medium S. As shown in FIG. 10, inside the inkjet printer 1 is provided a dot-formation-data generating section 184 that generates the dot-formation data. The processing of the dot-formation-data generating section 184 is described in detail below. It should be noted that in this embodiment, the dot-formation-data generation processing of the dot-formation-data generating section 184 is actually executed by the controller 126 of the inkjet printer 1.

<Generation of Dot-Formation Data>

When generating the dot-formation data based on the multivalue gradation-value data sent as print data from the computer 152, the dot-formation-data generating section 184 converts the multivalue gradation-value data into “dot-number data”. Then, based on the dot-number data obtained by this conversion, the dot-formation-data generating section 184 determines whether or not to form a dot individually for each of one or more pixels. The dot-formation-data generating section 184 then generates the dot-formation data by employing at least a portion of the pixels, among the one or more pixels for which whether or not to form a dot has been determined, as a pixel that makes up the image to be printed (i.e., the output image).

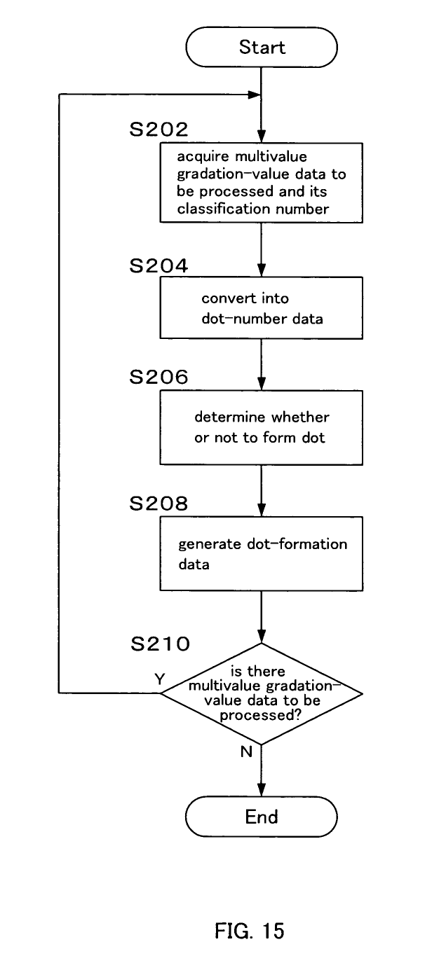

FIG. 15 shows an example of a processing procedure of the dot-formation-data generating section. As shown in FIG. 15, the dot-formation-data generating section 184 first acquires the multivalue gradation-value data and a classification number corresponding thereto (S202). Herein, the “classification number corresponding to the multivalue gradation-value data” is the classification number used when generating that multivalue gradation-value data. The dot-formation-data generating section 184 then acquires “dot-number data” based on the acquired multivalue gradation-value data and the classification number (S204). The “dot-number data” is data that indicates the number of dots to be formed. In this embodiment, the dot-number data is data that is coded to express the number of dots to be formed and also the size of the dot to be formed (i.e., “small dot”, “medium dot”, and “large dot”). The “dot-number data” will be described in detail further below. The dot-formation-data generating section 184 acquires the dot-number data in accordance with a dot-number-data conversion table in which the dot-number data is associated, separately for each classification number, to each multivalue gradation-value data. The dot-number-data conversion table will be described in detail further below.

Next, based on the acquired dot-number data, the dot-formation-data generating section 184 determines whether or not to form a dot for each of the one or more pixels (S206). In the present embodiment, the dot-formation-data generating section 184 determines, based on the acquired dot-number data, whether or not to form a dot for each of eight pixels. In determining whether or not to form a dot, the size of the dot to be formed is also determined.

Then, based on the one or more pixels (eight pixels in this case) for which whether or not to form a dot has been determined, the dot-formation-data generating section 184 generates the dot-formation data (S208). More specifically, the dot-formation data cuts out (extracts) at least a portion of the pixels from the one or more pixels (eight pixels in this case) for which whether or not to form a dot has been determined, and the cut-out pixel/s is/are used as data of the pixels that make up the image to be printed. Herein, all of the pixels may be cut out (extracted) from the one or more pixels (eight pixels in this case) for which whether or not to form a dot has been determined, and used as the data of the pixels that make up the image to be printed. The number of pixels to be cut out from the one or more pixels (eight pixels in this case) for which whether or not to form a dot has been determined differs depending on the resolution (output resolution) used when printing the image on the medium S. In this way, the dot-formation-data generating section 184 generates the dot-formation data.

After finishing generating the dot-formation data for a certain piece of multivalue gradation-value data, the dot-formation-data generating section 184 checks whether or not there are other pieces of multivalue gradation-value data to be processed (S210). If there is a piece of multivalue gradation-value data to be processed next, the dot-formation-data generating section 184 returns to step S202, and again executes the processing for generating the dot-formation data with respect to the multivalue gradation-value data to be processed. The dot-formation-data generating section 184 repeats such processing until there are no more pixels to be processed. If there are no more pieces of multivalue gradation-value data to be processed, then the dot-formation-data generating section 184 immediately ends its process.

<Dot-Number-Data Conversion Table>

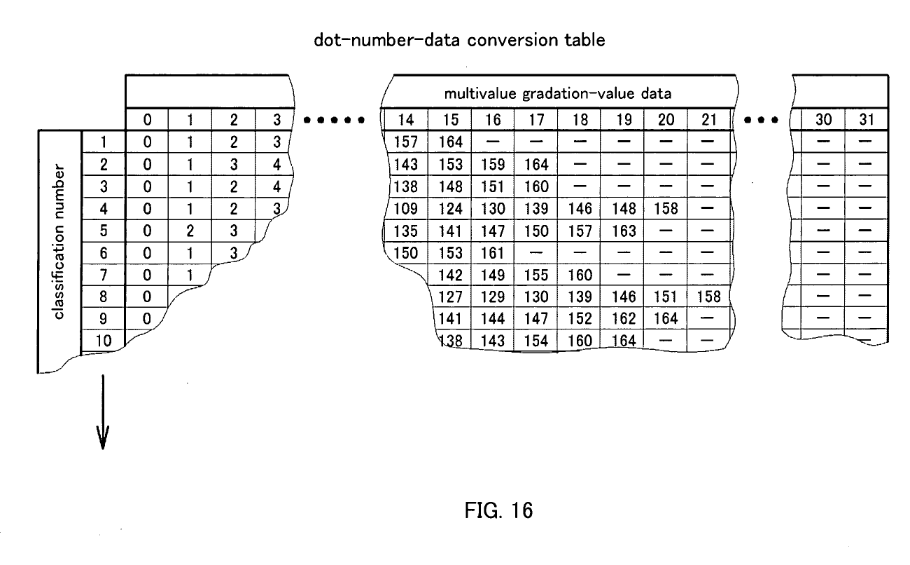

FIG. 16 schematically shows an example of a dot-number-data conversion table used when converting the multivalue gradation-value data into dot-number data. As shown in FIG. 16, the dot-number-data conversion table is a table in which a piece of dot-number data is set corresponding to each classification number and each multivalue gradation-value data. For example, in the dot-number-data conversion table, as shown in the figure, the “classification number” is set in the lengthwise direction and the “multivalue gradation-value data” is set in the width direction, and a corresponding piece of dot-number data can be found from the “classification number” and the “multivalue gradation-value data”. The “classification number” is expressed as a number ranging from “1” to “1024”, as described previously. The “multivalue gradation-value data” is expressed as a value ranging from “0” to “31”. Further, here, the “dot-number data” is set to take on a value ranging from “0” to “164”. A piece of dot-number data is provided separately for each classification number ranging from “1” to “1024” and for each multivalue gradation-value data ranging from “0” to “31”.

The classification number “1” is described below as an example. As for the classification number “1”, the dot-number data “0” is set to the multivalue gradation-value data “1”, the dot-number data “3” is set to the multivalue gradation-value data “3”, the dot-number data “157” is set to the multivalue gradation-value data “14”, and the dot-number data “164” is set to the multivalue gradation-value data “15”.

The inkjet printer 1 stores, in advance, data on the dot-number-data conversion table in its main memory 127 etc. (see FIG. 5). When converting the multivalue gradation-value data into dot-number data, the dot-formation-data generating section 184 acquires the data on the dot-number-data conversion table from the main memory 127 etc.

<Dot-Number Data>

As described above, in this embodiment, the dot-number data is data that is coded to express the number of dots to be formed and also the size of the dot to be formed (i.e., “small dot”, “medium dot”, and “large dot”).

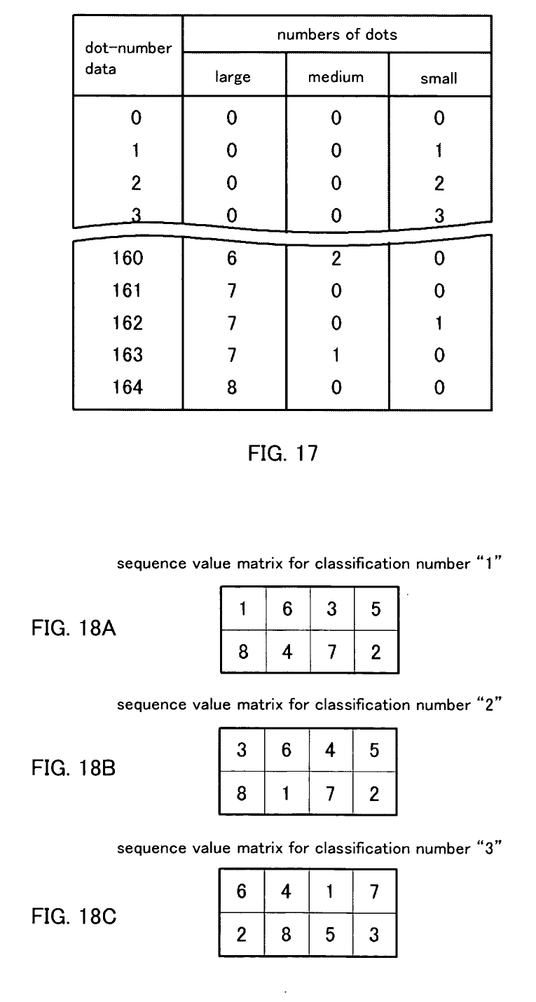

FIG. 17 shows an example of a correspondence between the dot-number data and information on the number and the size of the dots to be formed that is expressed by the dot-number data. As described above, the dot-number data is set to take on a value ranging from “0” to “164”. Each value, ranging from “0” to “164”, of the dot-number data expresses whether or not to form dots and the size of the dots. More specifically, the dot-number data “0” indicates that no dots are to be formed in any of the sizes “small dot”, “medium dot”, and “large dot”. Further, the dot-number data “1” indicates that only one “small dot” is to be formed. Further, the dot-number data “2” indicates that only two “small dots” are to be formed. Further, the dot-number data “3” indicates that only three “small dots” are to be formed. Further, the dot-number data “160” indicates that six “large dots”, two “medium dots”, and no “small dot” are to be formed. Further, the dot-number data “161” indicates that only seven “large dots” are to be formed. Further, the dot-number data “164” indicates that only eight “large dots” are to be formed.

The reason why the dot-number data is expressed in this way is because in this embodiment, whether or not to form a dot has to be determined for eight pixels based on the acquired dot-number data. In other words, the number of dots that could be formed in eight pixels is eight at most. For example, a dot-number combination of four large dots, three medium dots, and two small dots cannot actually occur because the total number of dots will be nine, which is larger than eight. In view of such a fact, it is considered that there are not so many types of dot-number combinations that can actually occur. The actual calculation is as follows. As for eight pixels, each pixel may take on four states: “form a large dot”, “form a medium dot”, “form a small dot”, and “form no dot”. Therefore, the number of dot-number combinations will be equal to the number of combinations when these four states are selected eight times, while allowing repetition, and can be obtained by ₄H₈ (=₄₊₈₋₁C₈). Thus, there will only be 165 types of combinations at most. Here, ₙHᵣ is an operator for finding the number of repeated combinations when performing selection from “n” pieces of articles “r” times while allowing repetition. Further, ₙCᵣ is an operator for finding the number of combinations when performing selection from “n” pieces of articles “r” times without allowing repetition. 165 combinations can be expressed using 8 bits.

On the other hand, if the number of dots were to be expressed without coding, a total of 12 bits of data will be necessary, four bits each for expressing the number of large dots, the number of medium dots, and the number of small dots. In contrast, by setting code numbers to the dot-number combinations that may actually occur, it is possible to express the combinations of the number of dots to be formed using only 8 bits of data. That is, by expressing the dot-number combination using a code, it is possible to reduce the necessary data amount compared to when the number of dots to be formed is expressed for each type of dot.

It should be noted that it goes without saying that, as for the dot-number data, it is possible to use 12-bit data expressed without coding the number of dots for each size, instead of the above-described 8-bit data.

<Determination of Whether or Not to Form Dots>

In this embodiment, the dot-formation-data generating section 184 determines whether or not to form a dot for each of the one or more pixels based on the acquired dot-number data. In this embodiment, the dot-formation-data generating section 184 determines, based on the dot-number data, whether or not to form a dot for each of the eight pixels (four pixels in the width direction and two pixels in the length direction) and also determines the size of the dots. Determination of whether or not to form dots for each of the eight pixels is carried out in accordance with a sequence value matrix. It should be noted that the sequence value matrix corresponds to the “dot-formation sequence data”.

Herein, the sequence value matrix is a matrix in which the order of forming dots in eight pixels is set. In the sequence value matrix, numbers indicating the order of forming dots in a total of eight pixels—four pixels in the width direction and two in the length direction—are set. The numbers indicating the dot-formation order set for each of the eight pixels are set individually for the respective classification numbers. That is, a different matrix is used as the sequence value matrix for each classification number.

<Sequence Value Matrix>

FIG. 18 shows an example of a sequence value matrix used in this example. FIG. 18A shows an example of a sequence value matrix set in correspondence to the classification number “1”. FIG. 18B shows an example of a sequence value matrix set in correspondence to the classification number “2”. FIG. 18C shows an example of a sequence value matrix set in correspondence to the classification number “3”.

As shown in FIG. 18A, in the sequence value matrix corresponding to the classification number “1”, a value “1”, which indicates the order for forming dots, is set to the pixel in the upper left corner of the eight pixels for which whether or not to form dots is to be determined. The value “1” in the pixel in the upper left corner indicates that a dot is to be formed first in that pixel among the eight pixels. It should be noted that the number set in the sequence value matrix and indicative of the order is also referred to as a “sequence value”. Further, a sequence value “2” is set to the pixel in the lower right corner of the eight pixels, and this indicates that a dot is to be formed second in that pixel among the eight pixels. In this way, sequence values indicating the order of forming dots are set in the sequence value matrix for each of the eight pixels. Here, since there are eight pixels, the numbers from “1” to “8” are set to the eight pixels as the sequence values. It should be noted that a different sequence value is set to each of the eight pixels.

On the other hand, as shown in FIG. 18B, in the sequence value matrix corresponding to the classification number “2”, the pixel in which a dot is to be formed first (i.e., the pixel with the sequence value “1”) is set to be the second pixel from the left on the lower stage. Further, the pixel in which a dot is to be formed second (i.e., the pixel with the sequence value “2”) is set to be the pixel in the lower right corner. Furthermore, as shown in FIG. 18C, in the sequence value matrix corresponding to the classification number “3”, the pixel in which a dot is to be formed first (i.e., the pixel with the sequence value “1”) is set to be the second pixel from the right on the upper stage. Further, the pixel in which a dot is to be formed second (i.e., the pixel with the sequence value “2”) is set to be the pixel in the lower left corner.

The inkjet printer 1 stores, in advance, data on the sequence value matrices corresponding to each of the classification numbers “1” to “1024” in its main memory 127 etc. (see FIG. 5). When determining whether or not to form dots individually for each of the eight pixels, the dot-formation-data generating section 184 acquires the data on the sequence value matrix from the main memory 127 etc.

<Determination for Each Pixel>

After acquiring the data on the sequence value matrix, the dot-formation-data generating section 184 first determines, from among the eight pixels, the pixel(s) in which large dots are to be formed. Since large dots stand out compared to the dots of the other sizes, it is preferable to determine the positions of the pixels in which to form large dots prior to the other types of dots in order to dispersedly form the dots to the extent possible. Therefore, the pixels in which the large dots are to be formed are determined first. In determining the pixels for forming the dots, the dot-number data obtained by converting the multivalue gradation-value data and the sequence value matrix corresponding thereto are used.

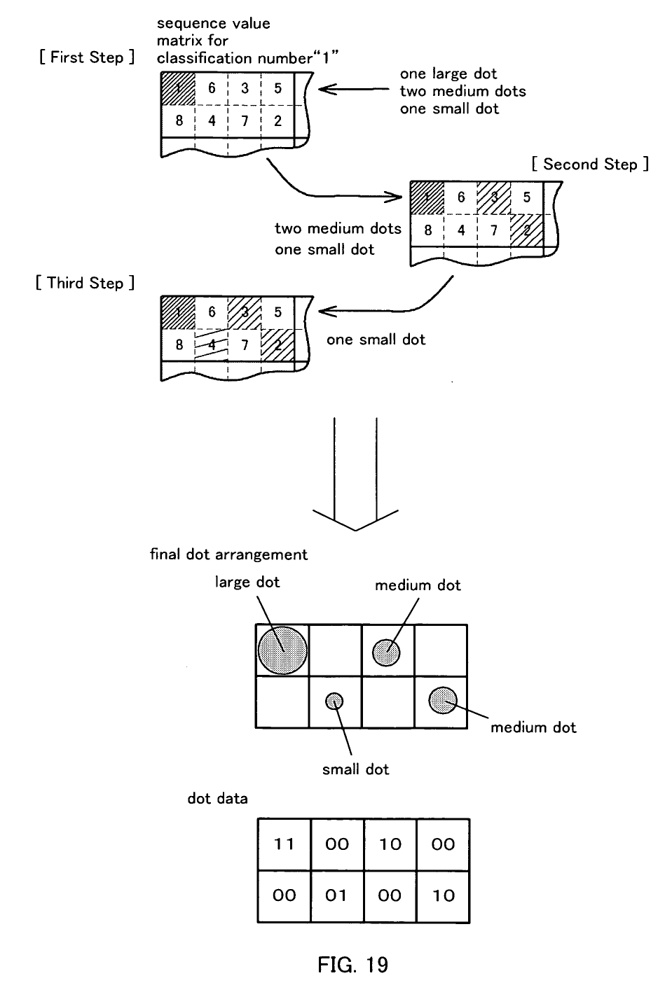

FIG. 19 schematically shows an example of a procedure for determining whether or not to form dots for each of the eight pixels based on the dot-number data and the sequence value matrix. In this example, the dot-number data indicates to form one large dot, two medium dots, and one small dot, and the sequence value matrix is a matrix corresponding to the classification number “1” shown in FIG. 18A.

As described above, the order of forming dots in the eight pixels is set in the sequence value matrix. Herein, first, the pixels in which the largest dots, that is, the large dots, are to be formed are determined in [step 1]. The number of large dots to be formed is “1” in this example, and therefore, the pixel in which a large dot is to be formed is the single pixel to which the sequence value “1” is set. That is, in FIG. 19, the pixel with the fine hatching, among the eight pixels, is selected.

Next, the pixels in which the second largest dots, that is, the medium dots, are to be formed are determined in [step 2]. The number of medium dots to be formed is “2” in this example, and therefore, the pixels in which a medium dot is to be formed are the two pixels to which the sequence values “2” and “3” are set. That is, in FIG. 19, the pixels with the slightly coarse hatching, among the eight pixels, are selected.

Then, the pixels in which the third largest dots, that is, the small dots, are to be formed are determined in [step 3]. The number of small dots to be formed is “1” in this example, and therefore, the pixel in which a small dot is to be formed is the single pixel to which the sequence value “4” is set. That is, in FIG. 19, the pixel with the coarse hatching, among the eight pixels, is selected.

In this way, the pixels, among the eight pixels, in which the large dots, the medium dots, and the small dots are to be formed are determined. The rest of the pixels in which none of a large dot, a medium dot, nor a small dot is designated are regarded as pixels in which no dot is formed. As a result, the dots are arranged in the way indicated in the lower section of FIG. 19. The data for forming the dots in the eight pixels takes the form of the dot data also shown in the lower section of FIG. 19.

<Cutting Out Pixels>

Next, the dot-formation-data generating section 184 cuts out at least a portion of the pixels from among the eight pixels for which the positions and sizes of the dots to be formed have been determined, and uses the cut-out pixels as the dot-formation data of the pixels that make up the image to be printed. The number of pixels that are cut out in this step differs depending on the resolution (output resolution) used when printing the image on the medium S. Further, the positions of the pixels that are cut out from the eight pixels differ depending on the positions of the pixels within the CMYK image data when generating the multivalue gradation-value data.

(1) 1×1 Mode

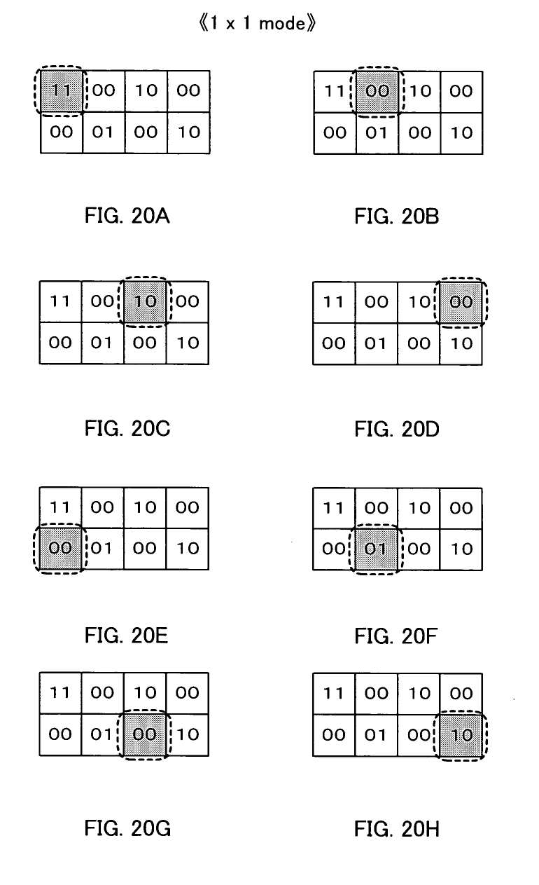

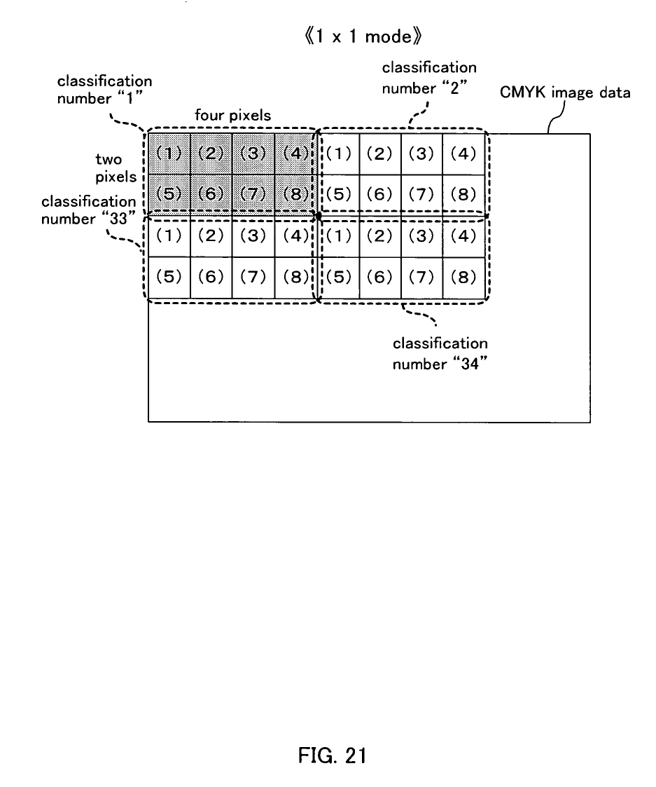

As for the “1×1 mode”, the resolution (output resolution) used when printing the image on the medium S is the same as the resolution of the CMYK image data. Therefore, the number of pixels to be cut out is “1”. FIG. 20 shows the positions of the pixels cut out from the eight pixels. FIGS. 20A through 20H respectively show patterns of the positions of the cut-out pixels. FIG. 21 shows the positions of the pixels within the CMYK image data.

FIG. 20A shows how a pixel located in the upper left corner, among the eight pixels, is cut out. FIG. 20B shows how a pixel located second from the left on the upper stage, among the eight pixels, is cut out. FIG. 20C shows how a pixel located second from the right on the upper stage, among the eight pixels, is cut out. FIG. 20D shows how a pixel located in the upper right corner, among the eight pixels, is cut out. FIG. 20E shows how a pixel located in the lower left corner, among the eight pixels, is cut out. FIG. 20F shows how a pixel located second from the left on the lower stage, among the eight pixels, is cut out. FIG. 20G shows how a pixel located second from the right on the lower stage, among the eight pixels, is cut out. FIG. 20H shows how a pixel located in the lower right corner, among the eight pixels, is cut out.

As shown in FIG. 20A, the pixel located in the upper left corner, among the eight pixels, is cut out when the position of the pixel referenced in the CMYK image data when generating the multivalue gradation-value data is at the position indicated by “(1)” in FIG. 21, that is, at the position in the upper left corner among the pixels to which the same classification number is set. In other words, in this example, the pixel cut-out process of FIG. 20A is performed when generating the dot-formation data based on the multivalue gradation-value data that is obtained by performing the value-multiplexing processing on the gradation value of the pixel located in the upper left corner of the eight pixels, constituted by four pixels (width)×2 pixels (length), to which one of the classification numbers “1”, “2”, “33”, and “34” shown in FIG. 21 is set. In this example, pixel data “11” is acquired as the dot-formation data through this cut-out process.

Further, as shown in FIG. 20B, the pixel located second from the left on the upper stage, among the eight pixels, is cut out when the position of the pixel referenced in the CMYK image data when generating the multivalue gradation-value data is at the position indicated by “(2)” in FIG. 21, that is, at the position second from the left on the upper stage among the pixels to which the same classification number is set. In other words, in this example, the pixel cut-out process of FIG. 20B is performed when generating the dot-formation data based on the multivalue gradation-value data that is obtained by performing the value-multiplexing processing on the gradation value of the pixel located second from the left on the upper stage of the eight pixels, constituted by four pixels (width)×2 pixels (length), to which one of the classification numbers “1”, “2”, “33”, and “34” shown in FIG. 21 is set. In this example, pixel data “00” is acquired as the dot-formation data through this cut-out process.

Further, as shown in FIG. 20C, the pixel located second from the right on the upper stage, among the eight pixels, is cut out when the position of the pixel referenced in the CMYK image data when generating the multivalue gradation-value data is at the position indicated by “(3)” in FIG. 21, that is, at the position second from the right on the upper stage among the pixels to which the same classification number is set. In other words, in this example, the pixel cut-out process of FIG. 20C is performed when generating the dot-formation data based on the multivalue gradation-value data that is obtained by performing the value-multiplexing processing on the gradation value of the pixel located second from the right on the upper stage of the eight pixels, constituted by four pixels (width)×2 pixels (length), to which one of the classification numbers “1”, “2”, “33”, and “34” shown in FIG. 21 is set. In this example, pixel data “10” is acquired as the dot-formation data through this cut-out process.

Further, as shown in FIG. 20D, the pixel located in the upper right corner, among the eight pixels, is cut out when the position of the pixel referenced in the CMYK image data when generating the multivalue gradation-value data is at the pixel position indicated by “(4)” in FIG. 21, that is, at the position in the upper right corner among the pixels to which the same classification number is set. In other words, in this example, the pixel cut-out process of FIG. 20D is performed when generating the dot-formation data based on the multivalue gradation-value data that is obtained by performing the value-multiplexing processing on the gradation value of the pixel located in the upper right corner of the eight pixels, constituted by four pixels (width)×2 pixels (length), to which one of the classification numbers “1”, “2”, “33”, and “34” shown in FIG. 21 is set. In this example, pixel data “00” is acquired as the dot-formation data through this cut-out process.

As shown in FIG. 20E, the pixel located in the lower left corner, among the eight pixels, is cut out when the position of the pixel referenced in the CMYK image data when generating the multivalue gradation-value data is at the position indicated by “(5)” in FIG. 21, that is, at the position in the lower left corner among the pixels to which the same classification number is set. In other words, in this example, the pixel cut-out process of FIG. 20E is performed when generating the dot-formation data based on the multivalue gradation-value data that is obtained by performing the value-multiplexing processing on the gradation value of the pixel located in the lower left corner of the eight pixels, constituted by four pixels (width)×2 pixels (length), to which one of the classification numbers “1”, “2”, “33”, and “34” shown in FIG. 21 is set. In this example, pixel data “00” is acquired as the dot-formation data through this cut-out process.

Further, as shown in FIG. 20F, the pixel located second from the left on the lower stage, among the eight pixels, is cut out when the position of the pixel referenced in the CMYK image data when generating the multivalue gradation-value data is at the position indicated by “(6)” in FIG. 21, that is, at the position second from the left on the lower stage among the pixels to which the same classification number is set. In other words, in this example, the pixel cut-out process of FIG. 20F is performed when generating the dot-formation data based on the multivalue gradation-value data that is obtained by performing the value-multiplexing processing on the gradation value of the pixel located second from the left on the lower stage of the eight pixels, constituted by four pixels (width)×2 pixels (length), to which one of the classification numbers “1”, “2”, “33”, and “34” shown in FIG. 21 is set. In this example, pixel data “01” is acquired as the dot-formation data through this cut-out process.

Further, as shown in FIG. 20G, the pixel located second from the right on the lower stage, among the eight pixels, is cut out when the position of the pixel referenced in the CMYK image data when generating the multivalue gradation-value data is at the position indicated by “(7)” in FIG. 21, that is, at the position second from the right on the lower stage among the pixels to which the same classification number is set. In other words, in this example, the pixel cut-out process of FIG. 20G is performed when generating the dot-formation data based on the multivalue gradation-value data that is obtained by performing the value-multiplexing processing on the gradation value of the pixel located second from the right on the lower stage of the eight pixels, constituted by four pixels (width)×2 pixels (length), to which one of the classification numbers “1”, “2”, “33”, and “34” shown in FIG. 21 is set. In this example, pixel data “00” is acquired as the dot-formation data through this cut-out process.

Further, as shown in FIG. 20H, the pixel located in the lower right corner, among the eight pixels, is cut out when the position of the pixel referenced in the CMYK image data when generating the multivalue gradation-value data is at the pixel position indicated by “(8)” in FIG. 21, that is, at the position in the lower right corner among the pixels to which the same classification number is set. In other words, in this example, the pixel cut-out process of FIG. 20H is performed when generating the dot-formation data based on the multivalue gradation-value data that is obtained by performing the value-multiplexing processing on the gradation value of the pixel located in the lower right corner of the eight pixels, constituted by four pixels (width)×2 pixels (length), to which one of the classification numbers “1”, “2”, “33”, and “34”, shown in FIG. 21 is set. In this example, pixel data “10” is acquired as the dot-formation data through this cut-out process.

(2) 2×1 Mode

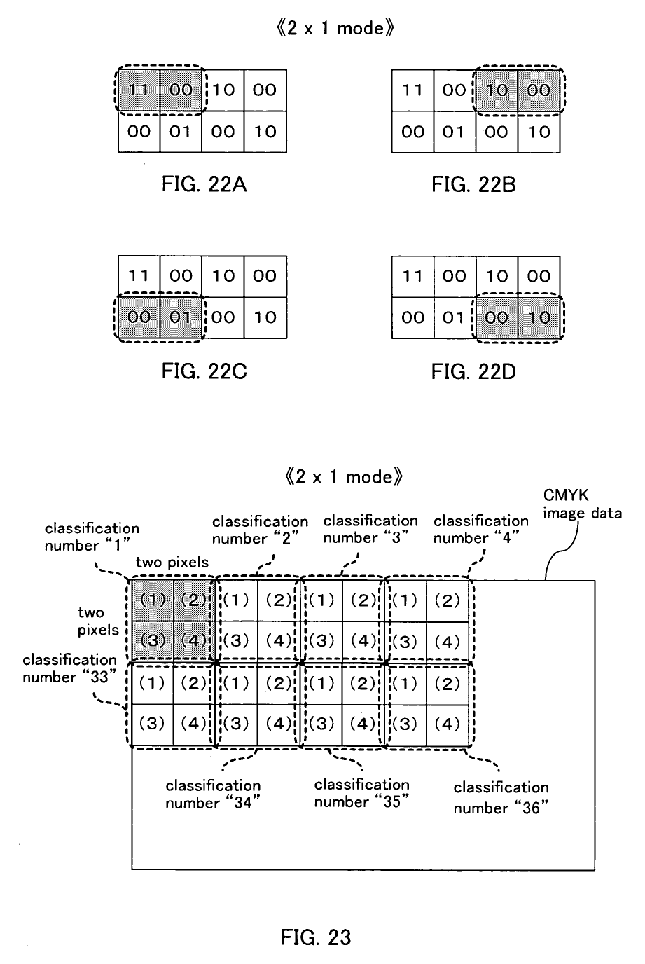

As for the “2×1 mode”, the resolution (output resolution) in the width direction used when printing the image on the medium S is twice the resolution of the CMYK image data. Therefore, the pixels to be cut out in the “2×1 mode” are two pixels, among the eight pixels, adjacent to one another in the width direction. FIG. 22 shows the positions of the pixels that are cut out from the eight pixels. FIGS. 22A through 22D respectively show the positions of the cut-out pixels. FIG. 23 shows the positions of the pixels within the CMYK image data.

FIG. 22A shows how pixels located furthest to the left and second from the left on the upper stage, among the eight pixels, are cut out. FIG. 22B shows how pixels located furthest to the right and second from the right on the upper stage, among the eight pixels, are cut out. FIG. 22C shows how pixels located furthest to the left and second from the left on the lower stage, among the eight pixels, are cut out. FIG. 22D shows how pixels located furthest to the right and second from the right on the lower stage, among the eight pixels, are cut out.

As shown in FIG. 22A, the pixels located furthest to the left and second from the left on the upper stage, among the eight pixels, are cut out when the position of the pixel referenced in the CMYK image data when generating the multivalue gradation-value data is at the position indicated by “(1)” in FIG. 23, that is, at the position in the upper left corner among the pixels to which the same classification number is set. In other words, in this example, the pixel cut-out process of FIG. 22A is performed when generating the dot-formation data based on the multivalue gradation-value data that is obtained by performing the value-multiplexing processing on the gradation value of the pixel located in the upper left corner of the four pixels, constituted by 2 pixels (width)×2 pixels (length), to which one of the classification numbers “1” through “4” and “33” through “36” shown in FIG. 23 is set. In this example, two pieces of pixel data “11” and “00” adjacent to one another in the width direction are acquired as the dot-formation data through this cut-out process.

As shown in FIG. 22B, the pixels located furthest to the right and second from the right on the upper stage, among the eight pixels, are cut out when the position of the pixel referenced in the CMYK image data when generating the multivalue gradation-value data is at the position indicated by “(2)” in FIG. 23, that is, at the position in the upper right corner among the pixels to which the same classification number is set. In other words, in this example, the pixel cut-out process of FIG. 22B is performed when generating the dot-formation data based on the multivalue gradation-value data that is obtained by performing the value-multiplexing processing on the gradation value of the pixel located in the upper right corner of the four pixels, constituted by 2 pixels (width)×2 pixels (length), to which one of the classification numbers “1” through “4” and “33” through “36” shown in FIG. 23 is set. In this example, two pieces of pixel data “10” and “00” adjacent to one another in the width direction are acquired as the dot-formation data through this cut-out process.

As shown in FIG. 22C, the pixels located furthest to the left and second from the left on the lower stage, among the eight pixels, are cut out when the position of the pixel referenced in the CMYK image data when generating the multivalue gradation-value data is at the position indicated by “(3)” in FIG. 23, that is, at the position in the lower left corner among the pixels to which the same classification number is set. In other words, in this example, the pixel cut-out process of FIG. 22C is performed when generating the dot-formation data based on the multivalue gradation-value data that is obtained by performing the value-multiplexing processing on the gradation value of the pixel located in the lower left corner of the four pixels, constituted by 2 pixels (width)×2 pixels (length), to which one of the classification numbers “1” through “4” and “33” through “36” shown in FIG. 23 is set. In this example, two pieces of pixel data “00” and “01” adjacent to one another in the width direction are acquired as the dot-formation data through this cut-out process.

As shown in FIG. 22D, the pixels located furthest to the right and second from the right on the lower stage, among the eight pixels, are cut out when the position of the pixel referenced in the CMYK image data when generating the multivalue gradation-value data is at the position indicated by “(4)” in FIG. 23, that is, at the position in the lower right corner among the pixels to which the same classification number is set. In other words, in this example, the pixel cut-out process of FIG. 22D is performed when generating the dot-formation data based on the multivalue gradation-value data that is obtained by performing the value-multiplexing processing on the gradation value of the pixel located in the lower right corner of the four pixels, constituted by 2 pixels (width)×2 pixels (length), to which one of the classification numbers “1” through “4” and “33” through “36” shown in FIG. 23 is set. In this example, two pieces of pixel data “00”, and “10” adjacent to one another in the width direction are acquired as the dot-formation data through this cut-out process.

(3) 1×2 Mode

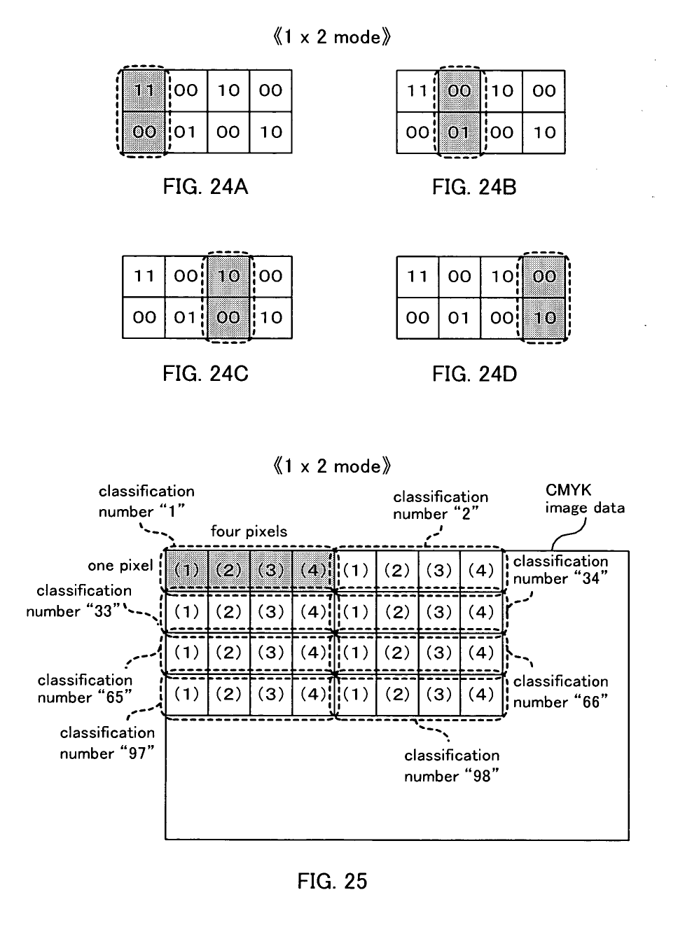

As for the “1×2 mode”, the resolution (output resolution) in the length direction used when printing the image on the medium S is twice the resolution of the CMYK image data. Therefore, the pixels to be cut out in the “1×2 mode” are two pixels, among the eight pixels, adjacent to one another in the length direction. FIG. 24 shows the positions of the pixels that are cut out from the eight pixels. FIGS. 24A through 24D respectively show the positions of the cut-out pixels. FIG. 25 shows the positions of the pixels within the CMYK image data.

FIG. 24A shows how two vertically-adjacent pixels located furthest to the left, among the eight pixels, are cut out. FIG. 24B shows how two vertically-adjacent pixels located second from the left, among the eight pixels, are cut out. FIG. 24C shows how two vertically-adjacent pixels located second from the right, among the eight pixels, are cut out. FIG. 24D shows how two vertically-adjacent pixels located furthest to the right, among the eight pixels, are cut out.

As shown in FIG. 24A, the two vertically-adjacent pixels located furthest to the left, among the eight pixels, are cut out when the position of the pixel referenced in the CMYK image data when generating the multivalue gradation-value data is at the position indicated by “(1)” in FIG. 25, that is, at the position furthest to the left among the pixels to which the same classification number is set. In other words, in this example, the pixel cut-out process of FIG. 24A is performed when generating the dot-formation data based on the multivalue gradation-value data that is obtained by performing the value-multiplexing processing on the gradation value of the pixel located furthest to the left of the four pixels, constituted by 4 pixels (width)×1 pixel (length), to which one of the classification numbers “1”, “2”, “33”, “34”, “65”, “66”, “97”, and “98” shown in FIG. 25 is set. In this example, two pieces of pixel data “11” and “00”, adjacent to one another in the length direction are acquired as the dot-formation data through this cut-out process.

As shown in FIG. 24B, the two vertically-adjacent pixels located second from the left, among the eight pixels, are cut out when the position of the pixel referenced in the CMYK image data when generating the multivalue gradation-value data is at the position indicated by “(2)” in FIG. 25, that is, at the position second from the left among the pixels to which the same classification number is set. In other words, in this example, the pixel cut-out process of FIG. 24B is performed when generating the dot-formation data based on the multivalue gradation-value data that is obtained by performing the value-multiplexing processing on the gradation value of the pixel located second from the left of the four pixels, constituted by 4 pixels (width)×1 pixel (length), to which one of the classification numbers “1”, “2”, “33”, “34”, “65”, “66”, “97”, and “98” shown in FIG. 25 is set. In this example, two pieces of pixel data “00” and “01” adjacent to one another in the length direction are acquired as the dot-formation data through this cut-out process.

As shown in FIG. 24C, the two vertically-adjacent pixels located second from the right, among the eight pixels, are cut out when the position of the pixel referenced in the CMYK image data when generating the multivalue gradation-value data is at the position indicated by “(3)” in FIG. 25, that is, at the position second from the right among the pixels to which the same classification number is set. In other words, in this example, the pixel cut-out process of FIG. 24C is performed when generating the dot-formation data based on the multivalue gradation-value data that is obtained by performing the value-multiplexing processing on the gradation value of the pixel located second from the right of the four pixels, constituted by 4 pixels (width)×1 pixel (length), to which one of the classification numbers “1”, “2”, “33”, “34”, “65”, “66”, “97”, and “98” shown in FIG. 25 is set. In this example, two pieces of pixel data “10” and “00” adjacent to one another in the length direction are acquired as the dot-formation data through this cut-out process.

As shown in FIG. 24D, the two vertically-adjacent pixels located furthest to the right, among the eight pixels, are cut out when the position of the pixel referenced in the CMYK image data when generating the multivalue gradation-value data is at the position indicated by “(4)” in FIG. 25, that is, at the position furthest to the right among the pixels to which the same classification number is set. In other words, in this example, the pixel cut-out process of FIG. 24D is performed when generating the dot-formation data based on the multivalue gradation-value data that is obtained by performing the value-multiplexing processing on the gradation value of the pixel located furthest to the right of the four pixels, constituted by 4 pixels (width)×1 pixel (length), to which one of the classification numbers “1”, “2”, “33”, “34”, “65”, “66”, “97”, and “98” shown in FIG. 25 is set. In this example, two pieces of pixel data “00” and “10” adjacent to one another in the length direction are acquired as the dot-formation data through this cut-out process.

(4) 2×2 Mode

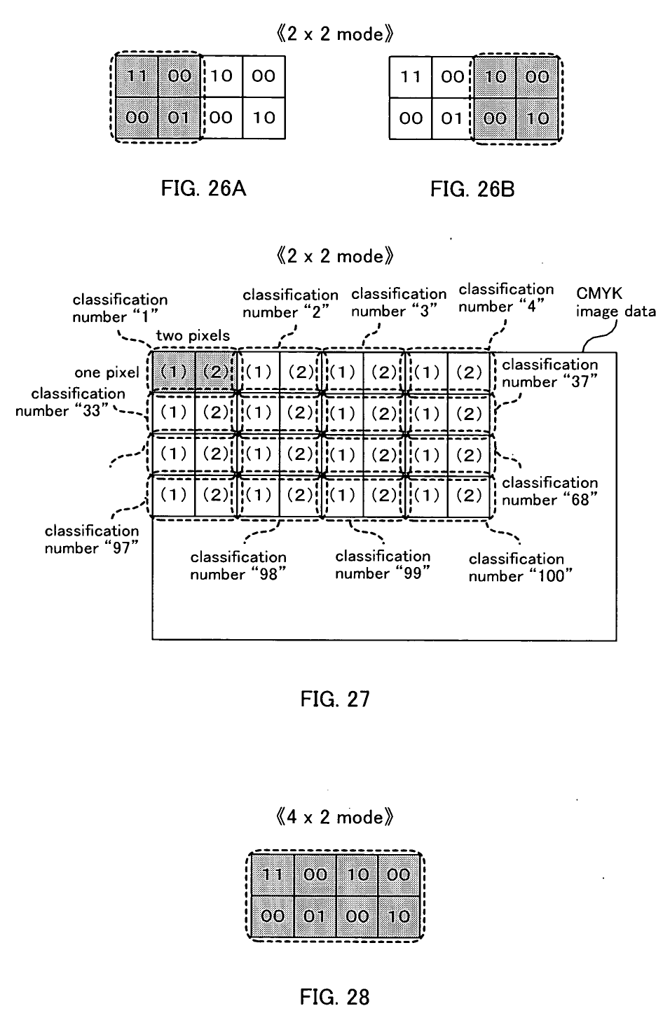

As for the “2×2 mode”, the resolution (output resolution) in both the width direction and the length direction used when printing the image on the medium S is twice the resolution of the CMYK image data. Therefore, the pixels to be cut out in the “2×2 mode” are four pixels, among the eight pixels, constituted by two pixels in the width direction and two pixels in the length direction. FIG. 26 shows the positions of the pixels that are cut out from the eight pixels. FIGS. 26A and 26B respectively show the positions of the cut-out pixels. FIG. 27 shows the positions of the pixels within the CMYK image data.

As shown in FIG. 26A, the four vertically-and-horizontally-adjacent pixels located on the left side, among the eight pixels, are cut out when the position of the pixel referenced in the CMYK image data when generating the multivalue gradation-value data is at the position indicated by “(1)” in FIG. 27, that is, at the position on the left side among the pixels to which the same classification number is set. In other words, in this example, the pixel cut-out process of FIG. 26A is performed when generating the dot-formation data based on the multivalue gradation-value data that is obtained by performing the value-multiplexing processing on the gradation value of the pixel located on the left side among the two pixels, constituted by 2 pixels (width)×1 pixel (length), to which one of the classification numbers “1” through “4”, “33” through “37”, “65”, through “68”, and “97” through “100” shown in FIG. 27 is set. In this example, four pieces of pixel data “11”, “00”, “00”, and “01” adjacent to one another in the length and width directions are acquired as the dot-formation data through this cut-out process.

As shown in FIG. 26B, the four vertically-and-horizontally-adjacent pixels located on the right side, among the eight pixels, are cut out when the position of the pixel referenced in the CMYK image data when generating the multivalue gradation-value data is at the position indicated by “(2)” in FIG. 27, that is, at the position on the right side among the pixels to which the same classification number is set. In other words, in this example, the pixel cut-out process of FIG. 26B is performed when generating the dot-formation data based on the multivalue gradation-value data that is obtained by performing the value-multiplexing processing on the gradation value of the pixel located on the right side among the two pixels, constituted by 2 pixels (width)×1 pixel (length), to which one of the classification numbers “1” through “4”, “33” through “37”, “65” through “68”, and “97” through “100” shown in FIG. 27 is set. In this example, four pieces of pixel data “10”, “00”, “00”, and “10” adjacent to one another in the length and width directions are acquired as the dot-formation data through this cut-out process.

(5) 4×2 Mode

As for the “4×2 mode”, the resolution (output resolution) in the width direction used when printing the image on the medium S is four times the resolution of the CMYK image data, and the resolution (output resolution) in the length direction used when printing the image on the medium S is twice the resolution of the CMYK image data. Therefore, the pixels to be cut out in the “4×2 mode” are all eight pixels. FIG. 28 shows the positions of the pixels that are cut out from the eight pixels. As shown in FIG. 28, all eight pixels for which the positions and sizes of the dots to be formed have been determined are cut out as the dot-formation data. That is, eight pieces of pixel data “11”, “00”, “10”, “00”, “00”, “01”, “00”, and “10”, four pieces being aligned in the width direction and two pieces being aligned in the length direction, are acquired as the dot-formation data through this cut-out process.

<Other Modes>

As for the “1×1 mode”, the “2×1 mode”, the “1×2 mode”, the “2×2 mode”, and the “4×2 mode”, the dot-formation data is generated according to the methods described above. As for the other modes, that is, the “2×4 mode”, and the “4×4 mode”, the dot-formation data is generated according to methods different from those described above. Below, these methods will be described.

(1) 2×4 Mode

In the “2×4 mode”, the process of converting the multivalue gradation-value data into the dot-number data is different compared to that of the other modes described above. In this mode, the multivalue gradation-value data is converted into the dot-number data using a dot-number-data conversion table for the “2×4 mode”, which is different from the dot-number-data conversion table described in FIG. 16.

FIG. 29 schematically shows an example of a dot-number-data conversion table for the “2×4 mode”. Similar to the dot-number-data conversion table shown in FIG. 16, the present dot-number-data conversion table is a table in which a piece of dot-number data is set corresponding to each classification number and each multivalue gradation-value data, and a corresponding piece of dot-number data can be found from the “classification number” and the “multivalue gradation-value data”. The “classification number” is expressed as a number ranging from “1” to “1024”, as in FIG. 16. The “multivalue gradation-value data” is expressed as a value ranging from “0” to “31”, as in FIG. 16. Further, the “dot-number data” is set to take on a value ranging from “0” to “164”, as in FIG. 16. A piece of dot-number data is provided separately for each classification number ranging from “1” to “1024” and for each multivalue gradation-value data ranging from “0” to “31”.

It should be noted that the “dot-number data” is data that is coded to express the number of dots to be formed and also the size of the dot to be formed (i.e., “small dot”, “medium dot”, and “large dot”). In this example, the “dot-number data” is expressed using values from “0” to “164” as described in FIG. 17, because it includes information on the number of dots formed in eight pixels.

The inkjet printer 1 stores, in advance, data on the dot-number-data conversion table used for the “2×4 mode” in its main memory 127 etc. (see FIG. 5). When converting the multivalue gradation-value data into dot-number data using the “2×4 mode”, the dot-formation-data generating section 184 acquires the data on the dot-number-data conversion table for the “2×4 mode” from the main memory 127 etc.

In the “2×4 mode”, the dot-formation-data generating section 184 references this dot-number-data conversion table to convert the multivalue gradation-value data into the dot-number data. Then, based on the dot-number data obtained through this conversion, the dot-formation-data generating section 184 determines whether or not to form a dot individually for each of a total of eight pixels, constituted by two pixels in the width direction and four pixels in the length direction. Here, the dot-formation-data generating section 184 determines whether or not to form a dot individually for the eight pixels based on sequence value matrices provided for the “2×4 mode”.

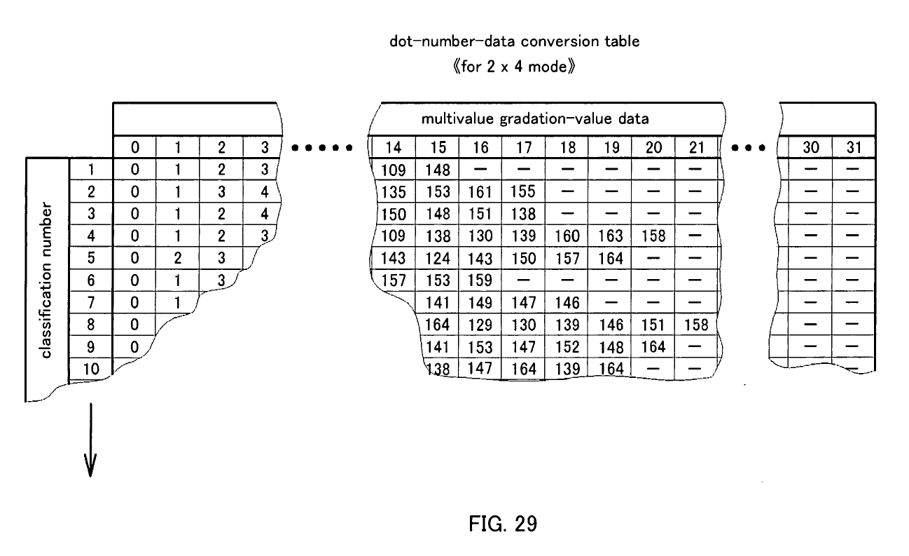

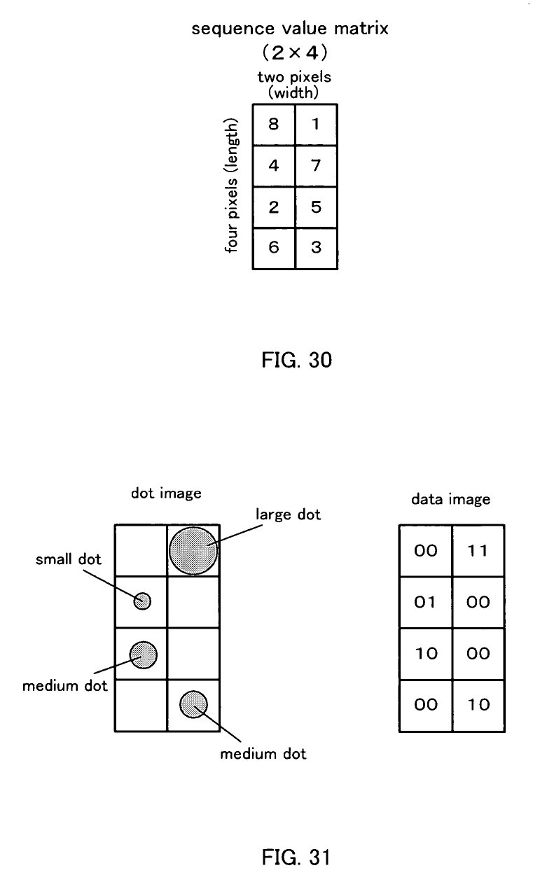

FIG. 30 shows an example of a sequence value matrix used here. As shown in FIG. 30, the sequence value matrix used for the “2×4 mode” is made of a matrix in which numbers (referred to below also as “sequence values”) indicating the order in which the dots are to be formed for a total of eight pixels—constituted by two pixels in the width direction and four pixels in the length direction—are set. The numbers set for each of the eight pixels indicate the order in which the dots are to be formed, as in the sequence value matrix described in FIG. 18. That is, the pixel to which the sequence value “1” is set is the pixel in which a dot is to be formed first, the pixel to which the sequence value “2” is set is the pixel in which a dot is to be formed second, and the pixel to which the sequence value “3” is set is the pixel in which a dot is to be formed third.

Also in the “2×4 mode”, such a sequence value matrix is set individually for each classification number, as with the sequence value matrices described in FIG. 18. That is, a different matrix is used as the sequence value matrix for each classification number.

The inkjet printer 1 stores, in advance, data on the sequence value matrix used for the “2×4 mode” in its main memory 127 etc. (see FIG. 5). When determining whether or not to form a dot for each of the eight pixels using the “2×4 mode”, the dot-formation-data generating section 184 acquires the data on the sequence value matrix for the “2×4 mode” from the main memory 127 etc.

The method of determining whether or not to form a dot for each of the eight pixels based on the sequence value matrix is the same as that described using FIG. 19. That is, the positions of the pixels in which dots are to be formed are determined in the order starting from the large-sized dots, which tend to stand out.

FIG. 31 schematically shows an example of a procedure for determining whether or not to form dots for each of the eight pixels based on the dot-number data and the sequence value matrix in the “2×4 mode”. Here, an example is described in which whether or not to form dots is determined using the sequence value matrix described in FIG. 30 based on dot-number data that indicates to form one large dot, two medium dots, and one small dot.

Here, the largest dot, that is, the large dot (“11”) is set to the pixel corresponding to the sequence value “1”. Since only one large dot needs to be formed, a medium dot (“10”) is set to the pixel corresponding to the sequence value “2”. Since two medium dots have to be formed, a medium dot (“10”) is also set to the pixel corresponding to the sequence value “3”. Next, a small dot (“01”) is set to the pixel corresponding to the sequence value “4”. Since only one small dot needs to be formed, no dots will be formed in the rest of the pixels, that is, the pixels corresponding to the sequence values “5” to “8”.

In this way, for the “2×4 mode”, the dot-formation-data generating section 184 determines whether or not to form dots for each of a total of eight pixels, constituted by two pixels in the width direction and four pixels in the length direction, based on the multivalue gradation-value data. The dot-formation-data generating section 184 then uses all eight pixels, for which whether or not to form dots has been determined, as the dot-formation data.

(2) 4×4 Mode

In the “4×4 mode”, the process of converting the multivalue gradation-value data into the dot-number data is different compared to that of the other modes described above. Also in the “4×4 mode”, a dot-number-data conversion table for the “4×4 mode”, which is different from the dot-number-data conversion tables described in FIG. 16 and FIG. 29, is used, as with the “2×4 mode”.

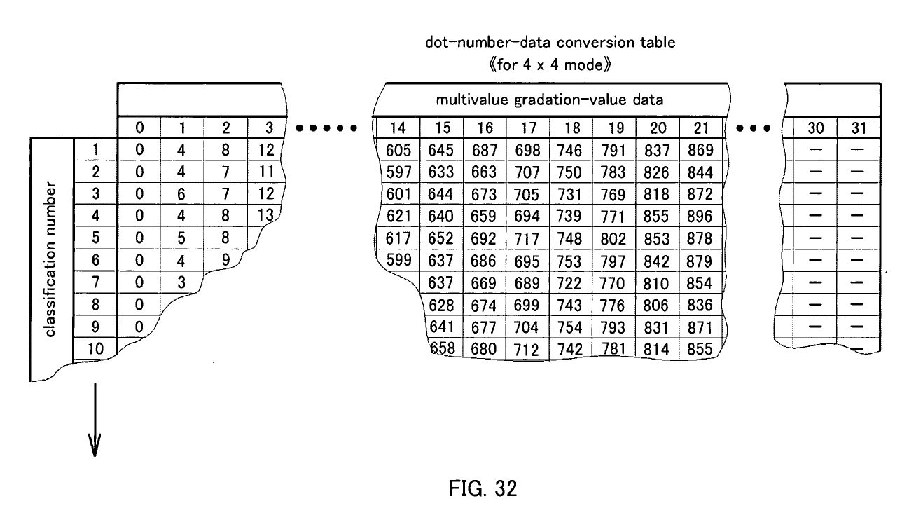

FIG. 32 schematically shows an example of a dot-number-data conversion table for the “4×4 mode”. Similar to the dot-number-data conversion tables shown in FIGS. 16 and 29, this dot-number-data conversion table is a table in which a piece of dot-number data is set corresponding to each classification number and each multivalue gradation-value data, and a corresponding piece of dot-number data can be found from the “classification number” and the “multivalue gradation-value data”. The “classification number” is expressed as a number ranging from “1” to “1024”, as in FIGS. 16 and 29. The “multivalue gradation-value data” is expressed as a value ranging from “0” to “31”, as in FIG. 16. A piece of dot-number data is provided separately for each classification number ranging from “1” to “1024” and for each multivalue gradation-value data ranging from “0” to “31”.

The “dot-number data”, however, is set to take on a value ranging from “0”, to “968”, which is different from the examples shown in FIGS. 16 and 29. The reason why the “dot-number data” is set to take on a value ranging from “0” to “968”, is as follows. As described above, the dot-number data is data that is coded to express the number of dots to be formed and also the size of the dot to be formed (i.e., “small dot”, “medium dot”, and “large dot”). In the “4×4 mode”, the determination on whether or not to form dots is not made for eight pixels as described above, but the determination on whether or not to form dots is made based on the dot-number data for 16 pixels (four pixels in the width direction×four pixels in the length direction). The number of dots that can be formed in 16 pixels is “16” at most. Each pixel can take four states: “large dot”, “medium dot”, “small dot”, and “no dot”. Thus, the dot-number combinations may take ₄H₁₆ (=₄₊₁₆₋₁C₁₆)=969 patterns. Therefore, it is possible to express all combinations by expressing the dot-number data using the values “0” to “968”.

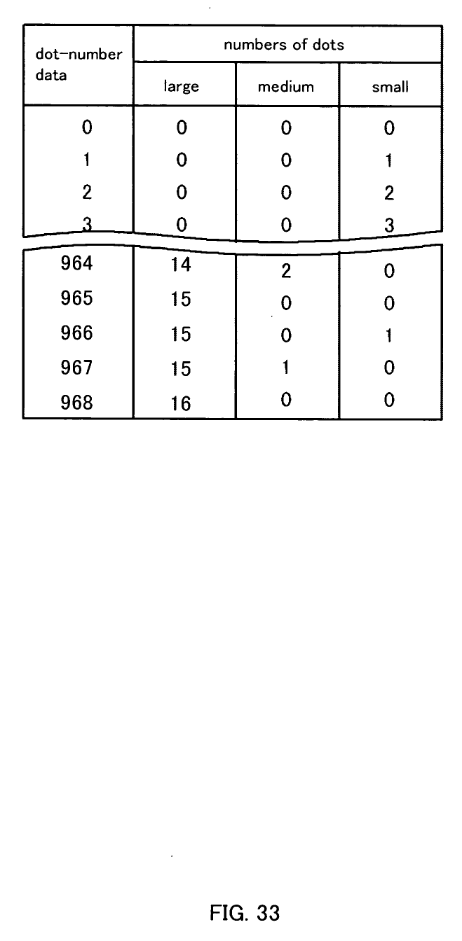

FIG. 33 shows an example of a correspondence between the dot-number data and information on the number and the size of the dots to be formed that is expressed by the dot-number data. As described above, the dot-number data is set to take on a value ranging from “0” to “968”. Each value, ranging from “0” to “968”, of the dot-number data expresses whether or not to form dots and the size of the dots.

The inkjet printer 1 stores, in advance, data on the dot-number-data conversion table used for the “4×4 mode” in its main memory 127 etc. (see FIG. 5). When converting the multivalue gradation-value data into the dot-number data using the “4×4 mode”, the dot-formation-data generating section 184 acquires the data on the dot-number-data conversion table for the “4×4 mode” from the main memory 127 etc.

In the “4×4 mode”, the dot-formation-data generating section 184 references this dot-number-data conversion table to convert the multivalue gradation-value data into the dot-number data. Then, based on the dot-number data obtained through this conversion, the dot-formation-data generating section 184 determines whether or not to form a dot individually for each of a total of 16 pixels, constituted by four pixels in the width direction and four pixels in the length direction. Here, the dot-formation-data generating section 184 determines whether or not to form a dot individually for the 16 pixels based on a sequence value matrix provided for the “4×4 mode”.

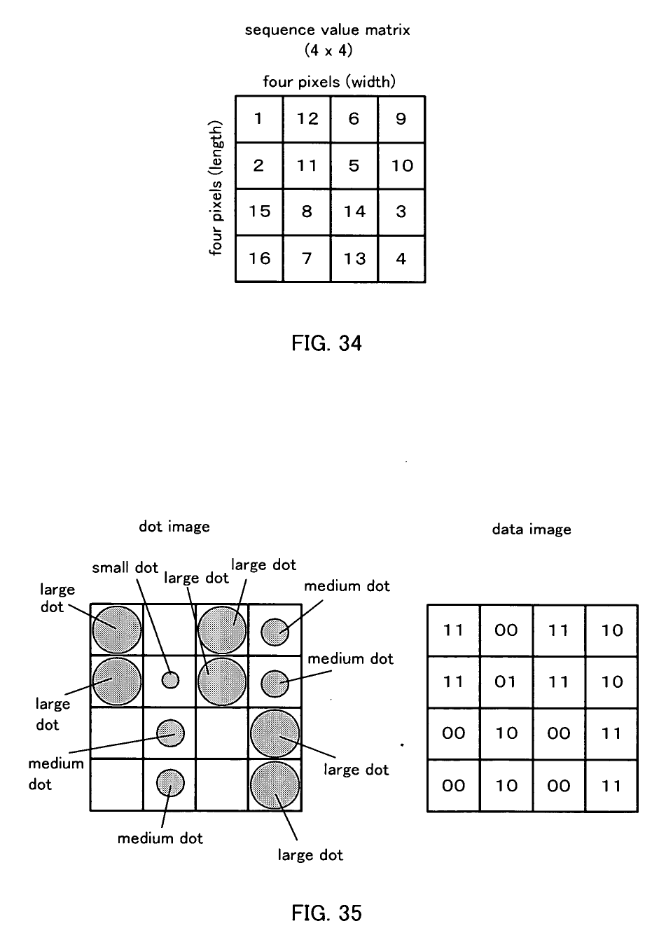

FIG. 34 shows an example of a sequence value matrix used here. As shown in FIG. 34, the sequence value matrix used for the “4×4 mode” is made of a matrix in which numbers (referred to below also as “sequence values”) indicating the order in which the dots are to be formed are set for a total of 16 pixels, constituted by four pixels in the width direction and four pixels in the length direction. The numbers set for each of the 16 pixels indicate the order in which the dots are to be formed, as in the sequence value matrices described in FIGS. 18 and 30. That is, the pixel to which the sequence value “1” is set is the pixel in which a dot is to be formed first, the pixel to which the sequence value “2” is set is the pixel in which a dot is to be formed second, and the pixel to which the sequence value “3” is set is the pixel in which a dot is to be formed third.

Also in the “4×4 mode”, such a sequence value matrix is set individually for each classification number, as with the sequence value matrices described in FIGS. 18 and 30. That is, a different matrix is used as the sequence value matrix for each classification number.

The inkjet printer 1 stores, in advance, data on the sequence value matrix used for the “4×4 mode” in its main memory 127 etc. (see FIG. 5). When determining whether or not to form a dot for each of the 16 pixels using the “4×4 mode”, the dot-formation-data generating section 184 acquires the data on the sequence value matrix for the “4×4 mode” from the main memory 127 etc.

The method of determining whether or not to form a dot for each of the 16 pixels based on the sequence value matrix is the same as that described using FIG. 19. That is, the positions of the pixels in which dots are to be formed are determined in the order starting from the large-sized dots, which tend to stand out.

FIG. 35 schematically shows an example of a procedure for determining whether or not to form dots for each of the 16 pixels based on the dot-number data and the sequence value matrix in the “4×4 mode”. Here, an example is described in which whether or not to form dots is determined using the sequence value matrix described in FIG. 34 based on dot-number data that indicates to form six large dots, four medium dots, and one small dot.

Here, the largest dot, that is, the large dot (“11”) is set to the pixel corresponding to the sequence value “1”. Since six large dots need to be formed, the large dot (“11”) is set also to the pixels corresponding to the sequence values “2” to “6”. Then, a medium dot (“10”) is set to the pixel corresponding to the sequence value “7”. Since four medium dots have to be formed, a medium dot (“10”) is also set to the pixels corresponding to the sequence values “8” to “10”. Next, a small dot (“01”) is set to the pixel corresponding to the sequence value “11”. Since only one small dot needs to be formed, no dots will be formed in the rest of the pixels, that is, the pixels corresponding to the sequence values “12” to “16”.

In this way, for the “4×4 mode”, the dot-formation-data generating section 184 determines whether or not to form dots for each of a total of 16 pixels, constituted by four pixels in the width direction and four pixels in the length direction, based on the multivalue gradation-value data. The dot-formation-data generating section 184 then uses all 16 pixels, for which whether or not to form dots has been determined, as the dot-formation data.

<Printing Process>

As shown in FIG. 10, the inkjet printer 1 carries out the printing process based on the dot-formation data generated by the dot-formation-data generating section 184 as described above. The printing process is executed under control of the controller 126. In accordance with the generated dot-formation data, the controller 126 causes ink to be ejected from the nozzles #1 to #180 of the nozzle rows 211C, 211M, 211Y, and 211K of the head 21 while moving the carriage 41 relative to the medium S to form dots on the medium S with the ejected ink, thereby printing the image designated by the application program 160 on the medium S.

===Outline of Dithering===

The value-multiplexing processing and dot-formation-data generation processing described above are executed based on a method referred to as dithering. In value-multiplexing processing and dot-formation-data generation processing described above, the concept of determining the classification number and the way of setting the value-multiplexing table, the dot-number-data conversion table, and the sequence value matrix are all based on dithering. An outline on dithering is described briefly below.

Dithering is a typical method used for converting image data into data that indicates whether or not to form a dot for each pixel. In this method, threshold values are set in a matrix called a dither matrix. By comparing, pixel by pixel, the gradation value of each pixel in the image data and the threshold value set to the dither matrix, it is judged to form a dot in a pixel whose gradation value is larger than the threshold value and judged not to form a dot in a pixel whose gradation value is not larger than the threshold value. Such a judgment is performed for all pixels in the image data. In this way, it is possible to convert, pixel by pixel, the image data into data that indicates whether or not to form a dot.

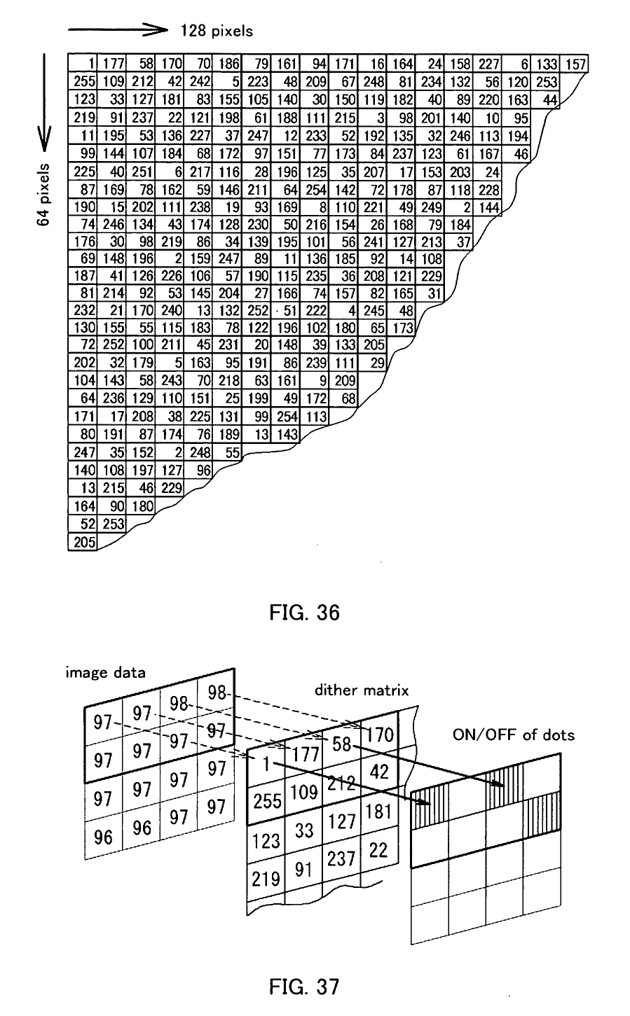

FIG. 36 is an explanatory diagram illustrating an enlarged portion of a dither matrix. In the dither matrix shown, threshold values selected evenly from a range of gradation values “1” to “255” are randomly stored in correspondence with a total of 8192 pixels, constituted by 128 pixels in the width direction and 64 pixels in the length direction. The gradation values of the threshold values are selected from a range of “1” to “255” in this example because each pixel in the image data is expressed as 1-byte data that can take on a value ranging from “0” to “255” and also because it is determined that a dot is to be formed in a pixel when the gradation value of that pixel in the image data is equal to the threshold value.

More specifically, if a dot were to be formed only in a pixel for which the gradation value of the image data is larger than the threshold value (that is, if no dot were to be formed in a pixel for which the gradation value is equal to the threshold value), then a dot will never be formed in a pixel having a threshold value that is equal to the maximum gradation value that the image data could take. To avoid such a situation, the range of the threshold value is set such that the maximum gradation value is excluded from the range of gradation values that the pixels can take. On the contrary, if a dot were to be formed in a pixel for which the gradation value of the image data and the threshold value are the same, then a dot will always be formed in a pixel having a threshold value that is equal to the minimum gradation value that the image data could take. To avoid such a situation, the range of the threshold value is set such that the minimum gradation value is excluded from the range of gradation values that the image data can take. In the present example, the gradation values that the image data can take are in the range of “0” to “255”, and a dot will be formed in a pixel if the image data and the threshold value are equal. Therefore, the range of the threshold values is set to “1” to “255”. It should be noted that the size of the dither matrix is not limited to that illustrated in FIG. 36, and matrices of various sizes may be employed, including matrices in which the numbers of pixels in the width and length directions are the same.

FIG. 37 is an explanatory diagram schematically showing how to determine whether or not to form a dot for each pixel with reference to the dither matrix. When determining whether or not to form a dot, first, a pixel targeted for determination is selected, and then, the gradation value in the image data for that pixel is compared with the threshold value stored in the corresponding position in the dither matrix. The thin broken-line arrows in FIG. 37 schematically show how the gradation values of the image data and the threshold values stored in the dither matrix are compared pixel by pixel. For example, as for the pixel in the upper left corner of the image data, the gradation value of the image data is “97”, and the threshold value of the dither matrix is “1”. Therefore, it is determined that a dot is to be formed in that pixel. The solid-line arrow shown in FIG. 37 schematically shows how it is determined that a dot is to be formed in that pixel and how the determination result is written into a memory. On the other hand, as for the pixel on the right of this pixel, the gradation value of the image data is “97”, and the threshold value of the dither matrix is “177”. Since the threshold value is larger, it is determined that no dot is to be formed in that pixel. In dithering, the image data is converted, pixel by pixel, into data that indicates whether or not to form a dot by referencing the dither matrix and judging, pixel by pixel, whether or not to form a dot.

===Concept of Setting Classification Numbers===

<Classification Number>

The classification numbers are set based on the above-described dither matrix shown in FIG. 36. More specifically, the dither matrix is made of a total of 8192 pixels—128 pixels in the width direction and 64 pixels in the length direction—, the 8192 pixels are divided up (grouped) into unit blocks, each unit block being made of four pixels in the width direction and two pixels in the length direction, and a serial number is assigned individually to each unit block obtained by dividing the pixels up. These serial numbers are the “classification numbers”.

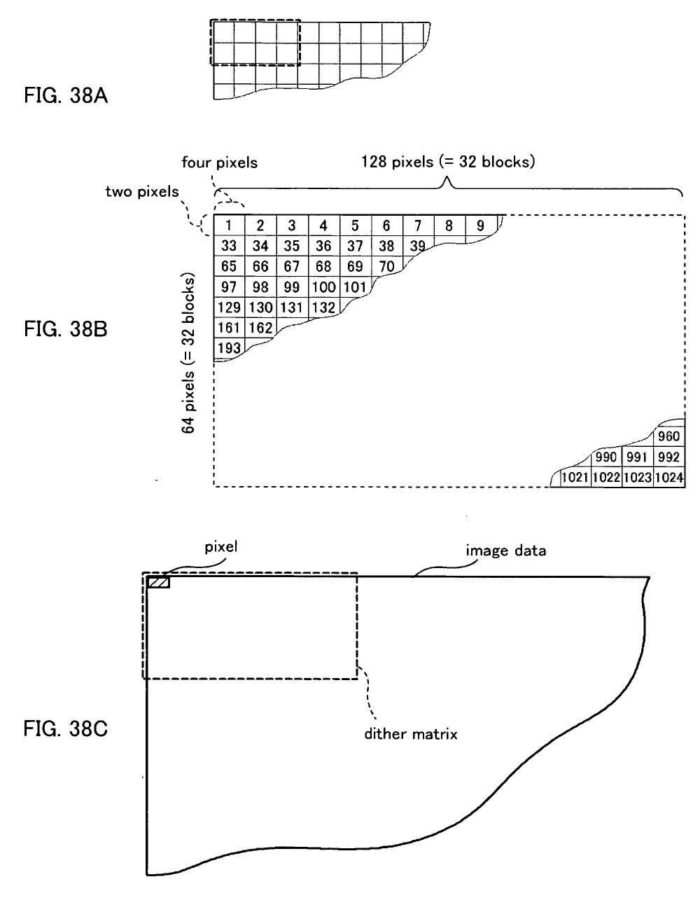

FIG. 38 is an explanatory diagram showing a concept for setting the classification numbers. FIG. 38A schematically shows how a total of eight pixels, constituted by four pixels in the width direction and two pixels in the length direction, are grouped as a single unit block in the upper left corner of the image. FIG. 38B describes how a “classification number” is set to each unit block by dividing up the pixels in the dither matrix.

By grouping four pixels in the width direction and two pixels in the length direction as a single unit block, a total of 1024 unit blocks, 32 blocks each in the width and length directions, are formed in the dither matrix. A serial number is individually set to each of the 1024 unit blocks. In this way, the classification numbers “1” to “1024” are respectively assigned to the unit blocks in the dither matrix.

FIG. 38C describes an example of how the dither matrix is applied to image data. When the dither matrix is applied to the image data in this way, the classification number “1” will at least be set to the pixel in the upper left corner of the image data. It should be noted that the method of setting the classification numbers to the pixels in the image data differs depending on the resolution (output resolution) used when printing the image on the medium S, as described using FIGS. 14A to 14E. That is, the method of setting the classification numbers to the pixels differs depending on the various modes, which are the “1×1 mode”, the “2×1 mode”, the “1×2 mode”, the “2×2 mode”, the “4×2 mode”, the “2×4 model, and the “4×4 mode”.

<Reason Why the Method of Setting Classification Numbers is Different>

Herein, description is given on the reason why the method of setting the classification numbers to the pixels in the CMYK image data differs depending on the resolution (output resolution) used when printing the image on the medium S. The classification numbers are respectively assigned to the unit blocks, each being made of a total of eight pixels constituted by four pixels in the width direction and two pixels in the length direction in the dither matrix. Therefore, a single unit block corresponding to a single classification number will be applied to eight pixels. Since the number of pixels in the dot-formation data generated from a single pixel in the CMYK image data differs depending on the resolution (output resolution) used when printing the image on the medium S, it is necessary to set the classification numbers according to methods different for each output resolution.

In the “1×1 mode”, data for only a single pixel is generated as the dot-formation data from a single pixel in the CMYK image data. Therefore, as regards the classification numbers for the 11×1 mode”, the same classification number is set to a unit of eight pixels, constituted by four pixels in the width direction and two pixels in the length direction, as shown in FIG. 14A.

On the other hand, in the “2×1 mode”, data for two pixels aligned in the width direction is generated as the dot-formation data from a single pixel in the CMYK image data. Therefore, as regards the classification numbers for the “2×1 mode”, the same classification number is set to a unit of four pixels, constituted by two pixels in the width direction and two pixels in the length direction, as shown in FIG. 14B.

Further, in the “1×2 mode”, data for two pixels aligned in the length direction is generated as the dot-formation data from a single pixel in the CMYK image data. Therefore, as regards the classification numbers for the “1×2 mode”, the same classification number is set to a unit of four pixels, constituted by four pixels in the width direction and one pixel in the length direction, as shown in FIG. 14C.

Further, in the “2×2 mode”, data for four pixels—two aligned in the width direction and two aligned in the length direction—is generated as the dot-formation data from a single pixel in the CMYK image data. Therefore, as regards the classification numbers for the “2×2 mode”, the same classification number is set to a unit of two pixels aligned in the width direction, as shown in FIG. 14D.

Further, in the “4×2 mode”, data for eight pixels—four aligned in the width direction and two aligned in the length direction—is generated as the dot-formation data from a single pixel in the CMYK image data. Therefore, as regards the classification numbers for the “4×2 mode”, a different classification number is set to each of the pixels, as shown in FIG. 14E.

<Method of Specifying Classification Numbers>

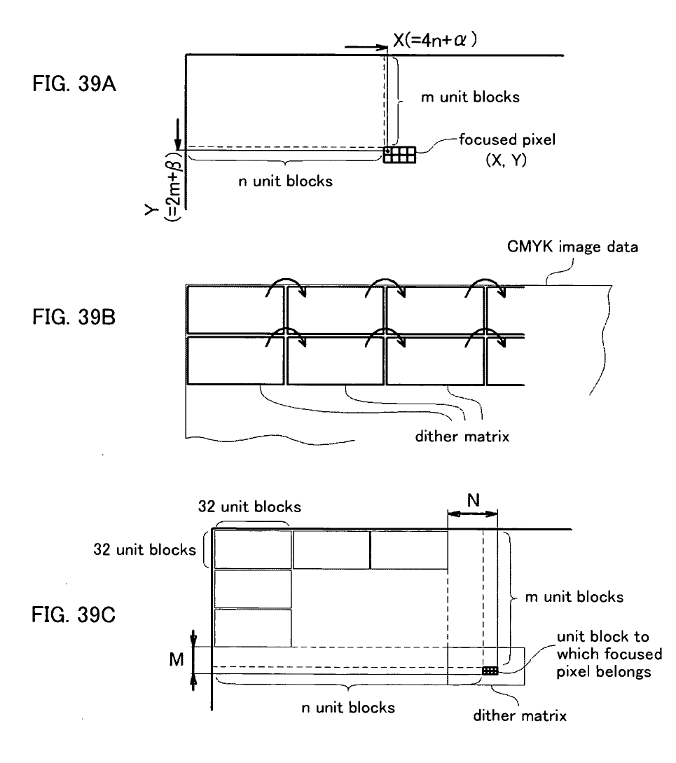

FIG. 39 describes an example of a method of specifying the classification numbers. Herein, a method of specifying the classification numbers for the “1×1 mode” is described. FIG. 39A shows a position of a focused pixel in the CMYK image data on which attention is focused. The position of the focused pixel is indicated with a black circle “•”. It is assumed that the coordinate of the focused pixel is (X, Y). Since a total of eight pixels, four in the width direction and two in the length direction, are grouped as a single unit block, the following expressions (1) and (2) hold true for X and Y:
X=4n+α (1)
Y=2m+β (2)

Herein, n and m are integers of 0 or greater, α is an integer of 0 to 3, and β is either 1 or 0. Further, n represents the number of unit blocks aligned on the left of the focused pixel, and m represents the number of unit blocks aligned above the focused pixel.

As shown, for example, in FIG. 39B, the dither matrix is repeatedly applied to the pixels in the CMYK image data by being gradually shifted on the CMYK image data in the width direction. As shown in FIG. 39C, it is assumed here that the unit block in the M-th row, N-th column in the dither matrix is applied to the focused pixel. Since 32 unit blocks are set both in the width and length directions in a single dither matrix, “M” and “N” can be found easily by the following expressions (3) and (4):
N=n−int(n/32)×32+1 (3)
M=m−int(m/32)×32+1 (4)

Herein, “int” is an operator expressing an operation of rounding off the numbers after the decimal point and making the number into an integer. More specifically, int(n/32) indicates an integral value obtained by rounding off the numbers after the decimal point of the calculation result of n/32. By finding the coordinate (X, Y) of the focused pixel, it is possible to specify, from X and Y, the unit block to which the focused pixel belongs. Accordingly, it is possible to find the classification number that is to be set to the focused pixel.

It should be noted that although the “1×1 mode” is described here as an example, it is possible to specify the position of the unit block in the dither matrix corresponding to the focused pixel from the coordinate (X, Y) of the focused pixel using the above-described expressions, even for the other modes. In this way, it is possible to find the classification number to be set to the focused pixel.

===Method of Setting Value-Multiplexing Table===

A method of setting the value-multiplexing table shown in FIG. 12 is described next. As described above, in the value-multiplexing table, a piece of multivalue gradation-value data is set corresponding to each classification number, which is provided for each pixel, and each gradation value, which is set for each pixel. By performing value-multiplexing processing with reference to the value-multiplexing table, it is possible to perform the value-multiplexing processing on the gradation value of each pixel in a manner unique to each of the classification numbers as shown in FIG. 13.

The value-multiplexing table of the present embodiment is set based on a method developed from the above-described dithering, so that it is possible to determine whether or not to form a dot for each pixel and for a plurality of types of dots having different sizes. Before describing the method of setting the value-multiplexing table, the basic technology necessary for understanding the present setting method is briefly described.

<Density Data>

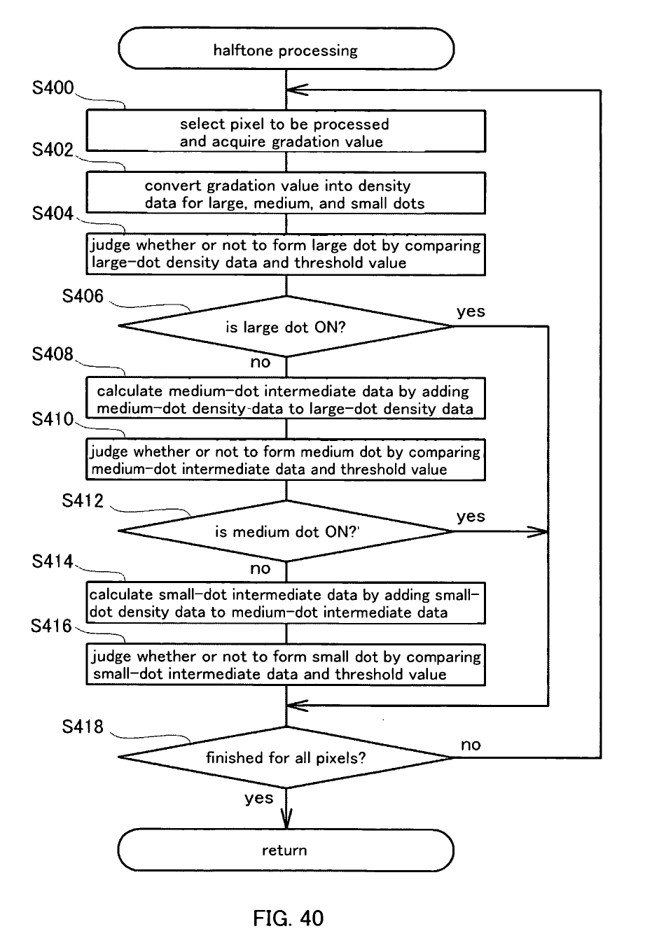

FIG. 40 is a flowchart showing a halftone processing flow that makes it possible to determine whether or not to form a large dot, a medium dot, or a small dot for each pixel by developing the dithering method. When the halftone processing is started, first, a pixel for which whether or not to form a dot is to be determined is selected and the gradation value of that pixel is acquired (S400). Next, the acquired image data is converted into density data regarding the large, medium, and small dots. The “density data” is data indicating the density at which the dots are to be formed. The larger the gradation value of the density data, the higher the density at which the dots are formed becomes. For example, the density data having a gradation value “255” indicates that the dot-formation density is 100%, that is, dots are formed in all of the pixels. On the other hand, the density data having a gradation value “0” indicates that the dot-formation density is 0%, that is, no dot is formed in any of the pixels. Conversion into the density data can be performed by referencing a table called a “dot density conversion table”.

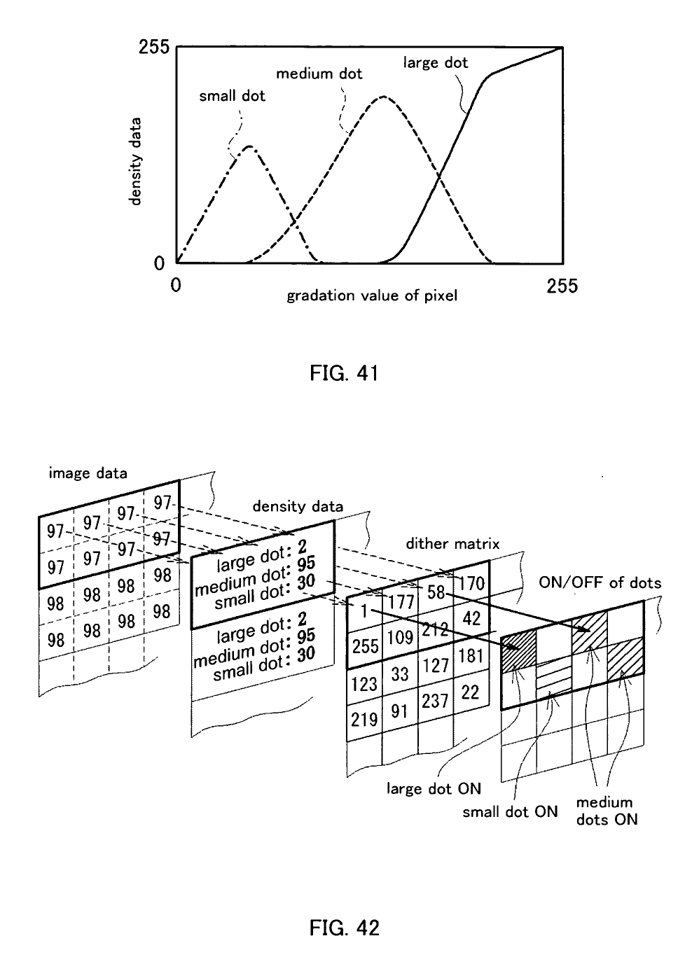

FIG. 41 is an explanatory diagram schematically showing a dot density conversion table that is referred to when converting the gradation value of each pixel into the density data regarding the large, medium, and small dots. As shown in FIG. 41, in the dot density conversion table, density data regarding small dots, medium dots, and large dots are set for the gradation values of the pixels. In a region near the gradation value “0”, the gradation values of the density data for the medium and large dots are set to “0”. The value of the small-dot density data increases with the increase in the gradation value, but when the gradation value reaches a certain value, it starts to decrease, and instead, the value of the medium-dot density data starts to increase. As the gradation value further increases and reaches a certain value, the gradation value of the small-dot density data becomes “0” and the value of the medium-dot density data starts to decrease, and instead the value of the large-dot density data starts to increase gradually. In step S402 of FIG. 40, a process of converting the gradation value of a pixel into large-dot density data, medium-dot density data, and small-dot density data, is performed with reference to this dot density conversion table.

<Judging Whether or Not to Form a Large Dot>

When the density data for the large, medium, and small dots have been acquired for the pixel to be processed, first, judgment on whether or not to form a large dot is made (step S404 of FIG. 40). This judgment is performed by comparing the large-dot density data and the threshold value of the dither matrix set in the position corresponding to the pixel to be processed. If the large-dot density data is larger than the threshold value, then it is judged that a large dot is to be formed in the pixel to be processed, whereas if the density data is smaller, it is judged that a large dot is not to be formed therein.

Next, a determination is made on whether or not it has been judged to form a large dot in the pixel to be processed (step S406). If it has been judged to form a large dot (yes in step S406), then judgment on the medium and small dots is omitted, and it is determined whether or not all pixels have been processed (step S418). If there still are pixels for which the judgment on whether or not to form a dot has not been made (no in step S418), then the procedure returns to step S400, a new pixel is selected, and the series of processes that follow are performed.

<Judging Whether or Not to Form a Medium Dot or a Small Dot>

On the other hand, if it has not been judged to form a large dot in the pixel to be processed (no in step S406), then, in order to judge whether or not to form a medium dot, intermediate data for medium dots is calculated by adding the medium-dot density data to the large-dot density data (step S408). Then, the intermediate data for medium dots obtained in this way is compared with the threshold value of the dither matrix. If the intermediate data for medium dots is larger than the threshold value, then it is judged that a medium dot is to be formed, whereas if the threshold value in the dither matrix is larger than the intermediate data, then it is judged that a medium dot is not to be formed (step S410).

Then, a determination is made on whether or not it has been judged to form a medium dot in the pixel to be processed (step S412). If it has been judged to form a medium dot (yes in step S412), then judgment on the small dot is omitted, and it is determined whether or not all pixels have been processed (step S418).

On the other hand, if it has not been judged to form a medium dot in the pixel to be processed (no in step S412), then, in order to judge whether or not to form a small dot, intermediate data for small dots is calculated by adding the small-dot density data to the intermediate data for medium dots (step S414). Then, the intermediate data for small dots obtained in this way is compared with the threshold value of the dither matrix. If the intermediate data for small dots is larger than the threshold value, then it is judged that a small dot is to be formed, whereas if the threshold value in the dither matrix is larger than the intermediate data, then it is judged that no dot is to be formed (step S416).

That is, as regards a pixel for which the threshold value set in the dither matrix is larger than the large-dot density data (that is, a pixel in which a large dot is not formed), the medium-dot density data is added to the large-dot density data and the obtained intermediate data is compared with the threshold value, and if the intermediate data is larger than the threshold value, then it is judged that a medium dot is to be formed. On the other hand, as for a pixel for which the threshold value is still larger than the intermediate data, the small-dot density data is added to the intermediate data to obtain a new intermediate data. Then, this intermediate data and the threshold value are compared, and if the new intermediate data is larger, then it is judged that a small dot is to be formed; on the other hand, as for a pixel for which the threshold value is still larger than the new intermediate data, it is judged that no dot is to be formed therein.

Through the processing described above, it is possible to judge whether to form either a large dot, a medium dot, or a small dot, or whether to form no dot, for the pixel to be processed. Then, it is determined whether or not all pixels have been processed (step S418). If there still are pixels for which the judgment has not been made (no in step S418), then the procedure returns to step S400, a new pixel is selected, and the series of processes that follow are performed. In this way, a judgment is made on whether or not to form either a large dot, a medium dot, or a small dot, one by one for the pixel that has been selected as the target for processing. If it is determined that processing has finished for all the pixels (yes in step S418), then the halftone processing of FIG. 40 is ended.

A method for judging whether or not to form a large dot, a medium dot, or a small dot using a dither matrix has been described above. Based on the above description, a method of setting the value-multiplexing table shown in FIG. 12 will be described below.

<Conceptual Diagram>

As described above, in the multivalue-gradation-value-data generation processing and the dot-formation-data generation processing, whether or not to form a dot for eight pixels is determined from the gradation value of a single pixel in the CMYK image data. Herein, this is considered that the gradation value of a single pixel in the CMYK image data represents gradation values of eight pixels, and the above-described halftone processing is applied to this case.

FIG. 42 describes an overview for when executing the halftone processing considering that the gradation value of a single pixel in the CMYK image data represents gradation values of eight pixels. In FIG. 42, the eight pixels that are targeted for halftone processing are shown surrounded by a thick solid line. The gradation values of the eight pixels are all the same, and in this example, they take on the gradation value “97”. In order to judge whether or not to form a large dot, a medium dot, or a small dot, the gradation value of each pixel is converted into density data for the respective dots. Conversion into the density data is performed by referencing the dot density conversion table shown in FIG. 41. Here, since all the pixels in the eight pixels are considered to have the same gradation value, the density data regarding the various dots also take on the same value for all the pixels. In the example shown, the gradation value of the large-dot density data is “2”, the gradation value of the medium-dot density data is “95”, and the gradation value of the small-dot density data is “30”.

Next, as described using FIG. 40, judgment on whether or not to form the various dots is performed, pixel by pixel, by comparing the large-dot density data, the intermediate data for medium dots, or the intermediate data for small dots with the threshold values set in the dither matrix. Here, as the threshold values of the dither matrix for comparison, threshold values in the dither matrix that are set in the positions corresponding to the eight focused pixels are used. For example, in the example of FIG. 42, since the eight pixels are in the upper left corner of the image, the threshold values that are set to the eight pixels (one unit block) in the upper left corner of the dither matrix are used.

Among the eight threshold values set for the eight pixels, it is judged that a large dot is formed in a pixel in which the threshold value is smaller than the large-dot density data. In this example, since the gradation value of the large-dot density data is “2”, a large dot is formed only in the pixel to which the threshold value “1” has been set. In FIG. 42, the pixel judged such that a large dot is to be formed therein is shown with a fine hatching. Further, it is judged that a medium dot is formed in a pixel in which the threshold value is larger than the large-dot density data “2” but smaller than the medium-dot intermediate data “97” obtained by adding the large-dot density data and the medium-dot density data. There are only two such pixels: the pixel to which the threshold value “42” has been set and the pixel to which the threshold value “58” has been set. In FIG. 42, the pixels judged such that a medium dot is to be formed therein are shown with a slightly coarse hatching. Finally, it is judged that a small dot is formed in a pixel in which the threshold value is larger than the medium-dot intermediate data “97” but smaller than the small-dot intermediate data “127” obtained by adding the medium-dot intermediate data and the small-dot density data. There is only one such pixel: the pixel to which the threshold value “109” has been set. In FIG. 42, the pixel judged such that a small dot is to be formed therein is shown with a coarse hatching. As a result of judging whether or not to form a large dot, a medium dot, or a small dot in this way, it is determined that one large dot, two medium dots, and one small dot are formed when the gradation value of the focused pixels is “97”.

If the gradation value of the pixel is significantly different, then the number of large dots, medium dots, and small dots formed in the eight pixels will differ. Further, if the gradation value of the pixel is changed from “0” to “255”, then, in accordance therewith, the number of large dots, medium dots, and small dots should change in several steps. Further, if the classification number set to the pixel is different, the way in which the number of dots changes should also be different because the threshold values in the dither matrix are different. The value-multiplexing table shown in FIG. 12 is set by finding out, for each classification number, the behavior according to which the numbers of the various dots change stepwise when the gradation value of the pixel is changed from “0” to “255”.

<Method of Generating Value-Multiplexing Table>

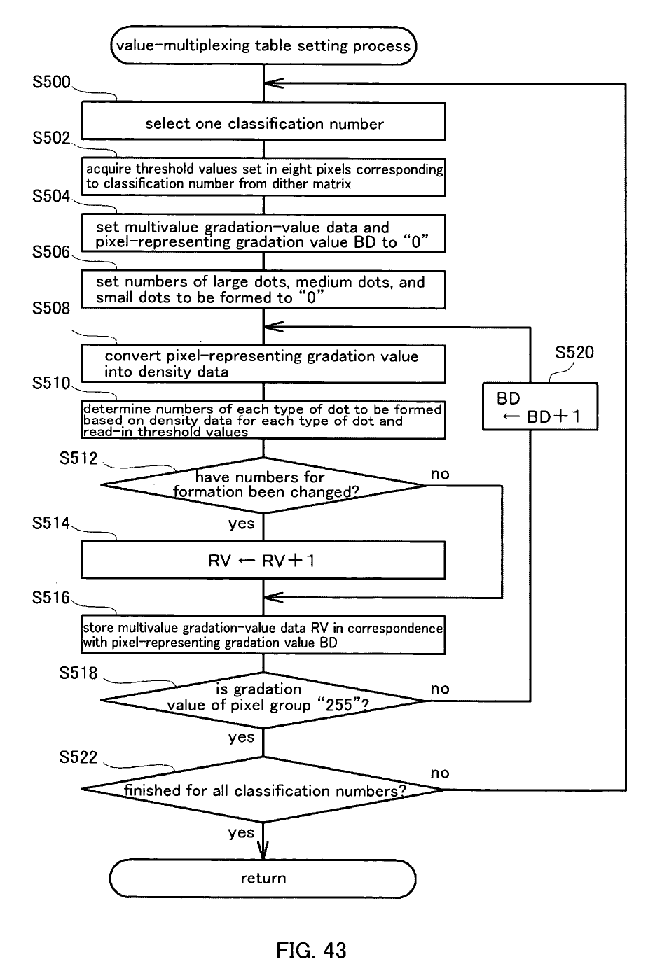

FIG. 43 is a flowchart showing the flow of a process for actually setting a value-multiplexing table. Below, description is given in accordance with the flowchart. When the value-multiplexing table setting process is started, first, a classification number is selected (step S500). For example, it is assumed that the classification number “1” has been selected.

Next, the threshold values corresponding to the selected classification number are read out from the dither matrix (step S502). In this example, since it is assumed that the classification number “1” has been selected, the eight threshold values set to the position of the block indicated by “1” in FIG. 38B are read out from the dither matrix illustrated in FIG. 36.

Then, the multivalue gradation-value data RV and the gradation values BD of the pixels are set to “0” (step S504), and also, the numbers of large dots, medium dots, and small dots to be formed are set to “0” (step S506).

Then, after converting the gradation values of the pixels into density data regarding the large dots, medium dots, and small dots by referencing the dot density conversion table shown in FIG. 41 (step S508), the numbers of large dots, medium dots, and small dots to be formed are determined based on the density data and the threshold values that have been read in (step S510). More specifically, as described using FIG. 40 and FIG. 42, the number of threshold values that are smaller than the large-dot density data is obtained, and the obtained number is set as the number of large dots to be formed. Then, the number of threshold values that are larger than the large-dot density data but smaller than the medium-dot intermediate data is obtained, and this is set as the number of medium dots to be formed. Further, the number of threshold values that are larger than the medium-dot intermediate data but smaller than the small-dot intermediate data is obtained, and this is set as the number of small dots to be formed.

Then, it is judged whether or not the numbers of various dots to be formed obtained in this way have been changed from the previously-set numbers (step S512). If it is judged that the numbers of dots to be formed have been changed (yes in step S512), then the multivalue gradation-value data RV is increased by “1” (step S514), and the obtained multivalue gradation-value data RV is stored in correspondence with the gradation value BD of the pixels (step S516). On the other hand, if it is judged that the numbers of dots to be formed have not been changed (no in step S512), then those values are stored, as they are, in correspondence with the gradation value BD of the pixels, without increasing the multivalue gradation-value data RV (step S516).

After storing the multivalue gradation-value data for a certain gradation value of the pixels, it is judged whether or not the gradation value BD of the pixels has reached the gradation value “255” (step S518). If it has not reached the gradation value “255” (no in step S518), then the gradation value BD of the pixels is increased by “1” (step S520), the procedure is returned to step S508, the gradation value BD of the pixels is again converted into the density data, and the series of processes that follow are performed to store the multivalue gradation-value data RV in correspondence with the new gradation value BD of the pixels (step S516). This operation is repeated until the gradation value BD of the pixels reaches the gradation value “255”. When the gradation value BD of the pixels has reached the gradation value “255” (yes in step S518), then it is assumed that the multivalue gradation-value data has been set for the selected classification number.

Then, it is determined whether or not the above-described processing has been performed for all classification numbers (step S522). If there still are unprocessed classification numbers (no in step S522), then the procedure is returned to step S500 and the above-described processing is performed again. The processing is repeated, and when it is determined that the multivalue gradation-value data has been set for all the classification numbers (yes in step S522), the value-multiplexing-table setting process shown in FIG. 43 is ended.

As apparent from the above description, the multivalue gradation-value data is determined according to the density data of the large, medium, and small dots obtained by converting the gradation values of the pixels, and the threshold values stored in the dither matrix in the positions corresponding to the classification numbers. Herein, since the same dot density conversion table shown in FIG. 41 is referenced even when the classification numbers are different, the density data of the dots corresponding to the gradation value of a pixel will be the same irrespective of the classification number. However, the combination of the threshold values that are read out from the dither matrix differs for each classification number. This is because the dither matrix is designed such that the threshold values are set in a dispersed and random manner, to the extent possible, so that dots are not formed according to a constant pattern in the image and that the dots are not gathered in a position close to one another, which deteriorate image quality. Therefore, when focusing on the plurality of threshold values that correspond to a certain classification number as a combination, the possibility is extremely low that the combinations of the threshold values are exactly the same. Accordingly, the correspondence between the gradation values of the pixels and the multivalue gradation-value data in the value-multiplexing table, which is referenced in the multivalue-gradation-value-data generation processing of the present embodiment, becomes different for each classification number, and the number of times of changes in the multivalue gradation-value data (the value-multiplexing level number shown in FIG. 13) differs depending on the classification number.

===Method of Setting Dot-Number-Data Conversion Table===

A method of setting the dot-number-data conversion table shown in FIG. 16 is described next. The dot-number-data conversion table is a table that is referenced to convert multivalue gradation-value data, in combination with a classification number, into dot-number data that indicates the number of dots to be formed in the eight pixels corresponding to that classification number, in the dot-formation determination processing shown in FIG. 11.

As apparent from the method of setting the value-multiplexing table shown in FIG. 43, the multivalue gradation-value data set in the value-multiplexing table is determined based on the numbers of large, medium, and small dots to be formed in the eight pixels corresponding to a classification number. However, the multivalue gradation-value data does not immediately correspond to the combination of dot numbers formed in the eight pixels corresponding to the classification number, but it is only possible to correlate the multivalue gradation-value data to a specific combination of dot numbers by using the multivalue gradation-value data and the classification number in combination. This is because the multivalue gradation-value data is designed to include information on only whether or not the numbers of the large, medium, and small dots to be formed changed while the gradation value of a pixel is increased from the gradation value “0” to the gradation value “255”, and does not include information indicating how the combination of the numbers of dots actually changed.

However, if the classification number is known, then it is possible to find out what number the change corresponds to in the eight pixels corresponding to the classification number, that is, it is possible to specify, from the multivalue gradation-value data, the actual combination of the numbers of the various dots. Accordingly, the actual numbers of the various dots used as the basis for setting the multivalue gradation-value data are found for every classification number, and code data corresponding to the combination of the dot numbers obtained is stored in association with the multivalue gradation-value data. The dot-number-data conversion table shown in FIG. 16 is designed by performing this operation for all the classification numbers.

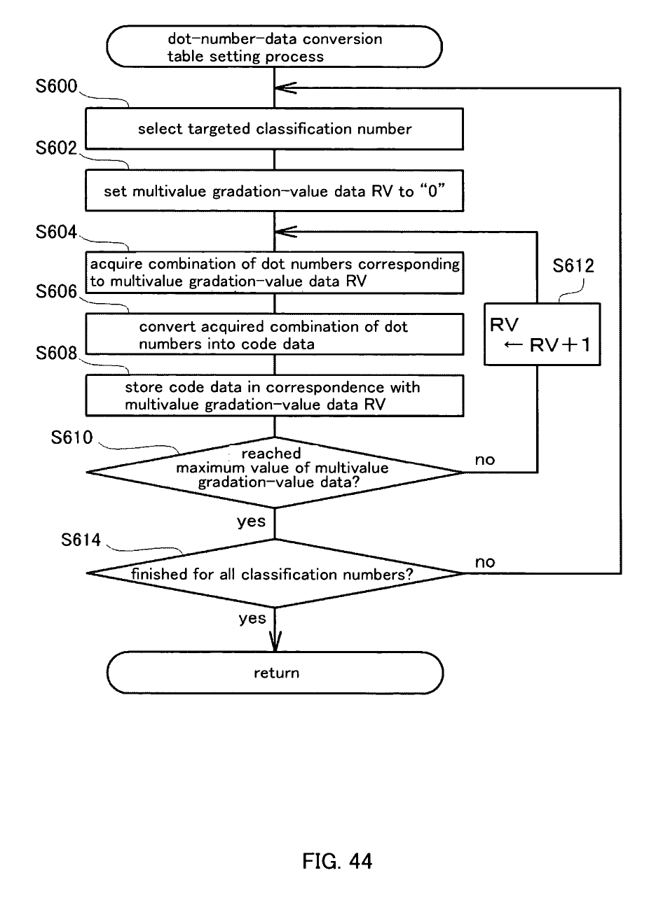

FIG. 44 is a flowchart showing a specific process flow for setting a dot-number-data conversion table. The description below is given in accordance with this flowchart. When the dot-number-data conversion table setting process is started, first, a classification number targeted for setting is selected (step S600), and the multivalue gradation-value data RV is set to “0” (step S602).

Next, the numbers of large, medium, and small dots corresponding to the multivalue gradation-value data RV are acquired (step S604). For example, assuming that the multivalue gradation-value data is “N”, whether or not to form large, medium, and small dots is judged for that classification number while changing the gradation value of the pixel from “0” to “255”, and the numbers of the large dots, medium dots, and small dots are acquired for when the numbers of dots to be formed change for the N-th time.

The combinations of dot numbers obtained in this way are converted into code data (step S606). Conversion of the dot-number combination into the code data is performed by referencing a correspondence table shown in FIG. 17. Then, the acquired code data is stored in correspondence with the multivalue gradation-value data (step S608), and then, it is determined whether or not the value-multiplexing result has reached a maximum value (i.e., whether or not the multivalue gradation-value data has reached its maximum value) for the targeted classification number (step S610). That is, as described in FIG. 13, since the maximum value of the multivalue gradation-value data is different depending on the classification number, it is determined whether or not the multivalue gradation-value data has reached its maximum value for the targeted classification number.

If the maximum value of the multivalue gradation-value data has not been reached (no in step S610), then the value of the multivalue gradation-value data RV is increased by “1” (step S612). Then, the procedure is returned to step S604, the numbers of dots corresponding to the new multivalue gradation-value data RV are obtained, and the series of processes that follow are repeated. When it is determined that the maximum value of the multivalue gradation-value data for the targeted classification number has been reached after repeating the above-described operation (yes in step S610), it is assumed that data for that classification number has been set to the dot-number-data conversion table.

Then, it is determined whether or not the same processing has been performed for all the classification numbers (step S614). If there still are classification numbers that have not been processed, the procedure is returned to step S600, a new classification number is selected, and the series of processes described above are performed for that classification number. When it is determined that the processing has finished for all the classification numbers (yes in step S614), all pieces of data will be set to the dot-number-data conversion table, so the processing shown in FIG. 44 is ended.

===Method of Setting Sequence Value Matrix===

A method of setting the sequence value matrix described in FIG. 18 is described next. As described above, the sequence value matrix is a matrix in which the order for forming dots is set for the pixels within the eight pixels corresponding to a classification number. In the dot-formation-data generation processing, the sequence value matrix corresponding to the classification number is read in, and the pixels in which to form the large dots, medium dots, and small dots are determined in accordance with the order set in the matrix.

As with the value-multiplexing table described above, the sequence value matrix is set based on the above-described method. More specifically, in the case of setting the value-multiplexing table, assuming that the pixels within the eight pixels all have the same gradation value, the gradation values of the pixels are changed from “0” to “255” while determining the numbers of large, medium, and small dots to be formed in the eight pixels, and the multivalue gradation-value data is set by focusing on the change in the numbers of dots to be formed. Further, as shown in FIG. 16, it is possible to retrieve the numbers of the large, medium, and small dots formed in the eight pixels by using the multivalue gradation-value data and the classification number in combination. However, information regarding which pixel, of the eight pixels, to form the various dots is not included, and this cannot be found from the multivalue gradation-value data nor the classification number. On the other hand, the sequence value matrix can be considered as data in which the information regarding which pixel, of the eight pixels, to form the various dots is stored. That is, application of the above-described method makes it possible to determine not only the numbers of the dots to be formed but also the positions of the pixels, within the eight pixels, in which the dots are to be formed as shown in FIG. 40 and FIG. 42. On the other hand, in the present embodiment, it can be considered that the above-described method is divided into two elements, and the information on the numbers of the various dots to be formed is reflected mainly on the multivalue gradation-value data (more specifically, to the combination of the multivalue gradation-value data and the classification number), and the information on the positions of the pixels in which to form the dots is reflected on the sequence value matrix. In practice, such a sequence value matrix can be designed relatively easily.

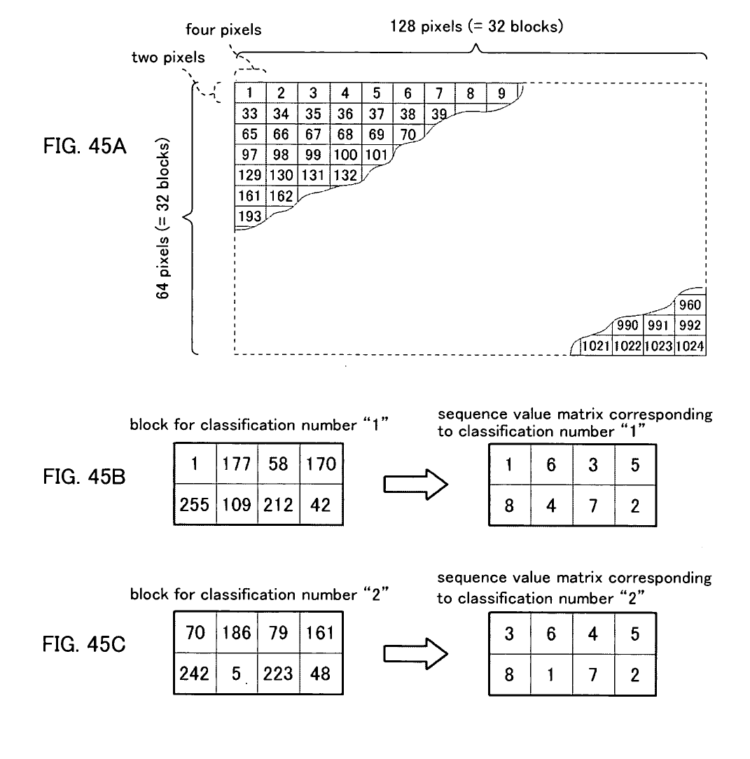

FIG. 45 is an explanatory diagram showing in detail a method of setting the sequence value matrix. The description below is given with reference to this figure. As shown in FIG. 45A, the dither matrix is divided into unit blocks, each unit block being made of four pixels in the width direction and two pixels in the length direction, and a classification number is assigned individually to each unit block obtained by dividing up the matrix. When setting the sequence value matrix, the threshold values corresponding to the eight pixels for each classification number are retrieved from the dither matrix.

FIG. 45B is an explanatory diagram that shows, as an example, how the sequence value matrix is generated from the block for the classification number “1”. The figure on the left in FIG. 45B shows the threshold values of the dither matrix included in the block for the classification number “1”. As described above with reference to FIG. 42, the dots are formed in the order from the pixel with a smaller threshold value. Therefore, in the block for the classification number “1” shown in FIG. 45B, the pixel in which a dot is formed first can be considered to be the pixel to which the threshold value “1” is set. Accordingly, the sequence value “1” is set to that pixel. Similarly, the pixel in which a dot is formed second can be considered to be the pixel to which the second-smallest threshold value “42” is set. Accordingly, the sequence value “2” is set to that pixel. In this way, by determining the sequence values “1” to “8” in order from the pixels with smaller threshold values set in the block for the classification number “1”, it is possible to obtain the sequence value matrix for the classification number “1” shown in the figure on the right in FIG. 45B.

FIG. 45C shows how a sequence value matrix for the classification number “2” is obtained by setting the sequence values “1” to “8”, in order from the pixels to which smaller threshold values are set within the block. By performing such an operation for all the blocks corresponding to the classification numbers “1” to “1024”, shown in FIG. 45A, it is possible to obtain sequence value matrices for the classification numbers “1” to “1024”.

===Why It is Possible to Appropriately Determine from the Multivalue Gradation-Value Data Whether or Not to Form Dots===

As described above, in the present embodiment, the multivalue gradation-value data is determined by referencing the value-multiplexing table described in FIG. 12. Then, the multivalue gradation-value data is converted into dot-number data while referencing the dot-number-data conversion table described in FIG. 16 and the sequence value matrix described in FIG. 18, and positions of the pixels in which to form the various types of dots, among the plurality of pixels, are determined based on the dot-number data. Even when the positions of the pixels in which to form the dots are determined in this way, it is possible to output a high-quality image in which the dots are appropriately dispersed. In addition, even though only relatively few pixels (eight in the present embodiment) are processed at one time, it is possible to achieve a superior dot distribution like that achieved using a large-scale dither matrix, typified by a so-called Blue Noise Mask or a Green Noise Mask, in which the number of pixels exceed 1000. Below, the principle behind this is described.

With the method described above, by converting the image data into large-dot density data, medium-dot intermediate data, and small-dot intermediate data as described in FIGS. 40 and 41 and comparing the data with the threshold values set in the dither matrix, it is possible to judge whether or not to form the large, medium, and small dots. Further, by employing a matrix in which consideration is given to dispersibility, typified by a so-called Blue Noise Mask or a Green Noise Mask, as the dither matrix to be referenced here, it is possible to obtain a high-quality image in which the dots are dispersed in a superior manner.

Further, in general, gradation values with close values (or the same value) tend to be assigned to neighboring pixels in image data. In recent years, there is a tendency to increase the image data resolution in response to demands for high image quality; the higher the image data resolution, the more conspicuous the tendency that a similar or the same gradation value is assigned to neighboring pixels becomes. Therefore, even when the judgment on whether or not to form the large, medium, and small dots is made by grouping up a plurality of pixels and assuming that the pixels within the plurality of pixels all have the same gradation value as described above with reference to FIG. 42, it would be rare that a difference will occur in image quality.

In the multivalue-gradation-value-data generation processing described above, the multivalue gradation-value data dependent on the classification number is generated by performing the value-multiplexing processing on the gradation values of the pixels. When used in combination with the classification number of the pixels, the multivalue gradation-value data generated in this way indicates the numbers of the various types of dots formed in the eight pixels. As for the eight pixels shown in FIG. 42, multivalue gradation-value data that indicates, when used in combination with the classification number, that one large dot, two medium dots, and one small dot are to be formed, will be generated.

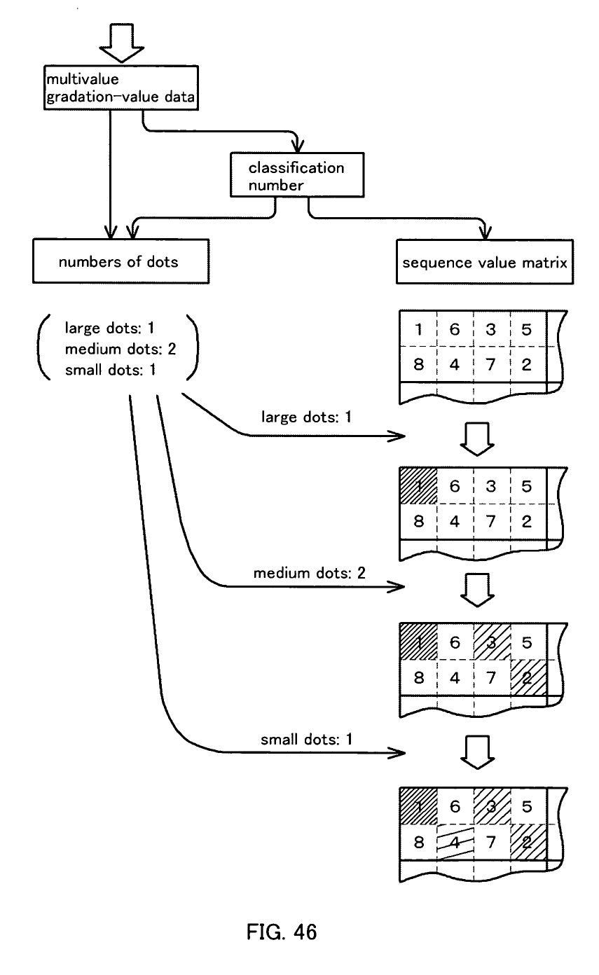

In the dot-formation-data generation processing described above, when such multivalue gradation-value data is received, whether or not to form large, medium, and small dots is determined for each of the pixels among the eight pixels. FIG. 46 is an explanatory diagram schematically showing a rough flow of a process for receiving the multivalue gradation-value data in the dot-formation-data generation processing described above and judging whether or not to form large, medium, and small dots for each of the pixels among the eight pixels. As shown in the figure, when the multivalue gradation-value data is received, the classification number of the pixel corresponding to that multivalue gradation-value data is obtained, and the numbers of large, medium, and small dots to be formed are acquired based on the multivalue gradation-value data and the classification number. Further, the matrix stored in correspondence with the classification number is read out from the sequence value matrix which is stored in advance.

Description is made regarding the eight pixels shown in FIG. 42. Since the eight pixels are located in the upper left corner of the image, the classification number “1” will be obtained. By using the multivalue gradation-value data and the obtained classification number in combination, it can be found that one large dot, two medium dots, and one small dot will be formed in the eight pixels. To determine the pixels, among the eight pixels, in which to form the dots, reference is made to the sequence value matrix for the classification number “1”. This sequence value matrix is generated from the section in the dither matrix in FIG. 42 used to judge whether or not to form the dots, that is, the section used to judge whether or not to form the dots for each of the pixels within the eight pixels.

The positions of the pixels, among the eight pixels, in which to form the dots are determined based on the numbers of large, medium, and small dots obtained in this way and the sequence value matrix. Since a specific method for determining the positions of the pixels has already been described in FIG. 19, description thereof is omitted here; the result of such a processing is that the large dot is formed in the pixel with the first sequence value, the medium dots are formed in the pixels with the second and third sequence values, and the small dot is formed in the pixel with the fourth sequence value. In FIG. 46, a fine hatching is applied to the pixel in which the large dot is formed, a slightly coarse hatching is applied to the pixels in which the medium dots are formed, and a coarse hatching is applied to the pixel in which the small dot is formed, as in FIG. 19. By comparing the dot distribution obtained in this way and the dot distribution obtained by performing the judgment on whether or not to form dots for each of the pixels shown in FIG. 42, it can be appreciated that the dot distribution for both cases matches completely.

In other words, by determining whether or not to form dots using the above-described method, it is possible to obtain the same dot distribution as that for a case in which the judgment on whether or not to form large, medium, and small dots is performed pixel by pixel with reference to dithering, even when only the multivalue gradation-value data, which is dependent on the classification number, is received. Therefore, it becomes possible to obtain high-quality images in which the dots are dispersed in a superior manner.

In addition, the value-multiplexing table that is referenced to generate the multivalue gradation-value data is designed based on the dither matrix (see FIG. 44). Similarly, the dot-number-data conversion table and the sequence value matrix that are referenced in the course of determining whether or not to form dots based on the multivalue gradation-value data are designed based on the dither matrix (see FIGS. 44 and 45). Therefore, by employing a so-called Blue Noise Mask or a Green Noise Mask as the dither matrix used for setting these tables, it becomes possible to obtain high-quality images that can usually be obtained only when such masks are used.

### CONCLUSION

In the present embodiment, by generating the multivalue gradation-value data by performing, with the value-multiplexing processing section 182, the value-multiplexing processing on the CMYK image data generated by the color conversion processing section 168 in the printer driver 180 and sending the multivalue gradation-value data, as the print data, from the computer 152 to the inkjet printer 1, it becomes possible to significantly reduce the data amount of the print data, compared to a conventional example in which data is sent after performing halftone processing and rasterization processing.

Further, with the present embodiment, the data is not converted to the resolution (output resolution) used when printing on the medium S during the resolution conversion processing of the printer driver 180, but is instead converted to a predetermined resolution, and the conversion to the resolution (output resolution) used when printing on the medium S is executed on the side of the inkjet printer 1. Therefore, it is possible to make the data amount of the print data sent from the computer 152 to the inkjet printer 1 constant regardless of the resolution for printing, and thus, it is possible to achieve a significant reduction in communication load.

Further, the multivalue gradation-value data generated through the value-multiplexing processing by the value-multiplexing processing section 182 is data expressed using a predetermined value-multiplexing level number. Therefore, it is possible to print an image to be printed with a sufficiently high image quality, even when the image is printed by the inkjet printer 1.

Further, it is possible to smoothly perform the process of generating the dot-formation data in accordance with the resolution of the output image by determining, with the dot-formation-data generating section 184 on side of the inkjet printer 1, whether or not to form a dot individually for each of a predetermined number of pixels (eight pixels in the embodiment) based on the dot-number data, and cutting out a predetermined number of pixels, from the predetermined number of pixels (eight pixels in the embodiment) for which whether or not to form a dot has been determined, in accordance with the resolution of the output image. Further, by appropriately changing the positions of the pixels to be cut out from the eight pixels for which whether or not to form a dot has been determined, it is possible to easily perform the process of generating the dot-formation data in accordance with the resolution of the output image.

### Other Embodiments

<Other Value-Multiplexing Tables>

In the foregoing embodiment, a value-multiplexing table in which the multivalue gradation-value data corresponding to each of the gradation values “0” to “255” is set is used as the value-multiplexing table. However, since the multivalue gradation-value data merely increases stepwise in accordance with the increase of the gradation values of the pixels in the CMYK image data, it is possible to find the multivalue gradation-value data corresponding to the gradation value of each pixel in the CMYK image data simply by setting the gradation values at which the multivalue gradation-value data changes.

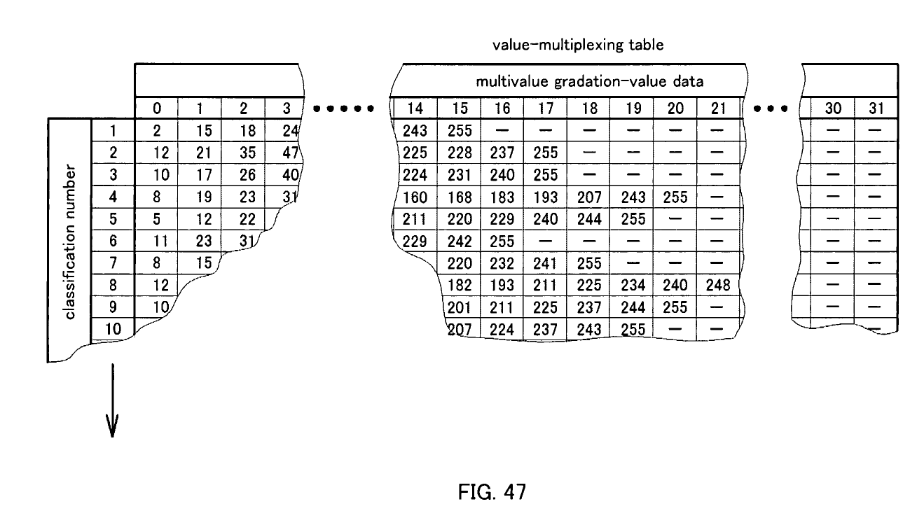

FIG. 47 describes an example of a value-multiplexing table in which only the gradation values at which the multivalue gradation-value data changes have been set. In this value-multiplexing table, threshold values for the gradation values of the pixels in the CMYK image data that correspond to the multivalue gradation-value data “0” to “31” are set for each of the classification numbers “1” to “1024”. The threshold value indicates the largest gradation value that takes on that multivalue gradation-value data when the gradation value is increased from “0” to “255”. For example, as for the classification number “1”, the threshold value “2” is set for the multivalue gradation-value data “0”. This means that, for the classification number “1”, the multivalue gradation-value data will be “0” when the gradation value of the pixel in the CMYK image data is within a range of “0” to “2”. Further, the threshold value “15” is set for the multivalue gradation-value data “1”. This means that, for the classification number “1”, the multivalue gradation-value data will be “1” when the gradation value of the CMYK image data is within a range of “3” to “15”. Similarly, the threshold value “243” is set for the multivalue gradation-value data “14”, and the threshold value “255” is set for the multivalue gradation-value data “15”. This means that the multivalue gradation-value data will be “15” when the gradation value of the pixel in the CMYK image data is within a range of “244” to “255”. Further, this means that the maximum value of the multivalue gradation-value data for the classification number “1” is “15”.

It should be noted that, in FIG. 47, the threshold values set separately for the classification numbers “1” to “1024” are set in correspondence with the multivalue gradation-value data. However, the threshold values for each classification number “1” to “1024” do not have to be associated with the multivalue gradation-value data, and a combination of the threshold values may simply be stored for each classification number “1” to “1024”. In this case, it is possible to find the multivalue gradation-value data by counting the number of threshold values smaller than the gradation value of the pixel in the CMYK image data. This is described taking the classification number “1” as an example. For example, it is assumed that the gradation value of the CMYK image data is “20”. In the combination of threshold values set for the classification number “1”, there are three threshold values, “2”, “15”, and “18”, that are smaller than the gradation value “20”. Therefore, it can be found that the resultant value of the value-multiplexing processing for the gradation value “20” is “3”.

As described above, by providing such a value-multiplexing table, it is possible to easily generate the multivalue gradation-value data after obtaining the gradation value of the pixel in the CMYK image data and the classification number. Further, this value-multiplexing table can be stored with a smaller data amount compared to the value-multiplexing table of FIG. 12 described above. Therefore, with this example, it is possible to significantly save the amount of usage of a memory compared to a case where the value-multiplexing table of FIG. 12 described above is provided.

<Another Method for Determining Whether or Not to Form Dots (1)>

In the foregoing embodiment, the dot-formation-data generating section 184 converts the multivalue gradation-value data into dot-number data indicating the number of dots to be formed for the eight pixels, and when determining whether or not to form a dot for each of the eight pixels (16 pixels for the “4×4 mode”; this is the same throughout the description below), it determined whether or not to form a dot for each pixel, of the eight pixels, separately for each dot type (size). For example, as described in FIG. 19, a procedure is adopted in which whether or not to form large dots is first determined, whether or not to form medium dots is determined next, and whether or not to form small dots is finally determined. However, the method for determining whether or not to form dots is not limited to the above method. For example, a single pixel may be selected from the eight pixels, and the determination on whether or not to form a large dot, a medium dot, or a small dot, or whether no dot is to be formed, may be performed pixel by pixel.

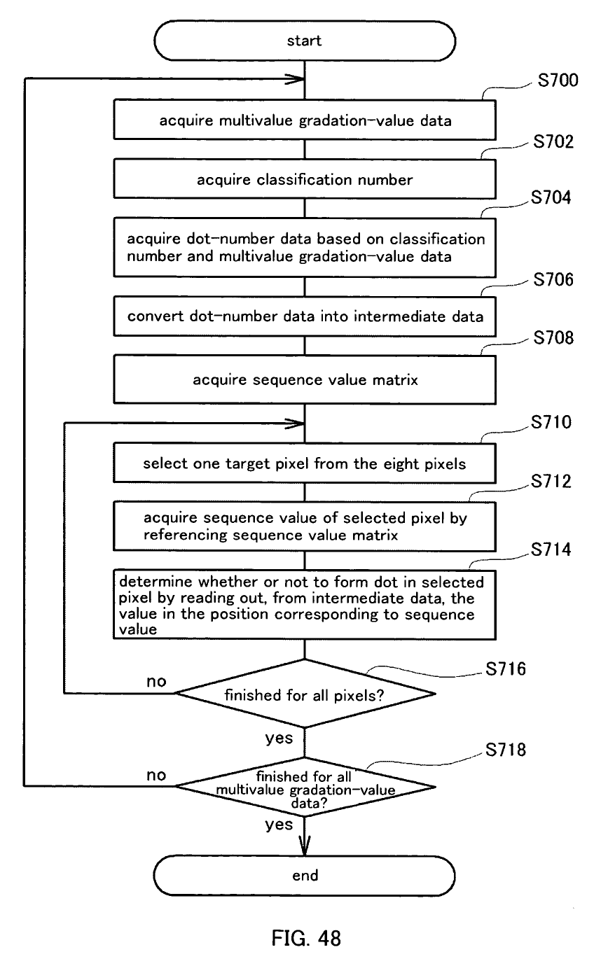

FIG. 48 is a flowchart showing a flow of the dot-formation-data generating section 184 for determining whether or not to form dots in this example. Herein, as with the dot-formation determination processing described above, first, the multivalue gradation-value data targeted for processing is acquired (step S700). Next, the classification number corresponding to the acquired multivalue gradation-value data is acquired (step S702). Then, based on the classification number and the multivalue gradation-value data, the dot-number data is acquired (step S704). The dot-number data is acquired using, for example, the dot-number-data conversion table described in FIG. 16.

Then, in the processing described here, the acquired dot-number data is once converted into intermediate data that is 16 bits long (step S706). More specifically, for example, with the dot-number-data conversion table described in FIG. 16, the dot-number data is expressed as code data that is 8 bits long in order to reduce the data amount. However, in the processing described here, the data is once converted into intermediate data that is expressed using a format with which it is possible to determine whether or not to form a dot more simply. Herein, the data length of the intermediate data is set to 16 bits because the number of pixels for which the determination on whether or not to form a dot has to be made is eight, and whether or not to form a dot for each pixel can be expressed using 2 bits. In other words, the intermediate data expresses the numbers of dots, taking 2 bits as a set and using eight sets of data, which correspond to the number of pixels. By expressing the numbers of dots to be formed in the eight pixels using such a format, it is possible to achieve easy correlation with the pixels as described below, and therefore, it becomes possible to easily determine whether or not to form dots. In the dot-formation determination processing described here, the correspondence between the dot-number data and the intermediate data is stored in advance, and in the process of step S706, the intermediate data is acquired by referencing this correspondence.

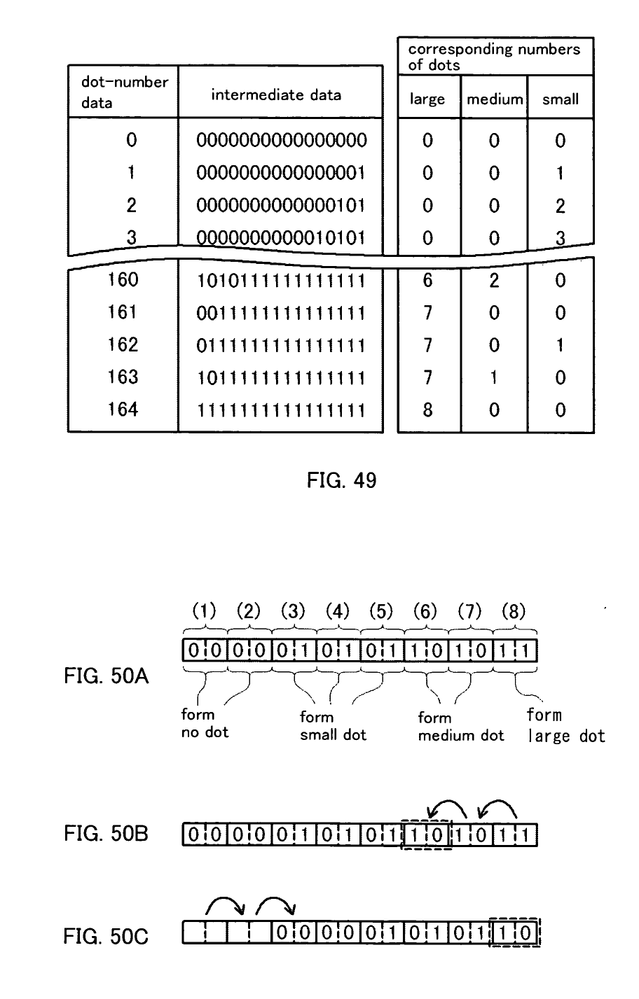

FIG. 49 is an explanatory diagram showing a table in which the dot-number data and the intermediate data are correlated. As described above, the dot-number data corresponds to the combination of the numbers of dots of the various sizes (see FIG. 17). Therefore, it is possible to obtain data of 16 bits by expressing the type of dot using 2 bits as a set and converting the data into an expression format in which a number of sets of bits corresponding to the number of dots are lined up. The 16-bit long intermediate data is obtained by converting the expression format of the dot-number data in this way.

For example, the dot-number data “1” indicates a combination of no large dot, no medium dot, and one small dot. It should be noted that the figure on the right of FIG. 49 shows the combination of the numbers of dots that each dot-number data indicates. Here, assuming that the 2-bit data “01” indicates a small dot, the 16-bit data corresponding to the code data “1” will include one set of “01”, and the seven other sets of 2-bit data will be “00”. It should be noted that the 2-bit data “00” indicates that no dot is to be formed.

Similarly, the dot-number data “163” indicates a combination of seven large dots, one medium dot, and no small dot. Here, assuming that the 2-bit data “11” indicates a large dot and the 2-bit data “10” indicates a medium dot, the 16-bit data corresponding to the dot-number data “163” will include seven sets of the 2-bit data “11”, and one set of the 2-bit data “10”.

It should be noted that the pieces of 2-bit data are set starting from the right end in the order of large dots, medium dots, and small dots. For example, assuming that the combination of dot numbers is one large dot, two medium dots, and three small dots, one set of the 2-bit data “11” indicating a large dot will be set at the right end, two sets of the 2-bit data “10” indicating a medium dot will be set continuously on the left thereof, three sets of the 2-bit data “01” indicating a small dot will be set continuously on the left thereof, and the 2-bit data “00” indicating formation of no dot will be set to the remaining two sets. The 2-bit data may be set starting from the left. That is, the pieces of 2-bit data may be set starting from the left end in the order of large dots, medium dots, and small dots.

In step S706 of the dot-formation determination processing described in FIG. 48, the process of converting the data indicating the numbers of dots into the intermediate data is performed by referencing the correspondence shown in FIG. 49. It should be noted that in the description above, the multivalue gradation-value data is once converted into the dot-number data by referencing the dot-number-data conversion table described in FIG. 16, and then the dot-number data is converted into the 16-bit intermediate data in accordance with the correspondence described in FIG. 49. However, since the dot-number data and the intermediate data have a one-to-one correspondence, it would be possible to directly acquire the intermediate data as the dot-number data by setting the 16-bit intermediate data as the dot-number data to the dot-number-data conversion table described in FIG. 16, instead of the 8-bit dot-number data. In this way, even though the data amount of the dot-number-data conversion table will increase, the conversion table for converting the dot-number data into the intermediate data will become unnecessary, and it becomes possible to acquire the intermediate data quickly.

After acquiring the intermediate data in this way, the sequence value matrix is acquired (step S708). After acquiring the sequence value matrix, one pixel, among the eight pixels, for determining whether or not to form a dot is selected (step S710), and the sequence value set in the position of the selected pixel within the sequence value matrix is acquired (step S712).

Then, by reading out, from the intermediate data acquired in advance, the 2-bit data set to the position corresponding to the sequence value, it is possible to determine whether or not to form a dot for the selected pixel.

FIG. 50 is an explanatory diagram showing how to determine whether or not to form a dot by reading out the data in the position corresponding to the sequence value from the intermediate data. FIG. 50A illustrates the intermediate data obtained by converting the dot-number data. As described above, the intermediate data is 16 bits long and is made up of eight sets of 2-bit data. The intermediate data shown in FIG. 50A includes one set of the 2-bit data “11” indicating a large dot, two sets of the 2-bit data “10” indicating a medium dot, three sets of the 2-bit data “01” indicating a small dot, and two sets of the 2-bit data “00” indicating formation of no dot, and these pieces of 2-bit data are set starting from the right end in the order of large dots, medium dots, and small dots.

For example, assume that the sequence value of the pixel for which whether or not to form a dot is to be determined is “3”. In this case, by reading out, from the intermediate data, the 2-bit data set as the third set from the right, it is possible to determine the type of dot to be formed in the pixel whose sequence value is “3”. FIG. 50B conceptually shows how the third set of 2-bit data from the right end of the intermediate data is read out. In the example shown, the 2-bit data that is read out is “10”, and therefore, it is determined that a medium dot is to be formed in that pixel. If the sequence value is “1”, then the 2-bit data (“11”) set at the right end of the intermediate data is read out and it is determined that a large dot is to be formed.

As described above, in this dot-formation determination processing, it is possible to determine whether or not to form a dot through an extremely simple operation of reading out, from the intermediate data, the 2-bit data set in the position corresponding to the sequence value. The reason why this is possible is as follows. First, in the intermediate data, the 2-bit data indicating a large dot, medium dot, and small dot are set starting from the right. On the other hand, in the process of determining whether or not to form large, medium, and small dots through dithering described in FIGS. 40 and 42, the determination on whether or not to form dots is performed in the order of large dots, medium dots, and small dots. Accordingly, by reading out the 2-bit data set in the intermediate data in order from the right end, an alignment of 2-bit data, which indicate a large dot, medium dot, and small dot, can be obtained in the same order as the order in which the positions of the pixels in which to form the various types of dots are determined by applying the method described above using FIGS. 40 and 42.

Further, in the method described above using FIGS. 40 and 42, dots are formed in order from the pixels to which smaller threshold values are set in the dither matrix. On the other hand, the sequence values set in the sequence value matrix indicate the order of the threshold values set in the dither matrix starting from the smallest threshold value. Therefore, the sequence values match with the order in which the dots are formed when the determination on whether or not to form dots is performed using the method described above using FIGS. 40 and 42.

Therefore, if the sequence value of the targeted pixel is known, it is possible to find the ordinal number of the pixel, among the eight pixels, in which the dot was formed when the method of FIGS. 40 and 42 is used. Further, by reading out the 2-bit data at the position of the sequence value, counting from the right end of the intermediate data, it is possible find the determination result of whether or not to form a dot that is obtained when the method of FIGS. 40 and 42 is used.

It should be noted that, here, an example in which the position, within the intermediate data, for reading out the 2-bit data is changed in accordance with the sequence value was described. However, the position for reading out the data from the intermediate data does not have to be changed, and instead, the position for reading out the data may be fixed and the intermediate data may be shifted by the number of the set corresponding to the sequence value. Even in this way, it is possible to determine whether or not to form a dot. FIG. 50C is an explanatory diagram schematically showing how the determination on whether or not to form a dot is made by shifting the intermediate data. In the example shown, the 2-bit data at the right end of the intermediate data is read out, and the intermediate data is shifted to the right by the number of the set corresponding to the sequence value of the pixel (more specifically, by the number of the set that is smaller by “1” than the sequence value). As it is apparent when comparing FIGS. 50B and 50C, the 2-bit data that is set at the same position in the intermediate data will be read out with either operation. Since the process of shifting the data by a predetermined number of bits can be performed relatively quickly, by shifting the intermediate data in this way, it is possible to quickly determine whether or not to form a data for the focused pixel by quickly reading out the 2-bit data at the position corresponding to the sequence value.

When the determination on whether or not to form a dot for the focused pixel is made by reading out, from the intermediate data, the 2-bit data set at the position corresponding to the sequence value (step S714 of FIG. 48), it is determined whether or not the determination on whether or not to form a dot has been made for all eight pixels (step S716). If there still are pixels, within the eight pixels, for which the determination on whether or not to form a dot has not been made (no in step S716), the procedure is returned to step S710 and a new pixel is selected, the series of processes that follow are performed for the selected pixel, and it is again determined whether or not the determination on whether or not to form a dot has been made for all eight pixels (step S716). This operation is repeated until the determination on whether or not to form a dot has been made for all the pixels, and when it is determined that the determination has been made for all the pixels (yes in step S716), then it is determined whether or not the determination on whether or not to form a dot has been made according to the above-described processing for all of the multivalue gradation-value data (step S718). If there still is multivalue gradation-value data that has not been processed (no in step S718), then the procedure is returned to step S700 and a new multivalue gradation-value data is acquired, and the series of processes are performed on that multivalue gradation-value data. This operation is repeated, and when it is determined that the processing has finished for all the multivalue gradation-value data (yes in step S718), the dot-formation determination processing is ended.

As described above, it is possible to easily determine whether or not to form a dot simply by reading out, from the intermediate data, the 2-bit data that is set at an appropriate position corresponding to the sequence value. Therefore, it is possible to quickly determine whether or not to form dots, and thus, it becomes possible to print images more quickly.

It should be noted that, here, description was given about an example in which the determination on whether or not to form a dot is made for each of the eight pixels. However, in the “4×4 mode” of the present embodiment, the determination on whether or not to form a dot is made for each of 16 pixels. That is, the intermediate data is set based on the dot-number data for the “4×4 mode” described in FIG. 33 and the combination of the numbers of the dots of various sizes.

<Another Method for Determining Whether or Not to Form Dots (2)>

In the foregoing embodiment, the positions of the pixels in which to form the dots, among the eight pixels (16 pixels for the “4×4 mode”; this is the same throughout the description below) are determined by referencing the sequence value matrix after converting the multivalue gradation-value data once into the dot-number data by referencing the dot-number-data conversion table described in FIG. 16. However, in determining whether or not to form the dots, it is also possible to directly determine the positions of the pixels in which to form the various dots based on the acquired multivalue gradation-value data, without determining the positions of the pixels in which to form the dots by referencing the sequence value matrix as described above. This method is described in detail below.

In the foregoing embodiment, the numbers of the various dots to be formed in the eight pixels were determined by first obtaining the multivalue gradation-value data and the classification number and then using the multivalue gradation-value data and the classification number in combination, as described in FIG. 46. Further, the positions of the pixels in which to form these dots were determined by referencing the sequence value matrix corresponding to the classification number. In other words, if the multivalue gradation-value data and the classification number are determined, then it is possible to determine the type of dot to be formed in each of the eight pixels. Accordingly, by finding, in advance, the type of dot that is formed in each of the eight pixels for each combination of the multivalue gradation-value data and the classification number and storing this information as a table, it would be possible to directly determine whether or not to form dots just by referencing this table. The dot-formation determination processing described below enables to quickly determine whether or not to form a dot for each pixel based on such a concept.

FIG. 51 is an explanatory diagram schematically showing an example of a dot-number-data conversion table used herein. As shown in FIG. 51, in this dot-number-data conversion table, data that indicates the type of dot formed in each of the eight pixels is set in correspondence with a combination of the classification number and the resultant value of value-multiplexing processing. Here, this data is referred to as “dot data”. By referencing this dot-number-data conversion table shown in FIG. 51, it is possible to directly obtain the corresponding dot data from the combination of the multivalue gradation-value data and the classification number. For example, if the classification number is “i” and the multivalue gradation-value data is “j”, the dot data will be DD (i, j). The dot data obtained in this way includes information on whether or not to form a dot in each of the eight pixels.

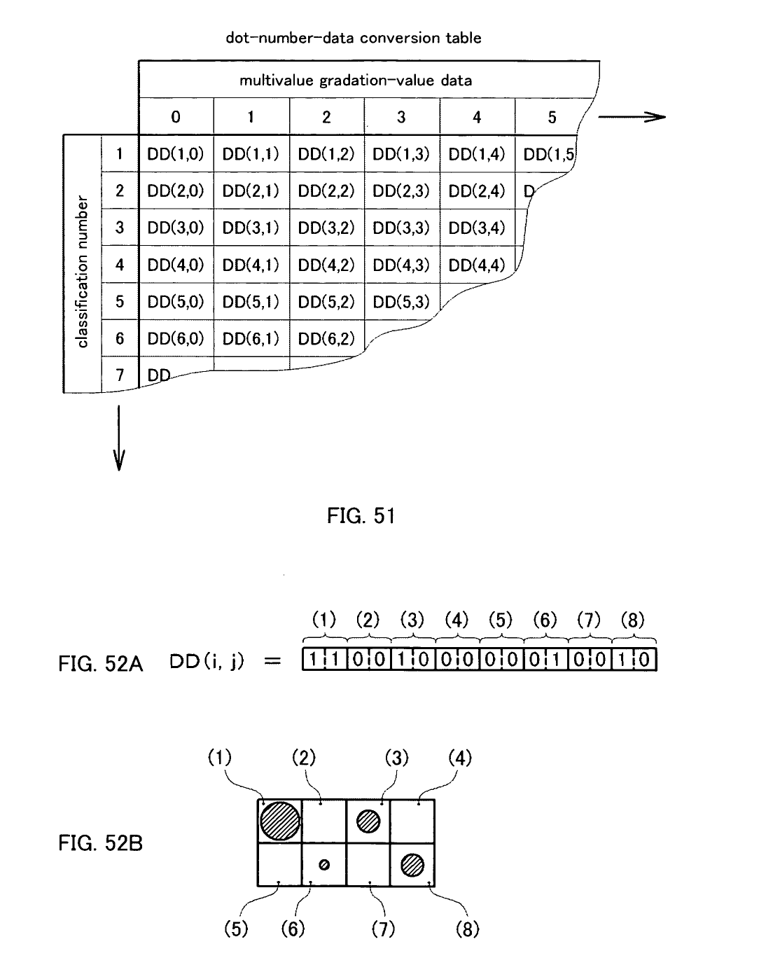

FIG. 52 is an explanatory diagram showing an example of a data structure of the dot data set in the dot-number-data conversion table used herein. FIG. 52A describes an example of the dot data. FIG. 52B describes an example of an image of dots that are actually formed.

As shown in FIG. 52A, the dot data is 16 bits long and is made up of eight sets of 2-bit data. The dot data is made up of eight sets of data because a piece of multivalue gradation-value data includes information on eight pixels. Therefore, for example, if a piece of multivalue gradation-value data includes information on 16 pixels as in the “4×4 mode” of the present embodiment, then a piece of dot data will be made of 16 sets of data. Further, although not described in the foregoing embodiment, if a piece of multivalue gradation-value data includes information on four pixels, then a piece of dot data will be made of four sets of data.

As shown in FIG. 52, the eight sets of data that make up the dot data correspond to the pixels at predetermined positions within the eight pixels. For example, the first set of data in the dot data shown in FIG. 52A corresponds to the pixel in the upper left corner within the eight pixels as shown in FIG. 52B. Further, the second set of data in the dot data corresponds to the pixel second from the left on the upper stage within the eight pixels. In this way, the eight sets of data that make up the dot data are associated, in advance, with the pixels at predetermined positions within the eight pixels.

The content of each set of data indicates the type of dot to be formed in the corresponding pixel. That is, the 2-bit data “11” indicates formation of a large dot, the 2-bit data “10” indicates formation of a medium dot, the 2-bit data “01” indicates formation of a small dot, and the 2-bit data “00” indicates formation of no dot. As can be appreciated from the above description, the dot data illustrated in FIG. 52A indicates to form a large dot in the pixel in the upper left corner among the eight pixels and to form a medium dot in the third pixel from the left in the upper stage. Further, this dot data indicates to form a small dot in the second pixel from the left in the lower stage and to form a medium dot in the pixel in the lower right corner among the eight pixels. Further, this dot data indicates that no dot is formed in the rest of the pixels.

By referencing such a dot-number-data conversion table, it is possible to quickly determine whether or not to form a dot for each pixel among the eight pixels based on the classification number and the multivalue gradation-value data.

It should be noted that in the present embodiment, a dedicated dot-number-data conversion table becomes necessary for the “2×4 mode” and the “4×4 mode”, in addition to the dot-number-data conversion table described above.

### Further Embodiments

A printing apparatus such as an inkjet printer of the present invention was described according to an embodiment thereof. However, the foregoing embodiment is for the purpose of facilitating understanding of the present invention, and is not to be interpreted as limiting the present invention. The invention can of course be altered and improved without departing from the gist thereof, and includes equivalents. In particular, the embodiments mentioned below also are within the scope of the invention.

<Value-Multiplexing Processing>

In the foregoing embodiment, the multivalue gradation-value data is generated using a value-multiplexing table. The multivalue gradation-value data, however, does not necessarily have to be generated using such a value-multiplexing table. That is, the multivalue gradation-value data may be generated through calculation etc. without using a table.

<Dot-Number-Data Conversion Processing>

In the foregoing embodiment, the multivalue gradation-value data is converted into the dot-number data using a dot-number-data conversion table. However, the multivalue gradation-value data does not necessarily have to be converted into the dot-number data using such a dot-number-data conversion table. That is, the dot-number data may be acquired through calculation etc. without using a table.

<Multivalue Gradation-Value Data>

In the foregoing embodiment, the multivalue gradation-value data is generated as 32-gradation, 5-bit data. In the present invention, however, the multivalue gradation-value data does not necessarily have to be generated as data having such a number of bits. That is, the number of bits of the multivalue gradation-value data is appropriately set in accordance with the level number, i.e., the value-multiplexing level number, by which the value-multiplexing processing section performs the value-multiplexing processing. The multivalue gradation-value data may be generated as data having a different number of bits.

<Dot-Number Data>

In the foregoing embodiment, the dot-number data is coded to express the number of dots to be formed and also the size of the dot to be formed (i.e., “small dot”, “medium dot”, and “large dot”). In the present invention, however, the dot-number data does not necessarily have to be such a kind of data. That is, it is only necessary that the dot-number data indicates the number of dots of at least one size, and the dot-number data does not have to represent other information, such as the dot size.

<Resolution of Output Image>

In the foregoing embodiment, there are seven types of resolutions of the output image, these being the “1×1 mode”, the “2×1 mode”, the “1×2 mode”, the “2×2 mode”, the “4×2 mode”, the “2×4 mode”, and the “4×4 mode”. The present invention, however, is not necessarily limited to these resolutions. That is, the resolution of the output image can freely be set to other resolutions.

<Regarding “One or More Pixels”>

In the foregoing embodiment, whether or not to form a dot is determined individually for eight pixels, which serve as the “one or more pixels” for which whether or not to form a dot is determined by the dot-formation-data generating section. The “one or more pixels”, however, are not limited to a case in which whether or not to form a dot is determined individually for eight pixels. The determination on whether or not to form a dot may be individually performed for seven or less pixels, or the determination on whether or not to form a dot may be individually performed for nine or more pixels.

<Value-Multiplexing Processing Section>

In the foregoing embodiment, the value-multiplexing processing section is provided in a computer such as a personal computer. The value-multiplexing processing section, however, does not necessarily have to be provided in a computer such as a personal computer. That is, for example, it may be provided inside a printing apparatus such as an inkjet printer, or it may be provided in various other devices.

<Dot-Formation-Data Generating Section>

In the foregoing embodiment, the dot-formation-data generating section is provided in a printing apparatus such as an inkjet printer. The dot-formation-data generating section, however, does not necessarily have to be provided in a printing apparatus such as an inkjet printer. That is, for example, it may be provided in a computer, such as a personal computer, connected to a printing apparatus such as an inkjet printer, or it may be provided in various other devices.

<Image-Processing Apparatus>

In the foregoing embodiment, the image-processing apparatus is described taking an example in which it is applied to a printing system (image-processing system) provided with a printing apparatus and a computer that controls this printing apparatus. The image-processing apparatus described herein, however, does not have to be applied to such a printing system. That is, the image-processing apparatus described herein may be applied only to the printing apparatus. In other words, both the value-multiplexing processing section and the dot-formation-data generating section may be provided in the printing apparatus. Further, the image-processing apparatus described herein may be applied to the computer that controls the printing apparatus. In other words, both the value-multiplexing processing section and the dot-formation-data generating section may be provided in the computer that controls the printing apparatus. In addition, any device may serve as the “image-processing apparatus” described herein, as long as it processes image data to generate the dot-formation data of an output image.

<Printing Apparatus>

In the foregoing embodiment, an inkjet printer 1 of the above-described type is taken as an example of a “printing apparatus”. However, the printing apparatus is not limited thereto, and it may be any kind of device as long as it is provided with a printing function, such as an inkjet printer that ejects ink using a different method, or a printer that does not eject ink, such as a dot-impact printer, a thermal-transfer printer, or a laser beam printer.

What is claimed is:

1. An image-processing apparatus comprising:
(A) a value-multiplexing processing section that generates, based on image data, multivalue gradation-value data by performing value-multiplexing processing on a gradation value of each of a plurality of pixels that constitute an image expressed by the image data, in accordance with a resolution of an output image; and
(B) a dot-formation-data generating section that converts the multivalue gradation-value data generated by the value-multiplexing processing section into dot-number data indicating a number of dots, that determines whether or not to form a dot individually for each of one or more pixels based on the dot-number data, and that generates dot-formation data of the output image having the above-described resolution by employing at least a portion of the pixels, among the one or more pixels for which whether or not to form a dot has been determined, as a pixel that constitutes the output image.

2. An image-processing apparatus according to claim 1,
wherein the image-processing apparatus further comprises a value-multiplexing table in which the gradation value and the multivalue gradation-value data are associated; and
wherein the value-multiplexing processing section generates the multivalue gradation-value data by referencing the value-multiplexing table.

3. An image-processing apparatus according to claim 1,
wherein the value-multiplexing processing section generates the multivalue gradation-value data by performing the value-multiplexing processing on the gradation value, provided separately for each color, of each of the pixels that constitute the image expressed by the image data, in accordance with the resolution of the output image.

4. An image-processing apparatus according to claim 1,
wherein the value-multiplexing processing section generates the multivalue gradation-value data by performing the value-multiplexing processing on the gradation value in accordance with a position of the pixel corresponding to the gradation value.

5. An image-processing apparatus according to claim 1,
wherein the multivalue gradation-value data is generated by the value-multiplexing processing section as data having a predetermined number of bits.

6. An image-processing apparatus according to claim 1,
wherein the image-processing apparatus further comprises a dot-number-data conversion table in which the multivalue gradation-value data and the dot-number data are associated; and
wherein the dot-formation-data generating section converts the multivalue gradation-value data into the dot-number data by referencing the dot-number-data conversion table.

7. An image-processing apparatus according to claim 1,
wherein the dot-formation-data generating section determines whether or not to form a dot individually for each of a predetermined number of pixels based on the dot-number data.

8. An image-processing apparatus according to claim 1,
wherein the dot-number data includes data on a number of dots and data on a size of the dots.

9. An image-processing apparatus according to claim 1,
wherein the dot-formation-data generating section determines whether or not to form a dot individually for each of the one or more pixels based on the dot-number data and dot-formation sequence data indicating an order in which dots are to be formed.

10. An image-processing apparatus according to claim 1,
wherein a number of the pixel, among the one or more pixels for which whether or not to form a dot has been determined, that is used by the dot-formation-data generating section as the pixel that constitutes the output image differs depending on the resolution of the output image.

11. An image-processing apparatus according to claim 1,
wherein a position of the pixel, among the one or more pixels for which whether or not to form a dot has been determined, that is used by the dot-formation-data generating section as the pixel that constitutes the output image differs depending on a position of the pixel corresponding to the gradation value subjected to the value-multiplexing processing when generating the multivalue gradation-value data.

12. An image-processing apparatus comprising:
(A) a value-multiplexing processing section that generates, based on image data, multivalue gradation-value data by performing value-multiplexing processing on a gradation value of each of a plurality of pixels that constitute an image expressed by the image data, in accordance with a resolution of an output image; and
(B) a dot-formation-data generating section that converts the multivalue gradation-value data generated by the value-multiplexing processing section into dot-number data indicating a number of dots, that determines whether or not to form a dot individually for each of one or more pixels based on the dot-number data, and that generates dot-formation data of the output image having the above-described resolution by employing at least a portion of the pixels, among the one or more pixels for which whether or not to form a dot has been determined, as a pixel that constitutes the output image;
(C) wherein the image-processing apparatus further comprises a value-multiplexing table in which the gradation value and the multivalue gradation-value data are associated, and the value-multiplexing processing section generates the multivalue gradation-value data by referencing the value-multiplexing table;
(D) wherein the value-multiplexing processing section generates the multivalue gradation-value data by performing the value-multiplexing processing on the gradation value, provided separately for each color, of each of the pixels that constitute the image expressed by the image data, in accordance with the resolution of the output image;
(E) wherein the value-multiplexing processing section generates the multivalue gradation-value data by performing the value-multiplexing processing on the gradation value in accordance with a position of the pixel corresponding to the gradation value;
(F) wherein the multivalue gradation-value data is generated by the value-multiplexing processing section as data having a predetermined number of bits;
(G) wherein the image-processing apparatus further comprises a dot-number-data conversion table in which the multivalue gradation-value data and the dot-number data are associated, and the dot-formation-data generating section converts the multivalue gradation-value data into the dot-number data by referencing the dot-number-data conversion table;
(H) wherein the dot-formation-data generating section determines whether or not to form a dot individually for each of a predetermined number of pixels based on the dot-number data;
(I) wherein the dot-number data includes data on a number of dots and data on a size of the dots;
(J) wherein the dot-formation-data generating section determines whether or not to form a dot individually for each of the one or more pixels based on the dot-number data and dot-formation sequence data indicating an order in which dots are to be formed;
(K) wherein a number of the pixel, among the one or more pixels for which whether or not to form a dot has been determined, that is used by the dot-formation-data generating section as the pixel that constitutes the output image differs depending on the resolution of the output image; and
(L) wherein a position of the pixel, among the one or more pixels for which whether or not to form a dot has been determined, that is used by the dot-formation-data generating section as the pixel that constitutes the output image differs depending on a position of the pixel corresponding to the gradation value subjected to the value-multiplexing processing when generating the multivalue gradation-value data.

13. An image-processing method comprising:
a value-multiplexing processing step of generating, based on image data, multivalue gradation-value data by performing value-multiplexing processing on a gradation value of each of a plurality of pixels that constitute an image expressed by the image data, in accordance with a resolution of an output image; and
a dot-formation-data generating step of
converting the multivalue gradation-value data generated in the value-multiplexing processing step into dot-number data indicating a number of dots,
determining whether or not to form a dot individually for each of one or more pixels based on the dot-number data, and
generating dot-formation data of the output image having the above-described resolution by employing at least a portion of the pixels, among the one or more pixels for which whether or not to form a dot has been determined, as a pixel that constitutes the output image.

14. An image-processing system comprising:
an image-processing apparatus that includes a value-multiplexing processing section that generates, based on image data, multivalue gradation-value data by performing value-multiplexing processing on a gradation value of each of a plurality of pixels that constitute an image expressed by the image data, in accordance with a resolution of an output image; and
an image-outputting apparatus that can communicate with the image-processing apparatus and that includes a dot-formation-data generating section that converts the multivalue gradation-value data generated by the value-multiplexing processing section into dot-number data indicating a number of dots, that determines whether or not to form a dot individually for each of one or more pixels based on the dot-number data, and that generates dot-formation data of the output image having the above-described resolution by employing at least a portion of the pixels, among the one or more pixels for which whether or not to form a dot has been determined, as a pixel that constitutes the output image.

15. A printing apparatus comprising:
(A) a value-multiplexing processing section that generates, based on image data, multivalue gradation-value data by performing value-multiplexing processing on a gradation value of each of a plurality of pixels that constitute an image expressed by the image data, in accordance with a resolution of an output image;
(B) a dot-formation-data generating section that converts the multivalue gradation-value data generated by the value-multiplexing processing section into dot-number data indicating a number of dots, that determines whether or not to form a dot individually for each of one or more pixels based on the dot-number data, and that generates dot-formation data of the output image having the above-described resolution by employing at least a portion of the pixels, among the one or more pixels for which whether or not to form a dot has been determined, as a pixel that constitutes the output image; and
(C) a printing section that performs printing on a medium based on the dot-number data generated by the dot-formation-data generating section.

16. A printing system comprising:
a computer that includes a value-multiplexing processing section that generates, based on image data, multivalue gradation-value data by performing value-multiplexing processing on a gradation value of each of a plurality of pixels that constitute an image expressed by the image data, in accordance with a resolution of an output image; and
a printing apparatus connectable to the computer and that includes
a dot-formation-data generating section that converts the multivalue gradation-value data generated by the value-multiplexing processing section into dot-number data indicating a number of dots, that determines whether or not to form a dot individually for each of one or more pixels based on the dot-number data, and that generates dot-formation data of the output image having the above-described resolution by employing at least a portion of the pixels, among the one or more pixels for which whether or not to form a dot has been determined, as a pixel that constitutes the output image, and
a printing section that performs printing on a medium based on the dot-number data generated by the dot-formation-data generating section.
